(19) United States
(12) Patent Application Publication
(10) Pub. No.: US 2025/0098029 A1
(43) Pub. Date: Mar. 20, 2025

(54) METHOD AND APPARATUS FOR MULTICAST/BROADCAST SERVICE

(71) Applicant: Telefonaktiebolaget LM Ericsson (publ), Stockholm (SE)

(72) Inventors: Jie Ling, Shanghai (CN); Juying Gan, Shanghai (CN); Shabnam Sultana, Montreal (CA); Paul Schliwa-Bertling, Ljungsbro (SE)

(21) Appl. No.: 18/729,545

(22) PCT Filed: Jan. 13, 2023
(86) PCT No.: PCT/CN2023/072131

§ 371 Date: Jul. 17, 2024

(30) Foreign Application Priority Data
Jan. 28, 2022 (WO) PCT/CN2022/074564
May 5, 2022 (WO) PCT/CN2022/090976

(51) Int. Cl. H04W 76/40; H04W 76/11

(52) U.S. Cl. CPC H04W 76/40; H04W 76/11

(57) ABSTRACT

Embodiments of the present disclosure provide methods and apparatuses for multicast/broadcast service (MBS). A method performed by a radio access network node comprises receiving a first request from a core network node in a first network. The first request comprises a multicast/broadcast service (MBS) session identifier (ID) and at least one associated session identifier. The at least one associated session ID is used to make an association for two or more broadcast MBS sessions of two or more networks. The method further comprises when a predefined number of user planes have been established for the two or more MBS sessions, skipping establishing a user plane of a first MBS session towards the first network. The method further comprises when the predefined number of user planes have not been established for the two or more MBS sessions, establishing the user plane of the first MBS session towards the first network.

### TECHNICAL FIELD

The non-limiting and exemplary embodiments of the present disclosure generally relate to the technical field of communications, and specifically to methods and apparatuses for multicast/broadcast service (MBS).

### BACKGROUND

This section introduces aspects that may facilitate a better understanding of the disclosure. Accordingly, the statements of this section are to be read in this light and are not to be understood as admissions about what is in the prior art or what is not in the prior art.

Third Generation Partnership Project (3GPP) TS 23.247 V17.2.0, the disclosure of which is incorporated by reference herein in its entirety, describes architectural enhancements for 5G (fifth generation) multicast-broadcast services. 3GPP TS 23.682 V17.2.0, the disclosure of which is incorporated by reference herein in its entirety, describes group message delivery procedures. 3GPP TS 23.246 V16.1.0, the disclosure of which is incorporated by reference herein in its entirety, describes Multimedia Broadcast/Multicast Service (MBMS), architecture and functional description.

FIG. 1A shows an example of delivery methods, which is same as FIGS. 4.1-1 of 3GPP TS 23.247 V17.2.0.

Multicast and Broadcast Service (MBS) is a point-to-multipoint service in which data is transmitted from a single source entity to multiple recipients, either to all users in a broadcast service area, or to users in a multicast group. The corresponding types of MBS session are broadcast session and multicast session.

The MBS architecture follows the fifth generation (5G) System architectural principles as defined in 3GPP TS 23.501 V17.1.1, the disclosure of which is incorporated by reference herein in its entirety, enabling distribution of the MBS data from the 5GS (5G system) ingress to NG-RAN (next generation radio access network) node(s) and then to the UE (user equipment). The MBS architecture provides efficient usage of RAN (radio access network) and CN (core network) resources, with an emphasis on radio interface efficiency, and efficient transport for a variety of multicast and broadcast services.

The MBS also provides functionalities such as local MBS service, authorization of multicast MBS and QoS (quality of service) differentiation. MBS traffic is delivered from a single data source (e.g. Application Service Provider) to multiple UEs. Depending on many factors, there are several delivery methods which may be used to deliver the MBS traffic in the 5GS (5G system).

Between 5GC (5G core network) and NG-RAN (next generation RAN), there are two possible delivery methods to transmit the MBS data.

The first delivery method is 5GC Individual MBS traffic delivery method. This method is only applied for multicast MBS session. 5GC receives a single copy of MBS data packets and delivers separate copies of those MBS data packets to individual UEs via per-UE PDU session. Hence for each such UE one PDU session is required to be associated with a multicast session.

The second delivery method is 5GC is shared MBS traffic delivery method. This method is applied for both broadcast and multicast MBS session. 5GC receives a single copy of MBS data packets and delivers a single copy of those MBS packets to an NG-RAN node, which then delivers the packets to one or multiple UEs.

The 5GC Shared MBS traffic delivery method is required in all MBS deployments. The 5GC Individual MBS traffic delivery method is required to enable mobility when there is an NG-RAN deployment with non-homogeneous support of MBS.

For the multicast session, a single copy of MBS data packets received by the CN (core network) may be delivered via 5GC Individual MBS traffic delivery method for some UE(s) and via 5GC Shared MBS traffic delivery method for other UEs.

Between the NG-RAN and the UE, two delivery methods are available for the transmission of MBS data packets over radio interface.

The first delivery method is Point-to-Point (PTP) delivery method where NG-RAN delivers separate copies of MBS data packets over radio interface to individual UE(s).

The second delivery method is Point-to-Multipoint (PTM) delivery method where NG-RAN delivers a single copy of MBS data packets over radio interface to multiple UEs.

NG-RAN may use a combination of PTP/PTM to deliver MBS data packets to UEs.

As depicted in FIG. 1A, 5GC Shared MBS traffic delivery method (with PTP or PTM delivery) and 5GC Individual MBS traffic delivery method may be used at the same time for a multicast MBS session.

For MBS broadcast communication, only 5GC Shared MBS traffic delivery method with PTM delivery is applicable.

For MBS multicast communication, if the NG-RAN node supports MBS, the network shall use the 5GC Shared MBS traffic delivery method for MBS data transmission.

For MBS multicast communication, the switching between 5GC Shared MBS traffic delivery method and 5GC Individual MBS traffic delivery method is supported. The UE mobility between RAN nodes both supporting MBS, and between a RAN node supporting MBS and a RAN node not supporting MBS is supported.

For MBS multicast communication, the switching between PTP and PTM delivery methods for 5GC Shared MBS traffic delivery shall be supported. NG-RAN is the decision point for switching between PTP and PTM delivery methods.

The term TMGI (Temporary Mobile Group Identity) is defined in 3GPP TS 23.003 V17.2.0, the disclosure of which is incorporated by reference herein in its entirety, and is used to be able to identify a broadcast MBS Session or a multicast MBS Session.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

There are some problems in the exiting solutions for the same broadcast content to be provided to Multi-Operator Core Networks (MOCN) network sharing scenarios (i.e., multiple CNs are connected to the same RAN).

For example, there are several solutions proposed in 3GPP TR 23.700-47 V0.2.0, the disclosure of which is incorporated by reference herein in its entirety, on how the user planes between NG-RAN and Multicast/Broadcast User Plane Functions (MB-UPFs) in different CNs (core network) can be established.

In solution #2, solution #7 and solution #9 as described in 3GPP TR 23.700-47 V0.2.0, all the user planes between NG-RAN and MB-UPFs are established. It is less efficient, as only the packets over one user plane will be utilized to be delivered over the air, while the packets over other user planes will be dropped. When there is a failure in the CN whose packets are used to be delivered over the air, NG-RAN can decide to bring the packets from another CN over the air. Such solution is robust but less efficient.

In solution #8 as described in 3GPP TR 23.700-47 V0.2.0, AF (application function) only creates MBS session towards one CN in case there are MOCN RAN sharing. If there is a failure in this CN, NG-RAN is not able to continue to offer the MBS service. It is efficient but less robust.

To overcome or mitigate at least one above mentioned problems or other problems, the embodiments of the present disclosure propose an improved solution for the same broadcast content to be provided to MOCN network sharing scenarios.

In a first aspect of the disclosure, there is provided a method performed by a radio access network node. The method may comprise receiving a first request from a core network node in a first network. The first request may comprise a multicast/broadcast service (MBS) session identifier (ID) and at least one associated session identifier. The at least one associated session ID is used to make an association for two or more broadcast MBS sessions of two or more networks. The method may further comprise when a predefined number of user planes have been established for the two or more MBS sessions, skipping establishing a user plane of a first MBS session towards the first network. The method may further comprise when the predefined number of user planes have not been established for the two or more MBS sessions, establishing the user plane of the first MBS session towards the first network.

In an embodiment, skipping establishing a user plane of a first MBS session towards the first network may comprise, for multicast transport, skipping joining a multicast group for receiving MBS content from a Multicast/Broadcast User Plane Function (MB-UPF) in the first network which is originated from an application node, or for unicast transport, sending a first response without downlink tunnel information to the core network node in the first network.

In an embodiment, the method may further comprise when radio resource has been allocated for broadcasting MBS content of an application node and shared by the two or more broadcast MBS sessions, skipping allocating the radio resource.

In an embodiment, the method may further comprise when the radio resource has not been allocated for broadcasting MBS content of an application node and shared by the two or more broadcast MBS sessions, allocating the radio resource.

In an embodiment, the method may further comprise advertising the MBS session ID. The method may further comprise linking the MBS session ID to the radio resource.

In an embodiment, the method may further comprise creating broadcast MBS session context including the at least one associated session ID.

In an embodiment, the method may further comprise receiving an MBS session release request from the core network node in the first network. The MBS session release request may comprise the MBS session ID.

In an embodiment, when the user plane of the first MBS session towards the first network is not established, the method may further comprise continuing content delivery of the two or more broadcast MBS sessions. The method may further comprise stopping advertisement of the MBS session ID. The method may further comprise skipping releasing the user plane of the first MBS session towards the first network.

In an embodiment, skipping releasing the user plane of the first MBS session towards the first network may comprise, for multicast transport, skipping sending a leaving message to a Multicast/Broadcast User Plane Function (MB-UPF) in the first network, or for unicast transport, sending an MBS session release response without downlink tunnel information to the core network node in the first network.

In an embodiment, when the user plane of the first MBS session towards the first network is established and at least one other user plane for two or more broadcast MBS sessions is established, the method may further comprise continuing using radio resource allocated for broadcasting MBS content of an application node and shared by the two or more broadcast MBS sessions. The method may further comprise continuing content delivery of the two or more broadcast MBS sessions using the content received from another user plane. The method may further comprise stopping advertisement of the MBS session ID. The method may further comprise releasing the user plane of the first MBS session towards the first network.

In an embodiment, the method may further comprise, when the predefined number of user planes have not been established for the two or more MBS sessions, establishing the predefined number of user planes for the two or more MBS sessions.

In an embodiment, when the user plane of the first MBS session towards the first network is established and no other user plane for two or more broadcast MBS sessions is established, the method may further comprise selecting a second MBS session of the two or more broadcast MBS sessions to establish a user plane of the second MBS session towards a second network. The method may further comprise continuing using radio resource allocated for broadcasting MBS content of an application node and shared by the two or more broadcast MBS sessions. The method may further comprise continuing content delivery of the two or more broadcast MBS sessions using the content received from the user plane of the second MBS session. The method may further comprise stopping advertisement of the MBS session ID. The method may further comprise releasing the user plane of the MBS session towards the first network.

In an embodiment, establishing the user plane of the second MBS session towards the second network may comprise, for multicast transport, joining a multicast group for receiving MBS content from a Multicast/Broadcast User Plane Function (MB-UPF) in the second network, or for unicast transport, allocating downlink tunnel information, sending a request comprising an ID of the second MBS session and the downlink tunnel information to a core network node in the second network.

In an embodiment, the method may further comprise triggering Broadcast MBS Session Release Require procedure for each associated broadcast MBS session.

In an embodiment, triggering Broadcast MBS Session Release Require procedure for each associated broadcast MBS session comprising, when a user plane of an associated broadcast MBS session towards a corresponding network is not established, skipping releasing the user plane of the associated broadcast MBS session towards the corresponding network, and when the user plane of the associated broadcast MBS session towards the corresponding network is established, releasing the user plane of the associated broadcast MBS session towards the corresponding network.

In an embodiment, skipping releasing the user plane of the associated broadcast MBS session towards the corresponding network may comprise for multicast transport, skipping sending a leaving message to a Multicast/Broadcast User plane Function (MB-UPF) in the corresponding network, or for unicast transport, sending an MBS session release response without downlink tunnel information to the core network node in the corresponding network.

In an embodiment, the method further comprising determining that the radio access network node cannot receive MBS content from a user plane of a third MBS session towards a third network. The method further comprising selecting a fourth MBS session of the two or more broadcast MBS sessions to establish a user plane of a fourth MBS session towards a fourth network.

In an embodiment, determining that the radio access network node cannot receive MBS content from a user plane of a third MBS session towards a third network may comprise receiving an MBS session release request from a core network node in the third network, releasing a user plane of the third MBS session towards the third network, and determining that the radio access network node cannot receive MBS content from the user plane of the third MBS session towards the third network.

In an embodiment, determining that the radio access network node cannot receive MBS content from a user plane of a third MBS session towards a third network may comprise detecting there is a failure in the third network which causes the radio access network node cannot receive MBS content from the user plane of the third MBS session towards the third network; and determining that the radio access network node cannot receive MBS content from the user plane of the third MBS session towards the third network.

In an embodiment, establishing the user plane of the fourth MBS session towards the fourth network may comprise: for multicast transport, joining a multicast group for receiving MBS content from a Multicast/Broadcast User Plane Function (MB-UPF) in the fourth network, or for unicast transport, allocating downlink tunnel information, sending an N2 request comprising an ID of the fourth MBS session and the downlink tunnel information to a core network node in the fourth network, and receiving an N2 response comprising the ID of the fourth MBS session from the core network node in the fourth network.

In an embodiment, the N2 request is a broadcast session transport request and the N2 response is a broadcast session transport response.

In an embodiment, the two or more networks comprise a 3rd Generation Partnership Project (3GPP) network.

In an embodiment, the MBS session ID may comprise a temporary mobile group identity (TMGI).

In an embodiment, the at least one associated session ID may comprise a source-specific multicast internet protocol address used by an application node.

In an embodiment, the request is an N2 message request and the first response is an N2 message response.

In an embodiment, the N2 message request is a broadcast session setup request and the N2 message response is a broadcast session setup response.

In an embodiment, the core network node may comprise an access and mobility management function (AMF).

In an embodiment, multiple core networks are connected to the radio access network node.

In an embodiment, the predefined number of user planes may comprise one user plane.

In an embodiment, when the radio access network node receives same multicast or broadcast data originating from an application node from two or more networks, only a single copy of the same multicast or broadcast data is broadcasted and other copies of the same multicast or broadcast data are dropped.

In a second aspect of the disclosure, there is provided a method performed by a core network node in a first network. The method may comprise sending a first request to a radio access network node. The first request may comprise an MBS session identifier (ID) and at least one associated session identifier. The at least one associated session ID is used to make an association for two or more broadcast MBS sessions of two or more networks. A predefined number of user planes are expected to be established for the two or more MBS sessions.

In an embodiment, when a user plane of a first MBS session towards the first network is skipped establishing, the method may further comprise, for unicast transport, receiving a first response without downlink tunnel information from the radio access network node. The method may further comprise sending a response without downlink tunnel information to a multicast/broadcast session management function (MB-SMF) in the first network.

In an embodiment, the method may further comprise receiving a release request from a multicast/broadcast session management function (MB-SMF) in the first network. The release request may comprise the MBS session ID. The method may further comprise sending an MBS session release request to the radio access network node. The MBS session release request may comprise the MBS session ID.

In an embodiment, when the user plane of the first MBS session towards the first network is not established, the method may further comprise, for unicast transport, receiving an MBS session release response without downlink tunnel information from the radio access network node. The method may further comprise sending a release response without the downlink tunnel information to the MB-SMF in the first network.

In an embodiment, when there is a failure in a network which causes the radio access network node cannot receive MBS content from a user plane of a MBS session towards the network and a first MBS session towards the first network is selected by the radio access network node to establish a user plane, the method may further comprise, for unicast transport, receiving an N2 request comprising an ID of the first MBS session and downlink tunnel information from the radio access network node. The method may further comprise forwarding the session management (SM) information in N2 request via a notify request to a multicast/broadcast session management function (MB-SMF) in the first network. The method may further comprise receiving a notify response from the MB-SMF in the first network. The notify response may comprise the ID of the first MBS session. The method may further comprise sending the N2 response to the radio access network node.

In an embodiment, the N2 request is a broadcast session transport request and the N2 response is a broadcast session transport response.

In an embodiment, the notify request is an MBS broadcast context status notify request and the notify response is an MBS broadcast context status notify response.

In an embodiment, the two or more networks comprise a 3rd Generation Partnership Project (3GPP) network.

In an embodiment, the MBS session ID may comprise a temporary mobile group identity (TMGI).

In an embodiment, the at least one associated session ID may comprise a source-specific multicast internet protocol address used by an application node.

In an embodiment, the request is an N2 message request and the first response is an N2 message response.

In an embodiment, the N2 message request is a broadcast session setup request and the N2 message response is a broadcast session setup response.

In an embodiment, the core network node may comprise an access and mobility management function (AMF).

In an embodiment, multiple core networks are connected to the radio access network node.

In an embodiment, the predefined number of user planes may comprise one user plane.

In an embodiment, the method may further comprise receiving a MBS broadcast context create request from a Multicast/Broadcast Session Management Function (MB-SMF) in the first network. The MBS broadcast context create request may comprise the MBS session ID and the at least one associated session identifier.

In a third aspect of the disclosure, there is provided a method performed by a multicast/broadcast session management function (MB-SMF) in the first network. The method may comprise receive a MBS session create request from a Network Exposure Function (NEF) or a Multicast/Broadcast Service Function (MBSF) in the first network or an application function (AF). The MBS session create request may comprise a multicast/broadcast service (MBS) session identifier (ID) and at least one associated session ID. The at least one associated session ID is used to make an association for two or more broadcast MBS sessions of two or more networks. The method may further comprise sending a MBS broadcast context create request to an access and mobility management function (AMF) in the first network. The MBS broadcast context create request may comprise the MBS session ID and the at least one associated session ID. A predefined number of user planes are expected to be established for the two or more MBS sessions of the two or more networks.

In an embodiment, the method may further comprise receiving a notify request comprising an N2 request comprising an ID of a first MBS session and downlink tunnel information from an access and mobility management function (AMF) in the first network. The method may further comprise sending a session modification request to a Multicast/Broadcast User plane Function (MB-UPF) to allocate point-to-point transport tunnel for a replicated MBS stream for the first MBS session. The method may further comprise sending a notify response to the AMF in the first network. The notify response may comprise the ID of the first MBS session. A predefined number of user planes are expected to be established for two or more MBS sessions of two or more networks.

In an embodiment, the N2 request is a broadcast session transport request and the N2 response is a broadcast session transport response.

In an embodiment, the notify request is an MBS broadcast context status notify request and the notify response is an MBS broadcast context status notify response.

In an embodiment, the two or more networks comprise a 3rd Generation Partnership Project (3GPP) network.

In an embodiment, the ID of the first MBS session may comprise a temporary mobile group identity (TMGI).

In an embodiment, the predefined number of user planes may comprise one user plane.

In an embodiment, multiple core networks are connected to a radio access network node.

In an embodiment, the MBS session ID may comprise a temporary mobile group identity (TMGI).

In an embodiment, the at least one associated session ID may comprise a source-specific multicast internet protocol address used by an application node.

In a fourth aspect of the disclosure, there is provided a method performed by a Network Exposure Function (NEF) or MBSF or a combined NEF and MBSF in a first network. The method may comprise receiving second MBS session create request from an application node (AF). The second MBS session create request may comprise a multicast/broadcast service (MBS) session identifier (ID) and at least one associated session ID. The at least one associated session ID is used to make an association for two or more broadcast MBS sessions of two or more networks. The method may further comprise sending a first MBS session create request to a multicast/broadcast session management function (MB-SMF) in the first network. The first MBS session create request may comprise the MBS session ID and the at least one associated session ID. A predefined number of user planes are expected to be established for the two or more MBS sessions of the two or more networks.

In an embodiment, the two or more networks comprise a 3rd Generation Partnership Project (3GPP) network.

In an embodiment, the predefined number of user planes may comprise one user plane.

In an embodiment, multiple core networks are connected to a radio access network node.

In an embodiment, the MBS session ID may comprise a temporary mobile group identity (TMGI).

In an embodiment, the at least one associated session ID may comprise a source-specific multicast internet protocol address used by an application node.

In a fifth aspect of the disclosure, there is provided a method performed by an application function (AF). The method may comprise sending a second MBS session create request to a multicast/broadcast session management function (MB-SMF) or a Network Exposure Function (NEF) or MBSF or a combined NEF and MBSF in a first network. The second MBS session create request may comprise a multicast/broadcast service (MBS) session identifier (ID) and at least one associated session ID. The at least one associated session ID is used to make an association for two or more broadcast MBS sessions of two or more networks. A predefined number of user planes are expected to be established for two or more MBS sessions of the two or more networks.

In an embodiment, the two or more networks comprise a 3rd Generation Partnership Project (3GPP) network.

In an embodiment, the predefined number of user planes may comprise one user plane.

In an embodiment, multiple core networks are connected to a radio access network node.

In an embodiment, the MBS session ID may comprise a temporary mobile group identity (TMGI).

In an embodiment, the at least one associated session ID may comprise a source-specific multicast internet protocol address used by an application node.

In a sixth aspect of the disclosure, there is provided a radio access network node. The radio access network node may comprise a processor and a memory coupled to the processor. Said memory contains instructions executable by said processor. Said radio access network node is operative to receive a first request from a core network node in a first network. The first request may comprise a multicast/broadcast service (MBS) session identifier (ID) and at least one associated session identifier. The at least one associated session ID is used to make an association for two or more broadcast MBS sessions of two or more networks. Said radio access network node is further operative to, when a predefined number of user planes have been established for the two or more MBS sessions, skip establishing a user plane of a first MBS session towards the first network. Said radio access network node is further operative to, when the predefined number of user planes have not been established for the two or more MBS sessions, establish the user plane of the first MBS session towards the first network.

In a seventh aspect of the disclosure, there is provided a core network node in a first network. The core network node may comprise a processor and a memory coupled to the processor. Said memory contains instructions executable by said processor. Said core network node is operative to send a first request to a radio access network node. The first request may comprise an MBS session identifier (ID) and at least one associated session identifier. The at least one associated session ID is used to make an association for two or more broadcast MBS sessions of two or more networks. A predefined number of user planes are expected to be established for the two or more MBS sessions.

In an eighth aspect of the disclosure, there is provided a multicast/broadcast session management function (MB-SMF) in a first network. The MB-SMF may comprise a processor and a memory coupled to the processor. Said memory contains instructions executable by said processor. Said memory containing instructions executable by said processor. Said MB-SMF is operative to receive a MBS session create request from a Network Exposure Function (NEF) or a Multicast/Broadcast Service Function (MBSF) in the first network or an application function (AF). The MBS session create request may comprise a multicast/broadcast service (MBS) session identifier (ID) and at least one associated session ID. The at least one associated session ID is used to make an association for two or more broadcast MBS sessions of two or more networks. Said MB-SMF is further operative to send a MBS broadcast context create request to an access and mobility management function (AMF) in the first network. The MBS broadcast context create request may comprise the MBS session ID and the at least one associated session ID. A predefined number of user planes are expected to be established for the two or more MBS sessions of the two or more networks.

In a ninth aspect of the disclosure, there is provided a NEF or MBSF or a combined NEF and MBSF in a first network. The NEF or MBSF or combined NEF and MBSF may comprise a processor and a memory coupled to the processor. Said memory contains instructions executable by said processor. Said memory containing instructions executable by said processor. Said NEF or MBSF or combined NEF and MBSF is operative to receive a second MBS session create request from an application node (AF). The second MBS session create request may comprise a multicast/broadcast service (MBS) session identifier (ID) and at least one associated session ID. The at least one associated session ID is used to make an association for two or more broadcast MBS sessions of two or more networks. Said NEF or MBSF or combined NEF and MBSF is further operative to send a first MBS session create request to a multicast/broadcast session management function (MB-SMF) in the first network. The first MBS session create request may comprise the MBS session ID and the at least one associated session ID. A predefined number of user planes are expected to be established for the two or more MBS sessions of the two or more networks.

In a tenth aspect of the disclosure, there is provided an AF. The AF may comprise a processor and a memory coupled to the processor. Said memory contains instructions executable by said processor. Said memory containing instructions executable by said processor. Said AF is operative to send a second MBS session create request to a multicast/broadcast session management function (MB-SMF) or a Network Exposure Function (NEF) or MBSF or a combined NEF and MBSF in a first network. The second MBS session create request may comprise a multicast/broadcast service (MBS) session identifier (ID) and at least one associated session ID. The at least one associated session ID is used to make an association for two or more broadcast MBS sessions of two or more networks. A predefined number of user planes are expected to be established for two or more MBS sessions of the two or more networks.

In an eleventh aspect of the disclosure, there is provided a radio access network node. The radio access network node may comprise a first receiving module configured to receive a first request from a core network node in a first network. The first request may comprise a multicast/broadcast service (MBS) session identifier (ID) and at least one associated session identifier. The at least one associated session ID is used to make an association for two or more broadcast MBS sessions of two or more networks. The radio access network node may further comprise a first skipping module configured to receive, when a predefined number of user planes have been established for the two or more MBS sessions, skip establishing a user plane of a first MBS session towards the first network. The radio access network node may further comprise a first establishing module configured to, when the predefined number of user planes have not been established for the two or more MBS sessions, establish the user plane of the first MBS session towards the first network.

In an embodiment, the radio access network node may further comprise a second skipping module configured to, when radio resource has been allocated for broadcasting MBS content of an application node and shared by the two or more broadcast MBS sessions, skip allocating the radio resource.

In an embodiment, the radio access network node may further comprise an allocating module configured to, when the radio resource has not been allocated for broadcasting MBS content of an application node and shared by the two or more broadcast MBS sessions, allocate the radio resource.

In an embodiment, the radio access network node may further comprise an advertising module configured to advertise the MBS session ID.

In an embodiment, the radio access network node may further comprise a linking module configured to link the MBS session ID to the radio resource.

In an embodiment, the radio access network node may further comprise a creating module configured to create broadcast MBS session context including the at least one associated session ID.

In an embodiment, the radio access network node may further comprise a second receiving module configured to receive an MBS session release request from the core network node in the first network. The MBS session release request may comprise the MBS session ID.

In an embodiment, when the user plane of the first MBS session towards the first network is not established, the radio access network node may further comprise a first continuing module configured to continue content delivery of the two or more broadcast MBS sessions. The radio access network node may further comprise a first stopping module configured to stop advertisement of the MBS session ID. The radio access network node may further comprise a third skipping module configured to skip releasing the user plane of the first MBS session towards the first network.

In an embodiment, when the user plane of the first MBS session towards the first network is established and at least one other user plane for two or more broadcast MBS sessions is established, the radio access network node may further comprise a second continuing module configured to continue using radio resource allocated for broadcasting MBS content of an application node and shared by the two or more broadcast MBS sessions. The radio access network node may further comprise a third continuing module configured to continue content delivery of the two or more broadcast MBS sessions using the content received from another user plane. The radio access network node may further comprise a second stopping module configured to stop advertisement of the MBS session ID. The radio access network node may further comprise a first releasing module configured to release the user plane of the first MBS session towards the first network.

In an embodiment, the radio access network node may further comprise a second establishing module configured to, when the predefined number of user planes have not been established for the two or more MBS sessions, establish the predefined number of user planes for the two or more MBS sessions.

In an embodiment, when the user plane of the first MBS session towards the first network is established and no other user plane for two or more broadcast MBS sessions is established, the radio access network node may further comprise a first selecting module configured to select a second MBS session of the two or more broadcast MBS sessions to establish a user plane of the second MBS session towards a second network. The radio access network node may further comprise a fourth continuing module configured to continue using radio resource allocated for broadcasting MBS content of an application node and shared by the two or more broadcast MBS sessions. The radio access network node may further comprise a fifth continuing module configured to continue content delivery of the two or more broadcast MBS sessions using the content received from the user plane of the second MBS session. The radio access network node may further comprise a third stopping module configured to stop advertisement of the MBS session ID. The radio access network node may further comprise a second releasing module configured to release the user plane of the MBS session towards the first network.

In an embodiment, the radio access network node may further comprise a triggering module configured to trigger Broadcast MBS Session Release Require procedure for each associated broadcast MBS session.

In an embodiment, the radio access network node may further comprise a determining module configured to determine that the radio access network node cannot receive MBS content from a user plane of a third MBS session towards a third network.

In an embodiment, the radio access network node may further comprise a second selecting module configured to select a fourth MBS session of the two or more broadcast MBS sessions to establish a user plane of a fourth MBS session towards a fourth network.

In a twelfth sixth aspect of the disclosure, there is provided a core network node in a first network. The core network node may comprise a first sending module configured to sending a first request to a radio access network node. The first request may comprise an MBS session identifier (ID) and at least one associated session identifier. The at least one associated session ID is used to make an association for two or more broadcast MBS sessions of two or more networks. A predefined number of user planes are expected to be established for the two or more MBS sessions.

In an embodiment, when a user plane of a first MBS session towards the first network is skipped establishing, the core network node may comprise a first receiving module configured to, for unicast transport, receive a first response without downlink tunnel information from the radio access network node. The core network node may comprise a second sending module configured to send a response without downlink tunnel information to a multicast/broadcast session management function (MB-SMF) in the first network.

In an embodiment, the core network node may comprise a second receiving module configured to receive a release request from a multicast/broadcast session management function (MB-SMF) in the first network. The release request may comprise the MBS session ID.

In an embodiment, the core network node may comprise a third sending module configured to send an MBS session release request to the radio access network node. The MBS session release request may comprise the MBS session ID.

In an embodiment, when the user plane of the first MBS session towards the first network is not established, the core network node may comprise a third receiving module configured to, for unicast transport, receive an MBS session release response without downlink tunnel information from the radio access network node. The core network node may comprise a fourth sending module configured to send a release response without the downlink tunnel information to the MB-SMF in the first network.

In an embodiment, when there is a failure in a network which causes the radio access network node cannot receive MBS content from a user plane of a MBS session towards the network and a first MBS session towards the first network is selected by the radio access network node to establish a user plane, the core network node may comprise a fourth receiving module configured to, for unicast transport, receive an N2 request comprising an ID of the first MBS session and downlink tunnel information from the radio access network node. The core network node may comprise a forwarding module configured to forward the session management (SM) information in N2 request via a notify request to a multicast/broadcast session management function (MB-SMF) in the first network. The core network node may comprise a fifth receiving module configured to receive a notify response from the MB-SMF in the first network. The notify response may comprise the ID of the first MBS session. The core network node may comprise a fifth sending module configured to send the N2 response to the radio access network node.

In an embodiment, the core network node may comprise a sixth receiving module configured to receive a MBS broadcast context create request from a Multicast/Broadcast Session Management Function (MB-SMF) in the first network. The MBS broadcast context create request may comprise the MBS session ID and the at least one associated session identifier.

In a thirteenth aspect of the disclosure, there is provided an MB-SMF in the first network. The MB-SMF may comprise a first receiving module configured to receive a MBS session create request from a Network Exposure Function (NEF) or a Multicast/Broadcast Service Function (MBSF) in the first network or an application function (AF). The MBS session create request may comprise a multicast/broadcast service (MBS) session identifier (ID) and at least one associated session ID. The at least one associated session ID is used to make an association for two or more broadcast MBS sessions of two or more networks. The MB-SMF may further comprise a first sending module configured to send a MBS broadcast context create request to an access and mobility management function (AMF) in the first network. The MBS broadcast context create request may comprise the MBS session ID and the at least one associated session ID. A predefined number of user planes are expected to be established for the two or more MBS sessions of the two or more networks.

In an embodiment, the MB-SMF may further comprise a second receiving module configured to receive a notify request comprising an N2 request comprising an ID of a first MBS session and downlink tunnel information from an access and mobility management function (AMF) in the first network. The MB-SMF may comprise a second sending module configured to send a session modification request to a Multicast/Broadcast User plane Function (MB-UPF) to allocate point-to-point transport tunnel for a replicated MBS stream for the first MBS session. The MB-SMF may comprise a third sending module configured to send a notify response to the AMF in the first network. The notify response may comprise the ID of the first MBS session.

In a fourteenth aspect of the disclosure, there is provided an NEF or MBSF or combined NEF and MBSF in the first network. The NEF or MBSF or combined NEF and MBSF may comprise a receiving module configured to receive a second MBS session create request from an application node (AF). The second MBS session create request may comprise a multicast/broadcast service (MBS) session identifier (ID) and at least one associated session ID. The at least one associated session ID is used to make an association for two or more broadcast MBS sessions of two or more networks. The NEF or MBSF or combined NEF and MBSF may further comprise a sending module configured to send a first MBS session create request to a multicast/broadcast session management function (MB-SMF) in the first network. The first MBS session create request may comprise the MBS session ID and the at least one associated session ID. A predefined number of user planes are expected to be established for the two or more MBS sessions of the two or more networks.

In a fifteenth aspect of the disclosure, there is provided an AF. The AF may comprise a sending module configured to send a second MBS session create request to a multicast/broadcast session management function (MB-SMF) or a Network Exposure Function (NEF) or MBSF or a combined NEF and MBSF in a first network. The second MBS session create request may comprise a multicast/broadcast service (MBS) session identifier (ID) and at least one associated session ID. The at least one associated session ID is used to make an association for two or more broadcast MBS sessions of two or more networks. A predefined number of user planes are expected to be established for two or more MBS sessions of the two or more networks.

In a sixteenth aspect of the disclosure, there is provided a computer-readable storage medium storing instructions which when executed by at least one processor, cause the at least one processor to perform any of the methods according to the first, second, third, fourth and fifth aspects of the disclosure.

In a seventeenth aspect of the disclosure, there is provided a computer program product, comprising instructions which, when executed on at least one processor, cause the at least one processor to carry out any of the methods according to the first, second, third, fourth and fifth aspects of the disclosure.

In another aspect of the disclosure, there is provided a communication system including a host computer. The host computer includes processing circuitry configured to provide user data and a communication interface configured to forward the user data to a cellular network for transmission to a terminal device. The cellular network includes the network device (such as radio access network node above mentioned), and/or the terminal device (such as UE).

In embodiments of the present disclosure, the system further includes the terminal device. The terminal device is configured to communicate with the network device.

In embodiments of the present disclosure, the processing circuitry of the host computer is configured to execute a host application, thereby providing the user data; and the terminal device includes processing circuitry configured to execute a client application associated with the host application.

In another aspect of the disclosure, there is provided a communication system including a host computer and a network device. The host computer includes a communication interface configured to receive user data originating from a transmission from a terminal device. The transmission is from the terminal device to the network device. The network device is above mentioned radio access network node.

In embodiments of the present disclosure, the processing circuitry of the host computer is configured to execute a host application. The terminal device is configured to execute a client application associated with the host application, thereby providing the user data to be received by the host computer.

In another aspect of the disclosure, there is provided a method implemented in a communication system which may include a host computer, a network device and a terminal device. The method may comprise providing user data at the host computer. Optionally, the method may comprise, at the host computer, initiating a transmission carrying the user data to the terminal device via a cellular network comprising the network device which may perform any step of the methods according to the first aspect of the present disclosure.

In another aspect of the disclosure, there is provided a communication system including a host computer. The host computer may comprise processing circuitry configured to provide user data, and a communication interface configured to forward the user data to a cellular network for transmission to a terminal device. The cellular network may comprise a network device having a radio interface and processing circuitry. The network device's processing circuitry may be configured to perform any step of the methods according to the first aspect of the present disclosure.

In another aspect of the disclosure, there is provided a method implemented in a communication system which may include a host computer, a network device and a terminal device. The method may comprise providing user data at the host computer. Optionally, the method may comprise, at the host computer, initiating a transmission carrying the user data to the terminal device via a cellular network comprising the network device.

In another aspect of the disclosure, there is provided a communication system including a host computer. The host computer may comprise processing circuitry configured to provide user data, and a communication interface configured to forward user data to a cellular network for transmission to a terminal device. The terminal device may comprise a radio interface and processing circuitry.

In another aspect of the disclosure, there is provided a method implemented in a communication system which may include a host computer, a network device and a terminal device. The method may comprise, at the host computer, receiving user data transmitted to the network device from the terminal device.

In another aspect of the disclosure, there is provided a communication system including a host computer. The host computer may comprise a communication interface configured to receive user data originating from a transmission from a terminal device to a network device. The terminal device may comprise a radio interface and processing circuitry.

In another aspect of the disclosure, there is provided a method implemented in a communication system which may include a host computer, a network device and a terminal device. The method may comprise, at the host computer, receiving, from the network device, user data originating from a transmission which the network device has received from the terminal device. The network device may perform any step of the methods according to the first aspect of the present disclosure.

In another aspect of the disclosure, there is provided a communication system which may include a host computer. The host computer may comprise a communication interface configured to receive user data originating from a transmission from a terminal device to a network device. The network device may comprise a radio interface and processing circuitry. The network device's processing circuitry may be configured to perform any step of the methods according to the first aspect of the present disclosure.

Many advantages may be achieved by applying the proposed solution according to embodiments of the present disclosure. For example, in some embodiments herein, for MOCN RAN sharing scenario, the RAN establishes a predefined number of user plane towards multiple CNs where multiple broadcast MBS session associated with the associated session identifier are established. In some embodiments herein, when there is a failure in the CN (which cause the RAN cannot receive packets), the RAN switches to another CN to establish the user plane. In some embodiments herein, it provides an efficient and robust solution. In some embodiments herein, it is efficient on that there is the predefined number of user plane established, which can avoid unnecessary user planes between the RAN and the MB-UPFs in other CNs. In some embodiments herein, it can further avoid RAN handling on duplicated packets (the packets received from the MB-UPFs in other CNs), as well as the MB-UPF handling. In some embodiments herein, it is robust on that the RAN can establish user plane towards another CN when there is a failure in the CN, and continue to use the packets received from the newly established user plane to offer the service towards UEs. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1A shows an example of delivery methods;

FIG. 1B shows 5G system architecture for Multicast and Broadcast Service;

FIG. 1C shows a 5G System architecture for Multicast and Broadcast Service in reference point representation;

FIG. 1D shows a flowchart of Broadcast Session Establishment for MOCN network sharing;

FIG. 1E shows a flowchart of Broadcast Session Release for MOCN network sharing;

FIG. 1F shows a flowchart of MBS Session Creation for MOCN RAN sharing;

FIG. 1G shows a flowchart of MBS Session Start for Broadcast for MOCN RAN sharing;

FIG. 1H shows a flowchart of MBS Session Release for Broadcast for MOCN RAN sharing;

FIG. 1I shows an MBS example scenario including MOCN network sharing;

FIG. 1J shows a flowchart of Procedure for Broadcast using MOCN TMGI;

FIG. 1K shows a flowchart of Procedure for Broadcast Session start for MOCN NG-RAN;

FIG. 2A shows a flowchart of a method according to an embodiment of the present disclosure;

FIG. 2B shows a flowchart of a method according to another embodiment of the present disclosure;

FIG. 2C shows a flowchart of a method according to another embodiment of the present disclosure;

FIG. 2D shows a flowchart of a method according to another embodiment of the present disclosure;

FIG. 2E shows a flowchart of a method according to another embodiment of the present disclosure;

FIG. 2F shows a flowchart of a method according to another embodiment of the present disclosure;

FIG. 2G shows a flowchart of a method according to another embodiment of the present disclosure;

FIG. 2H shows a flowchart of a method according to another embodiment of the present disclosure;

FIG. 2I shows a flowchart of a method according to another embodiment of the present disclosure;

FIG. 2J shows a flowchart of a method according to another embodiment of the present disclosure;

FIG. 3A shows a flowchart of a method according to another embodiment of the present disclosure;

FIG. 3B shows a flowchart of a method according to another embodiment of the present disclosure;

FIG. 3C shows a flowchart of a method according to another embodiment of the present disclosure;

FIG. 3D shows a flowchart of a method according to another embodiment of the present disclosure;

FIG. 3E shows a flowchart of a method according to another embodiment of the present disclosure;

FIG. 3F shows a flowchart of a method according to another embodiment of the present disclosure;

FIG. 4A shows a flowchart of a method according to another embodiment of the present disclosure;

FIG. 4B shows a flowchart of a method according to another embodiment of the present disclosure;

FIG. 5A shows a flowchart of a method according to another embodiment of the present disclosure;

FIG. 5B shows a flowchart of a method according to another embodiment of the present disclosure;

FIG. 5C shows a flowchart of MBS Session Creation for MOCN RAN sharing according to another embodiment of the present disclosure;

FIG. 6 shows a flowchart of MBS Session Start for Broadcast for MOCN RAN sharing according to another embodiment of the present disclosure;

FIG. 7 shows a flowchart of MBS Session Release for Broadcast for MOCN RAN sharing according to another embodiment of the present disclosure;

FIG. 8 shows a flowchart of Broadcast MBS Session Release Require according to another embodiment of the present disclosure;

FIG. 9A is a block diagram showing an apparatus suitable for practicing some embodiments of the disclosure;

FIG. 9B is a block diagram showing a radio access network node according to an embodiment of the disclosure;

FIG. 9C is a block diagram showing a core network node in a first network according to an embodiment of the disclosure;

FIG. 9D is a block diagram showing an MB-SMF in the first network according to an embodiment of the disclosure;

FIG. 9E is a block diagram showing an NEF in the first network according to an embodiment of the disclosure;

FIG. 9F is a block diagram showing an AF in the first network according to an embodiment of the disclosure;

FIG. 10 is a schematic showing a wireless network in accordance with some embodiments;

FIG. 11 is a schematic showing a user equipment in accordance with some embodiments;

FIG. 12 is a schematic showing a virtualization environment in accordance with some embodiments;

FIG. 13 is a schematic showing a telecommunication network connected via an intermediate network to a host computer in accordance with some embodiments;

FIG. 14 is a schematic showing a host computer communicating via a base station with a user equipment over a partially wireless connection in accordance with some embodiments;

FIG. 15 is a schematic showing methods implemented in a communication system including a host computer, a base station and a user equipment in accordance with some embodiments;

FIG. 16 is a schematic showing methods implemented in a communication system including a host computer, a base station and a user equipment in accordance with some embodiments;

FIG. 17 is a schematic showing methods implemented in a communication system including a host computer, a base station and a user equipment in accordance with some embodiments; and

FIG. 18 is a schematic showing methods implemented in a communication system including a host computer, a base station and a user equipment in accordance with some embodiments.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G communication protocols, and/or any other protocols either currently known or to be developed in the future.

The term “network device” or “network node” or “network function (NF)” refers to any suitable function which can be implemented in a network element (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and mobility management function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc. For example, the 4G system (such as LTE) may include MME (Mobile Management Entity), HSS (home subscriber server), Policy and Charging Rules Function (PCRF), Packet Data Network Gateway (PGW), PGW control plane (PGW-C), Serving gateway (SGW), SGW control plane (SGW-C), E-UTRAN Node B (eNB), etc. In other embodiments, the network function may comprise different types of NFs for example depending on a specific network.

The network device may be a core network device/node. For example, in 5GS, the network device may comprise AMF, SMF, AUSF, UDM, PCF, NEF, UPF, NRF, SCP, NWDAF, NSSF, NSSAAF, etc. For example, the 4G system, the network device may comprise MME, HSS, PCRF, PGW, PGW-C, SGW, SGW-C, etc.

The network device may be an access network device/node with accessing function in a communication network via which a terminal device accesses to the network and receives services therefrom. The access network device may include a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), an Integrated Access and Backhaul (IAB) node, a remote radio head (RRH), a relay, a low power node such as a femto, a pico, and so forth.

Yet further examples of the access network device comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VoIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “may comprise”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

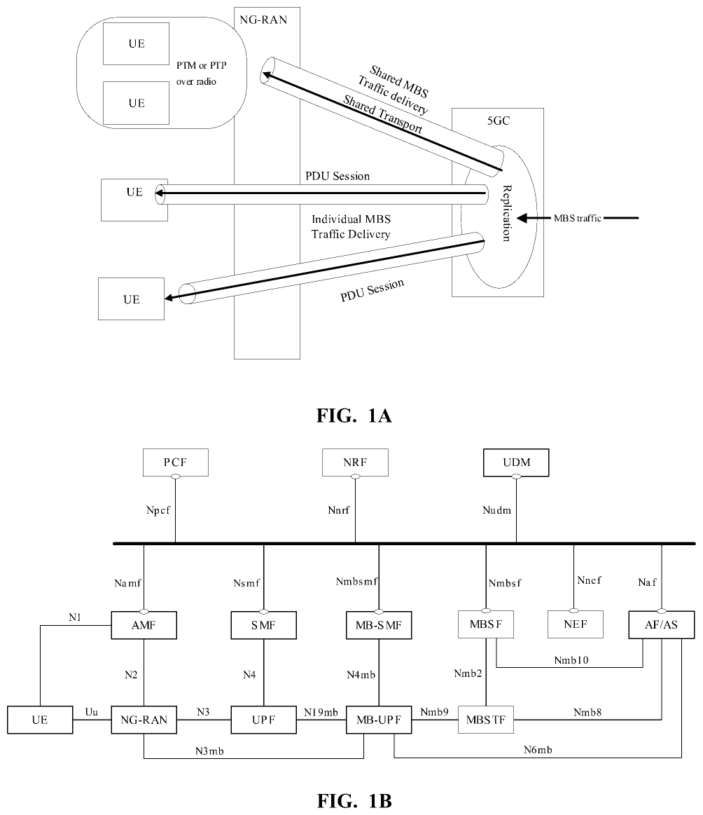

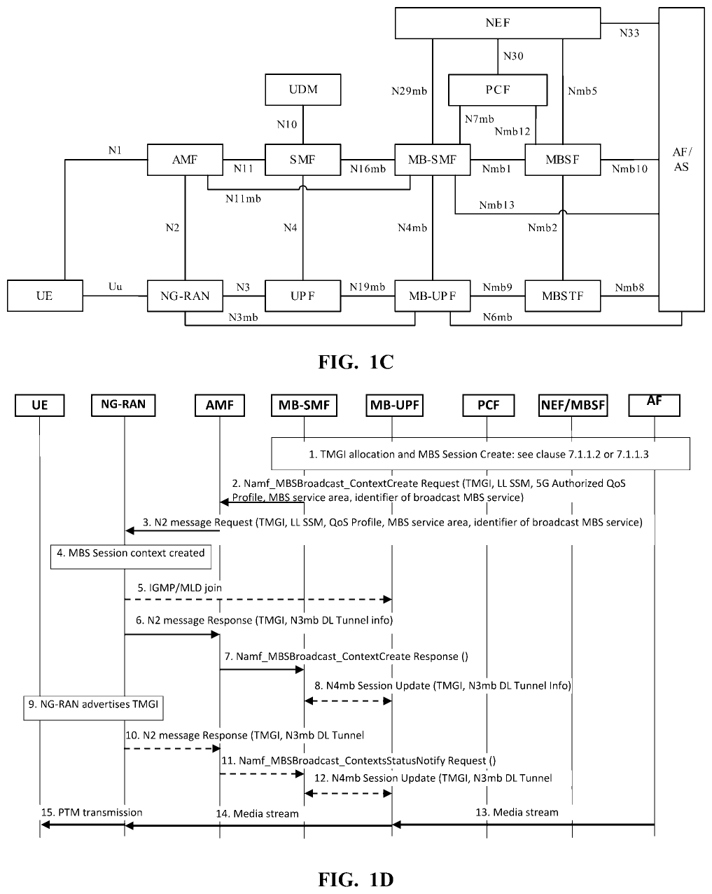

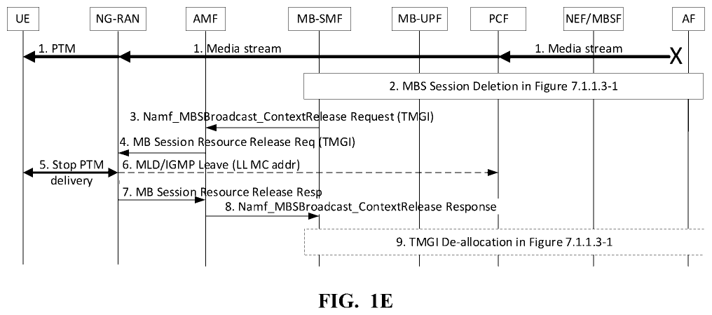

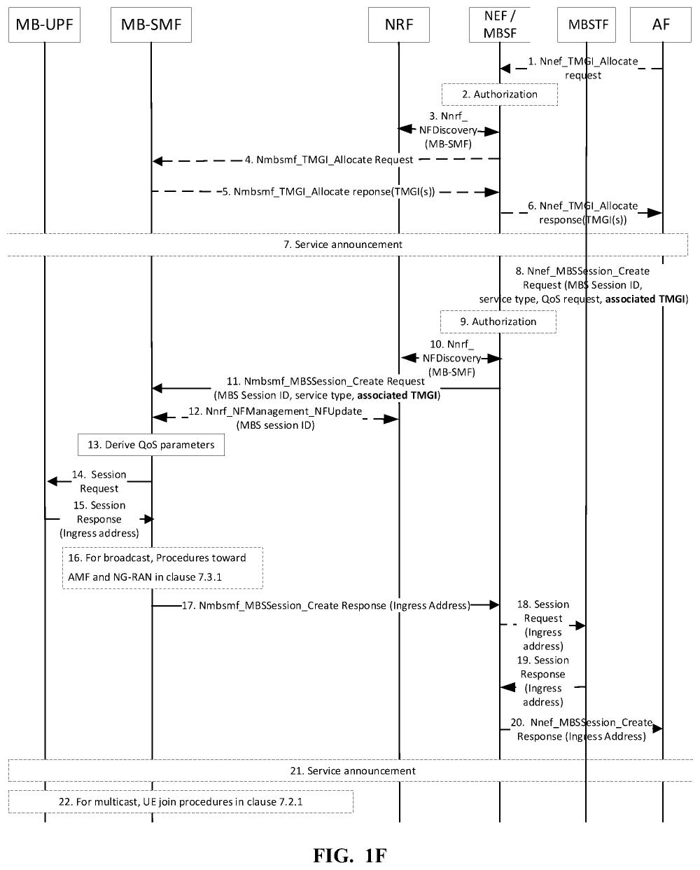

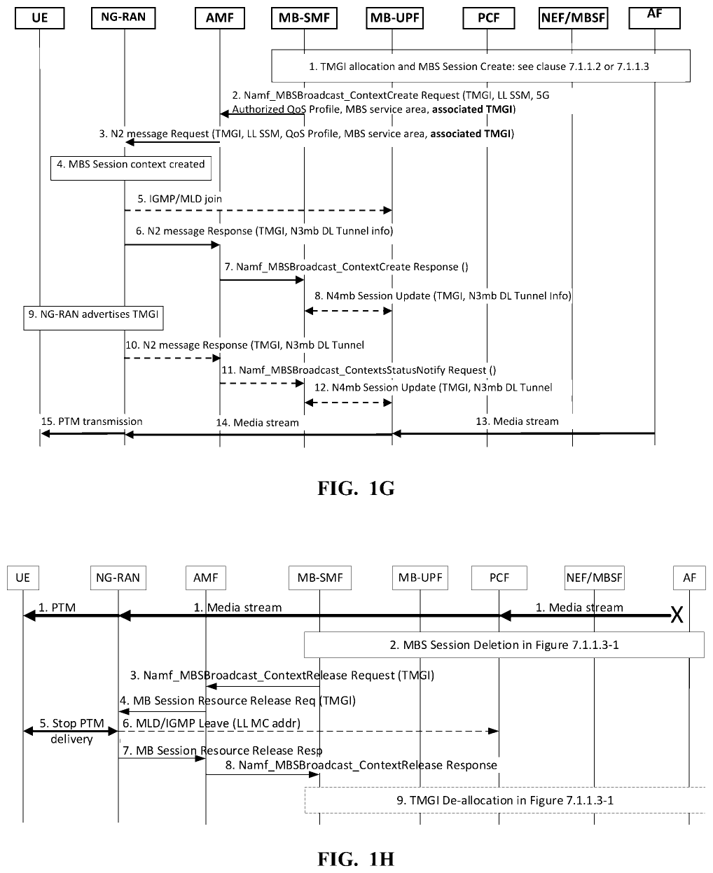

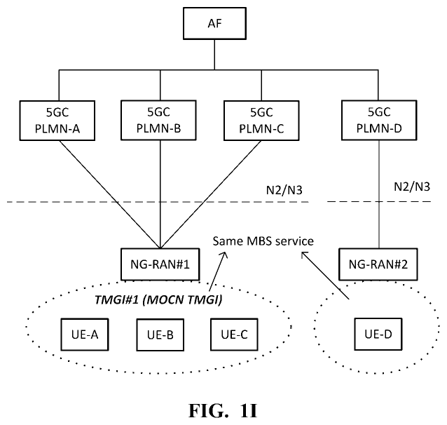

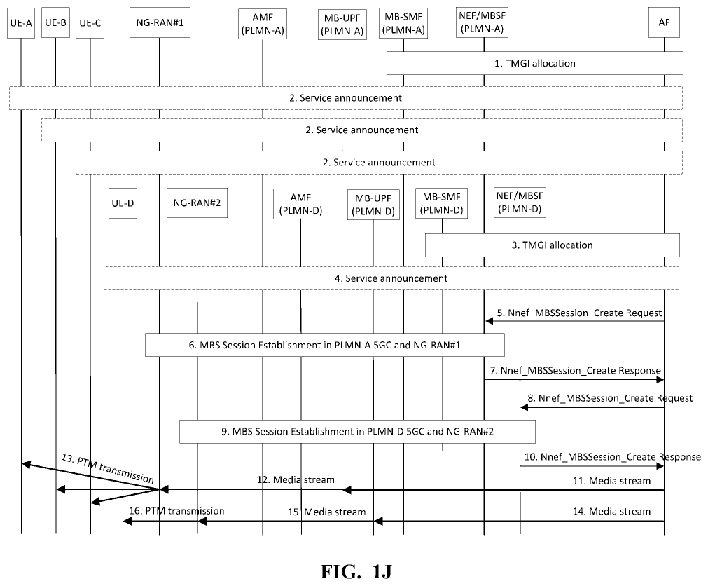

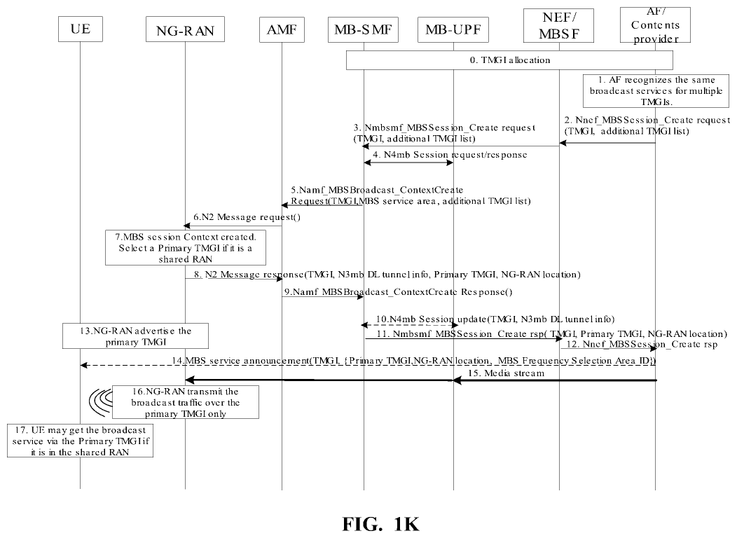

Although the subject matter described herein may be implemented in any appropriate type of system using any suitable components, the embodiments disclosed herein are described in relation to a communication system complied with the exemplary system architecture illustrated in FIG. 1B and FIG. 1C. For simplicity, the system architecture of FIG. 1B and FIG. 1C only depicts some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

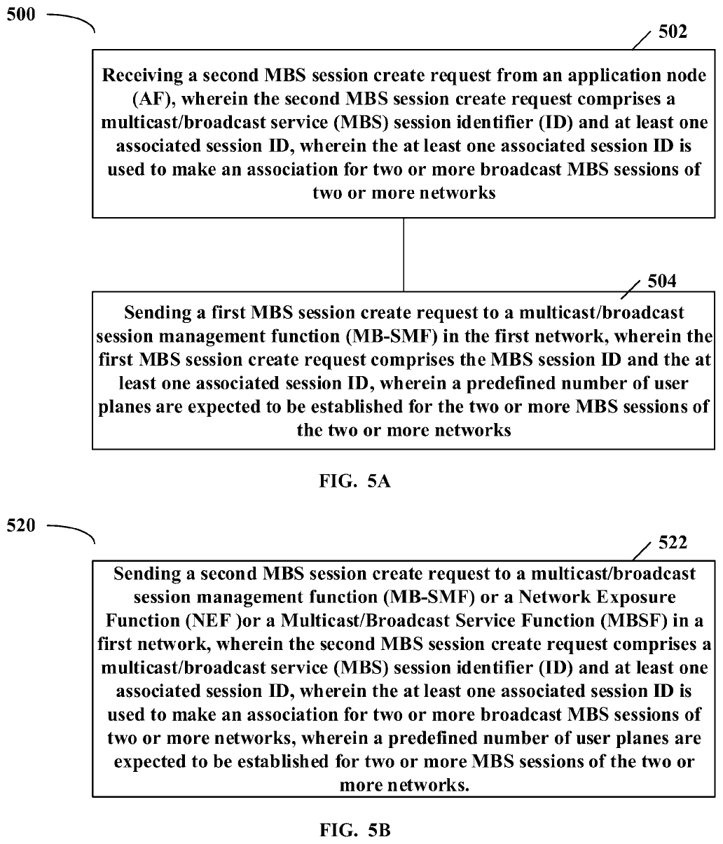

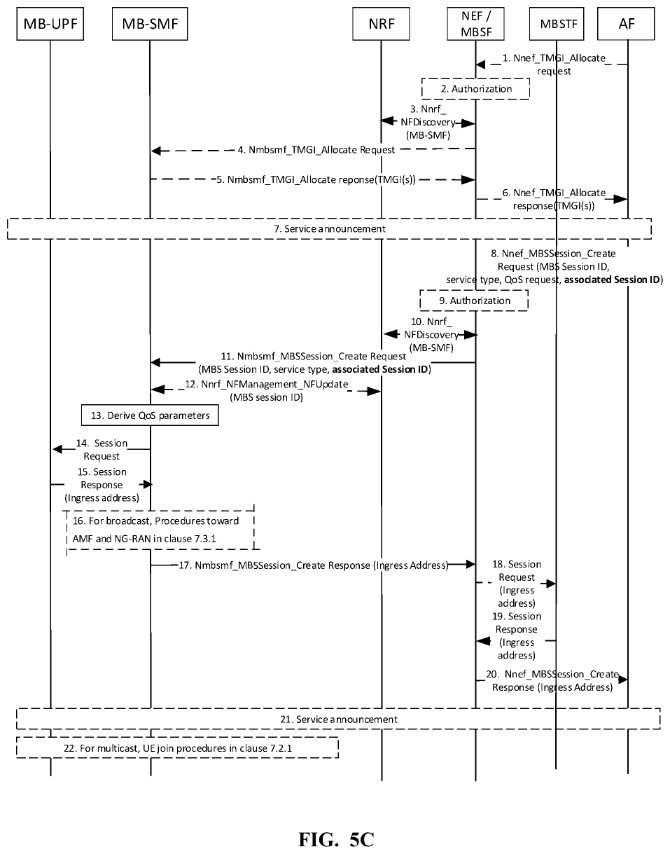

FIG. 1B shows 5G system architecture for Multicast and Broadcast Service, which is same as FIGS. 5.1-1 of 3GPP TS 23.247 V17.2.0. FIG. 1C shows a 5G System architecture for Multicast and Broadcast Service in reference point representation, which is same as FIGS. 5.1-2 of 3GPP TS 23.247 V17.2.0. The 5G MBS system architecture may comprise functional entities such as PCF (Policy Control Function), MB-SMF (Multicast/Broadcast Session Management Function), SMF (Session Management Function), MB-UPF (Multicast/Broadcast User plane Function), UPF (User plane Function), AMF (Access and mobility management function), NG-RAN (next generation radio access network), UE (user equipment), AF/AS (Application Function/Application Server), NEF (Network Exposure Function), MBSF (Multicast/Broadcast Service Function), MBSTF (Multicast/Broadcast Service Transport Function), UDM (Unified Data Management), UDR (Unified Data Repository), NRF (Network Repository Function), etc. These functional entities have been described in clause 5.3.2 of 3GPP TS 23.247 V17.2.0.

The MBSF is optional and may be collocated with the NEF or AF/AS, and the MBSTF is an optional network function.

The existing service-based interfaces of Nnrf, Nudm, and Nsmf are enhanced to support MBS. The existing service-based interfaces of Npcf and Nnef are enhanced to support MBS.

A MBS-enabled AF uses either Nmbsf or Nnef to interact with the MBSF.

SMF and MB-SMF may be co-located or deployed separately.

The MBS System Architecture may contain the following reference points:

N3mb: Reference point between the (R)AN and the MB-UPF.

N4mb: Reference point between the MB-SMF and the MB-UPF.

N6mb: Reference point between the MB-UPF and the AF/AS.

N7mb: Reference point between the MB-SMF and the PCF.

N11mb: Reference point between the AMF and the MB-SMF.

N16mb: Reference point between the SMF and the MB-SMF.

N19mb: Reference Point between the UPF and the MB-UPF.

N29mb: Reference point between the MB-SMF and the NEF.

Nmb1: Reference point between the MB-SMF and the MBSF.

Nmb2: Reference point between the MBSF and the MBSTF.

Nmb5: Reference point between the MBSF and the NEF.

Nmb8: Reference point between the MBSTF and the AF.

Nmb9: Reference point between the MB-UPF and the MBSTF.

Nmb10: Reference point between the MBSF and the AF.

Nmb12: Reference point between the MBSF and the PCF.

Nmb13: Reference point between the MB-SMF and the AF.

The existing reference points of N1, N2, N4, N10, N11, N30 and N33 are enhanced to support MBS.

Regarding the functionalities, Nmb13, N29mb and Nmb1 are identical, Nmb5 and Nmb10 are identical, Nmb9 and N6mb are identical.

Solutions related with MBS MOCN RAN Sharing from 3GPP TR 23.700-47 V0.2.0 are described below.

The following italics content is a copy of clause 6.2 of 3GPP TR 23.700-47 V0.2.0.

### Solution #2: Procedures for MOCN Network Sharing

This solution addresses Key Issue #2 of 3GPP TR 23.700-47 V0.2.0.

It is assumed to reuse the current architecture and TMGI definition in Rel-17 MBS work (see TS 23.247 [4]). In other words, MB-SMF is used to handle MBS session-level management while SMF performs per-UE MBS session management, e.g. authorization, multicast session information provisioning, managing 5GC Individual MBS traffic delivery.

In general the proposal is based on the additional identifier (i.e. identifier of the broadcast MBS service) provided by AF during MBS session Create procedure. The identifier of the broadcast MBS service is non-PLMN specific, which would be included and the same when AF sends requests for establishing the broadcast MBS session for the same broadcast MBS service to different PLMNs. The MB-SMF includes the received identifier in the N2 MB-SM container, and provided to NG-RAN node.

It is assumed that for the MBS sessions identified by the same “identifier of the broadcast MBS service”, the NG-RAN node will use the same radio resources, but still broadcast the TMGIs for different PLMNs. In other words:
UE: UEs of different PLMNs behave the same as Rel-17, i.e. listen to the control channel of the TMGIs broadcasted by the NG-RAN node and receive the broadcast data.
NG-RAN node: NG-RAN node behave the same as Rel-17, i.e. broadcasts the TMGIs of different PLMNs, but the NG-RAN node also use the same radio resources for transmitting the MBS data of different TMGIs but with the same “identifier of the broadcast MBS service”.

The message names in the procedures below are descriptive. It is assumed that the names are updated with corresponding SBI based names where applicable during the normative phase.

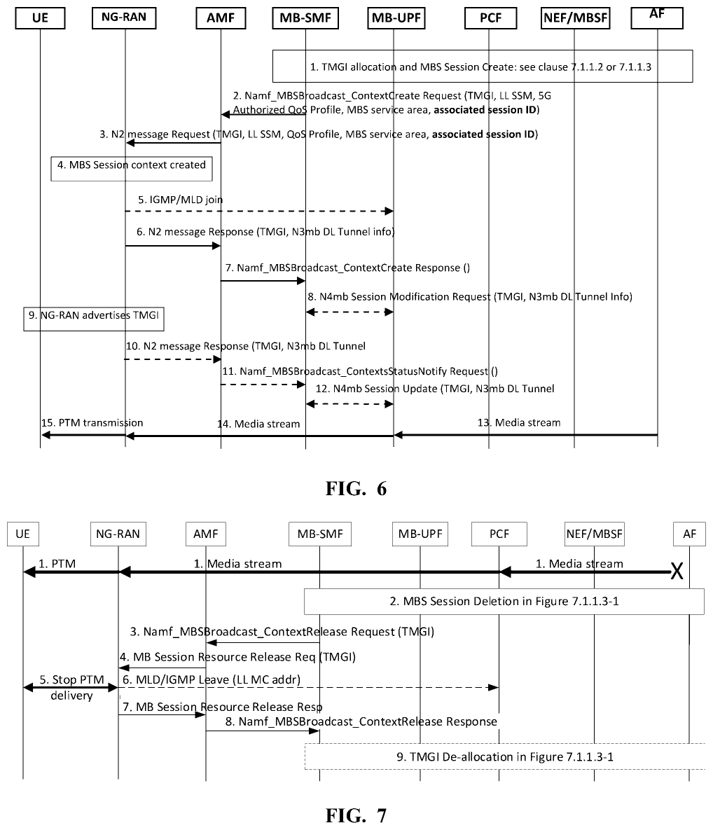

FIG. 1D shows a flowchart of Broadcast Session Establishment for MOCN network sharing, which is same as FIG. 6.2.3.2-1 of 3GPP TR 23.700-47 V0.2.0.

The following additions apply compared to clause 7.3.1 of 3GPP TS 23.247 V17.2.0:

1. AF performs TMGI allocation and MBS session creation as specified in clause 7.1.1.2 or clause 7.1.1.3 of TS 23.247 [4]. The AF further includes the identifier of the broadcast MBS service in MBS session creation request.

2. MB-SMF invokes Namf_MBSBroadcast_ContextCreate Request with further including identifier of the broadcast MBS service in the N2 SM container received in step 1.

4. NG-RAN node creates a Broadcast MBS Session Context, stores the TMGI, the QoS Profile and the identifier of the broadcast MBS service in the MBS Session Context, if the Broadcast MBS Session Context does not exist (i.e. the other PLMN network sharing the NG-RAN node has not requested for the same broadcast MBS service to be established at the NG-RAN node).

If the NG-RAN node already exists, i.e. NG-RAN nodes stores the same “identifier of the broadcast MBS service” in the MBS Session Context of other MBS session, then the NG-RAN node reuses the previously allocated radio resources of the MBS session identified by the same “identifier of the broadcast MBS service”, as the one for the newly requested MBS session. In other words, all MBS sessions having the same “identifier of the broadcast MBS service” shares the radio resources. When the NG-RAN node receives the DL MBS data of the requested MBS session afterwards, it will not send the received data in the air interface.

9. NG-RAN broadcasts the TMGI representing the MBS service over radio interface.

NOTE: This step is same as the session start procedure in TS 23.247 [4]; it is included here for the sake of clarity.

FIG. 1E shows a flowchart of Broadcast Session Release for MOCN network sharing, which is same as FIG. 6.2.3.3-1 of 3GPP TR 23.700-47 V0.2.0.

The following additions apply compared to clause 7.3.2 of 3GPP TS 23.247 V17.2.0:

4. After NG-RAN node receives multiple N2 messages to release the MBS Session for the TMGI (e.g. from several AMFs the NG-RAN is connected to), if there is no other PLMN requesting to the broadcast MBS service, the NG-RAN node performs step 5 and step 6.

If the MBS session is about to be released, and 1) the NG-RAN nodes uses its MBS data as the one sending in the air interface, and 2) there are other MBS sessions identified by the same “identifier of the broadcast MBS service”, then the NG-RAN node will select DL data of one other MBS session of the same “identifier of the broadcast MBS service” and send its data using the previous allocated radio resources.

Impacts on services, entities and interfaces

Functional entities defined in clause 5.3.2 of TS 23.247 [4] is reused exception for the following additions:

### AF, NEF:

Support to provide/process the identifier of the broadcast MBS service during broadcast session establishment procedure.

### MB-SMF:

Include the identifier of the broadcast MBS service to the N2 SM container sent to NG-RAN node.

### NG-RAN:

Support to identify the broadcast MBS service from 5GC and use the same resources for the same broadcast MBS service.
Support to configure radio bearer of the MBS sessions with the same “identifier of the broadcast MBS service” with the same radio resources.
Refrain from sending the data of the subsequently established MBS session with the same “identifier of the broadcast MBS service” to the UEs.

The following italics content is a copy of clause 6.7 of 3GPP TR 23.700-47 V0.2.0.

### Solution #7: MOCN RAN Sharing

This solution addresses Key Issue #2 of 3GPP TR 23.700-47 V0.2.0.

### Functional Description

This solution utilizes the first allocated TMGI to be the identifier to associate broadcast MBS sessions from different CNs which transmitting the same content.

The AF gets the TMGI from the broadcast MBS session which is created first. The AF provides it as an associated TMGI to the other CNs when creating other broadcast MBS sessions with the same broadcast content. In other CNs, MB-SMF provides the associated TMGI to the NG-RAN via AMF. And then, NG-RAN can utilize the associated TMGI to associate those broadcast MBS sessions.

NG-RAN establishes the user planes for all broadcast MBS sessions. Based on the association information, the NG-RAN deliver only one broadcast MBS session over the air (the broadcast MBS session which is created firstly) and drop the packets from other broadcast MBS sessions.

It is FFS (for future study) whether NG-RAN should avoid establishing UP resources for the second and later broadcast MBS sessions for more saving.

In the service announcement for all broadcast MBS sessions delivering the same content, AF provides all the relevant TMGIs to the UEs. The UEs can check SIB to listen to any of the TMGIs to receive content.

It is FFS whether the UEs can avoid the scanning of all TMGIs when receiving contents.

Support of the encrypted content reception is FFS.

The message names in the procedures below are descriptive. It is assumed that the names are updated with corresponding SBI based names where applicable during the normative phase.

FIG. 1F shows a flowchart of MBS Session Creation for MOCN RAN sharing, which is same as FIG. 6.7.3.2-1 of 3GPP TR 23.700-47 V0.2.0.

In the service announcement for all broadcast MBS sessions delivering the same content, AF provides all the relevant TMGIs to the UE.

AF creates the first broadcast MBS session as clause 7.1.1.2 of TS 23.247 [4], and AF utilizes the TMGI of this broadcast MBS session to the associated TMGI.

The following additions apply compared to clause 7.1.1.2 of TS 23.247 [4] when AF creating the second and later broadcast MBS sessions:

8. The AF provides the TMGI of the broadcast MBS session which is created first as the associated TMGI to the NEF/MBSF when invoking Nnef_MBSSession_Create Request.

11. The NEF/MBSF provides the associated TMGI to the MB-SMF when invoking Nmbsmf_MBSSession_Create Request. The MB-SMF stores the associated TMGI as a part of the MBS session context to be further distributed to NG-RAN in clause 6.7.3.3.

The same updates apply to clause 7.1.1.3 of TS 23.247 [4].

FIG. 1G shows a flowchart of MBS Session Start for Broadcast for MOCN RAN sharing, which is same as FIG. 6.7.3.3-1 of 3GPP TR 23.700-47 V0.2.0.

The following additions apply compared to clause 7.3.1 of TS 23.247 [4] when MBS Session Start for the second and later broadcast MBS sessions:

2-3. The MB-SMF provides the associated TMGI in the N2 SM container to the NG-RAN via AMF.

4. The NG-RAN creates the Broadcast MBS Session context including the associated TMGI

9. If the NG-RAN understands the broadcast MBS Session is associated with another Broadcast MBS Session identified by the associated TMGI whose content has been delivered over the air, the NG-RAN will not further advertise the TMGI of this broadcast MBS Session.

15. If the NG-RAN understands the broadcast MBS Session is associated with another Broadcast MBS Session identified by the associated TMGI whose content has been delivered over the air, the NG-RAN can silently drop packets received in this broadcast MBS session, and do not deliver them again.

It is FFS whether NG-RAN should avoid establishing UP resources for the second and later broadcast MBS sessions for more saving.

FIG. 1H shows a flowchart of MBS Session Release for Broadcast for MOCN RAN sharing, which is same as FIG. 6.7.3.4-1 of 3GPP TR 23.700-47 V0.2.0.

The following additions apply compared to clause 7.3.2 of TS 23.247 [4] when MBS Session Release for the broadcast MBS session which is created firstly:

5. If the NG-RAN determines there are other associated broadcast MBS sessions available, while the first broadcast MBS session is going to be released, it selects another broadcast MBS session. For this selected broadcast MBS session, the NG-RAN stop dropping the packets, advertise the TMGI of the selected session and deliver the packets over the air.

It is FFS whether the random selection in the NG-RAN can be improved.

Impacts on services, entities and interfaces.

Functional entities defined in clause 5.3.2 of TS 23.247 [4] are reused exception for the following additions:

### AF:

Use the TMGI for the broadcast MBS session which is created first and provide it as the associated TMGI to 5GC when creating MBS session for the second and later broadcast MBS sessions.
In the service announcement, include all the relevant TMGIs whose broadcast sessions are used to deliver the same content.

### NEF:

Provides the associated TMGI to the MB-SMF if received in MBS Session Creation.

### MB-SMF:

Provides the associated TMGI to the NG-RAN if received in MBS Session Start for Broadcast.

### NG-RAN:

Support the associated TMGI and understand the association among those broadcast MBS sessions which delivers the same content.
If the content is delivered in one broadcast MBS session over the air, drop the packets received from other broadcast MBS sessions and do not further advertise other TMGIs.
If the broadcast MBS session that is used to deliver the content is released and there are other associated broadcast MBS sessions available, select another broadcast MBS session, stop dropping the packets of this broadcast MBS session, advertise the TMGI of the selected session and deliver the packets over the air.

UE impacts and other additional impacts are FFS.

The following italics content is a copy of clause 6.8 of 3GPP TR 23.700-47 V0.2.0.

### Solution #8: Allocating and Using MOCN TMGI

This solution addresses key issue #2 “5MBS MOCN Network Sharing”.

### Functional Description

The proposed solution introduces a MOCN TMGI used for MBS session when the related MBS service needs to be provided over PLMNs (Public Land Mobile Networks) sharing NG-RANs. A MOCN TMGI is allocated by one of the PLMNs and the MBS session identified by the MOCN TMGI is established only with the PLMN that has allocated the MOCN TMGI. The AF transmits the DL media stream to the PLMN that the MBS session was established. Therefore, the NG-RAN shared by the multiple PLMNs receives the DL media stream only from the 5GC of the PLMN that the MBS session was established and transmits the media stream by using the MOCN TMGI.

For the MOCN TMGI, a Shared PLMN ID needs to be created and used by the PLMNs sharing NG-RANs. All the MB-SMFs in the PLMNs sharing NG-RANs are configured with the Shared PLMN ID so that the MB-SMFs can allocate the MOCN TMGIs.

FIG. 1I shows an MBS example scenario including MOCN network sharing, which is same as FIG. 6.8.2-1 of 3GPP TR 23.700-47 V0.2.0.
The AF wants to provide MBS service over PLMN-A, PLMN-B, PLMN-C and PLMN-D, i.e. to the UEs that are served by these PLMNs.
UE-A, UE-B, UE-C and UE-D are served by PLMN-A, PLMN-B, PLMN-C and PLMN-D, respectively.
NG-RAN #1 is shared by PLMN-A, PLMN-B and PLMN-C while NG-RAN #2 belongs only to PLMN-D.
NG-RAN #1 and NG-RAN #2 covers the MBS service area for the MBS service provided by the AF.
The AF is configured about which PLMNs share the NG-RAN, i.e. PLMN-A, PLMN-B and PLMN-C.

The outline of the proposed solution for allocating and using MOCN TMGI is as below:
The AF performs TMGI allocation with only one PLMN among PLMNs sharing the NG-RANs to obtain a TMGI to identify new MBS session by indicating that MOCN TMGI allocation is requested (e.g. with PLMN-A in FIG. 1).
The MB-SMF allocates a MOCN TMGI and returns it to the AF.
The AF performs MBS session establishment with the PLMN that has allocated the MOCN TMGI
The AF transmits the DL media stream to the PLMN that the MBS session was established.

FIG. 1J shows a flowchart of Procedure for Broadcast using MOCN TMGI, which is same as FIG. 6.8.3.1-1 of 3GPP TR 23.700-47 V0.2.0.

This procedure is based on the MBS example scenario depicted in FIG. 1I.

1. The AF requests TMGI allocation with one of PLMNs that it wants to provide broadcast service over. In this figure, the AF performs TMGI allocation with PLMN-A to obtain a TMGI to identify new MBS session.

Steps 1 to 6 in clause 7.1.1.2 or clause 7.1.1.3 of TS 23.247 [4] are performed with the following differences:
In step 1, the following information is provided by the AF when requesting TMGI allocation.

a) A list of PLMNs that the AF wants to provide MBS service (i.e. PLMN-A, PLMN-B, PLMN-C in this figure).

b) Indication that MOCN TMGI allocation is requested.
In step 5, the MB-SMF allocates a MOCN TMGI based on the information provided by the AF and local configuration related to MOCN network sharing. In this figure, the local configuration related to MOCN network sharing is that PLMN-A, PLMN-B and PLMN-C share NG-RANs.
In step 5, the following information is provided by the MB-SMF when returning the TMGI

i) Indication that MOCN TMGI is allocated.

2. The AF may perform a Service Announcement towards UE-A, UE-B and UE-C.

3. The AF performs TMGI allocation with PLMN-D to obtain a TMGI to identify new MBS session as specified in steps 1 to 6 in clause 7.1.1.2 or clause 7.1.1.3 of TS 23.247 [4].

The MBS session identified by the MOCN TMGI allocated in step 1 and the MBS session identified by the TMGI allocated in this step are for the same broadcast service.

4. The AF may perform a Service Announcement towards UE-D.

5. The AF performs MBS session creation with PLMN-A by providing description for the MBS session for a previously allocated MOCN TMGI in step 1, as specified in step 8 in clause 7.1.1.2 or clause 7.1.1.3 of TS 23.247 [4].

6-7. The MBS session is established in PLMN-A as specified in steps 9 to 20 in clause 7.1.1.2 or steps 9 to 33 in clause 7.1.1.3 of TS 23.247 [4].

The AF may also perform a Service Announcement towards UE-A, UE-B and UE-C at this stage.

8. The AF performs MBS session creation with PLMN-D by providing description for the MBS session for a previously allocated TMGI in step 3, as specified in step 8 in clause 7.1.1.2 or clause 7.1.1.3 of TS 23.247 [4].

9-10. The MBS session is established in PLMN-D as specified in steps 9 to 20 in clause 7.1.1.2 or steps 9 to 33 in clause 7.1.1.3 of TS 23.247 [4].

The AF may also perform a Service Announcement towards UE-D at this stage.

11. The AF starts transmitting the DL media stream to PLMN-A as specified in step 13 in clause 7.3.1 of TS 23.247 [4].

12. The MB-UPF of PLMN-A transmits the media stream to NG-RAN via N3mb multicast transport or point-to-point transport.

13. NG-RAN #1 shared by PLMN-A, PLMN-B and PLMN-C transmits the received DL media stream using DL PTM resources.

UE-A, UE-B and UE-C can receive the media stream.

14. The AF starts transmitting the DL media stream to PLMN-D as specified in step 13 in clause 7.3.1 of TS 23.247 [4]. The DL media stream is same to that in step 11 which means the AF transmits the same DL media stream to PLMN-A and PLMN-D.

Step 11 and step 14 can be performed in parallel.

15. The MB-UPF of PLMN-D transmits the media stream to NG-RAN via N3mb multicast transport or point-to-point transport.

16. NG-RAN #2 of PLMN-D transmits the received DL media stream using DL PTM resources.

UE-D can receive the media stream.

### Impacts on Services, Entities and Interfaces

### AF:

supports MOCN TMGI allocation request.

### MB-SMF:

supports MOCN TMGI allocation.

### NEF:

Nnef_MBSTMGI_Allocate service operation supports additional parameters related to MOCN TMGI allocation.

### UE:

supports MOCN TMGI.

### NG-RAN:

supports MOCN TMGI

The following italics content is a copy of clause 6.9 of 3GPP TR 23.700-47 V0.2.0.

### Solution #9: Broadcast Services Considering MOCN RAN

This solution addresses Key Issue #2 of 3GPP TR 23.700-47 V0.2.0.

It is assumed to reuse the current architecture in Rel-17 MBS specification (see TS 23.247 [4]).

A TMGI is assigned and used for a broadcast service in an operator's network. However, if an NG-RAN is shared among operators, a primary TMGI may be selected and used instead of the TMGI in the shared NG-RAN if MOCN operators share a same broadcast service.

When a broadcast service is shared among operator's networks, the contents provider may recognize the using TMGI for each operator. So that if the operators share some NG-RAN(s) (call MOCN NG-RAN), AF/contents provider may provide the TMGI list for the broadcast service to 5GS.

Then, the MOCN NG-RAN decides to use a primary TMGI out of the TMGI list, and the primary TMGI and its usage area (i.e. NG-RAN location or Cell IDs) is notified to AF so that such information can be announced to the UEs.

Security (i.e. en/decryption of content) is assumed to be not supported in 5GS, but possible by application layer.

FIG. 1K shows a flowchart of Procedure for Broadcast Session start for MOCN NG-RAN, which is same as FIG. 6.9.3.2-1 of 3GPP TR 23.700-47 V0.2.0.

The following additions apply compared to clause 7.3.1 of TS 23.247 [4]:

0-3. AF performs TMGI allocation and MBS session creation as specified in clause 7.1.1.2 or clause 7.1.1.3 of TS 23.247 [4]. The AF provides additionally the TMGI list for the broadcast service which each operator uses in MBS session creation request.

5-6. MB-SMF invokes Namf_MBSBroadcast_ContextCreate Request including AF may provide the TMGI list for the broadcast service which each operator uses in the N2 SM container.

7. NG-RAN node creates a Broadcast MBS Session Context. If the NG-RAN is MOCN NG-RAN, it selects a primary TMGI out of the TMGI list.

NOTE: How to select a primary TMGI follows local policy or NG-RAN implementation.

8-12. NG-RAN responds the primary TMGI and its location (e.g. Cell ID(s)) if the NG-RAN is MOCN NG-RAN, where such information is delivered to AF.

13. MOCN NG-RAN advertises the primary TMGI for the broadcast service instead of using the TMGI for operator's network.

14. Service announcement to UEs includes the primary TMGI and its usage area (i.e. NG-RAN location or Cell IDs) as well as the TMGI for operator's network.

15. Broadcast service media stream is delivered to MOCN NG-RAN.

16. MOCN NG-RAN uses the primary TMGI only instead of TMGI for the same broadcast service.

17. UE receives the broadcast service via the primary TMGI when it is in the MOCN NG-RAN.

Functional entities defined in clause 5.3.2 of TS 23.247 [4] is reused exception for the following additions:

### AF, NEF:

Support to provide the TMGI list for the broadcast service which each operator uses in MBS session creation request only when there exists a MOCN NG-RAN among operators.
obtain a primary TMGI which will be used in the MOCN NG-RAN and announce to UEs the primary TMGI and its usage area.

### MB-SMF:

send TMGI list of other networks for a same broadcast service to NG-RAN node.

### NG-RAN:

In case of MOCN NG-RAN, decide the primary TMGI for a same broadcast service, which will be used for the broadcast service in the MOCN NG-RAN.

### UE:

receive the broadcast service via the primary TMGI in the MOCN NG-RAN.

As described above, there are some problems in the exiting solutions for the same broadcast content to be provided to MOCN network sharing scenarios (i.e., multiple CNs are connected to the same RAN). To overcome or mitigate at least one of above mentioned problems or other problems, the embodiments of the present disclosure propose an improved solution for the same broadcast content to be provided to MOCN network sharing scenarios.

In an embodiment, for multiple MBS sessions which are associated by associated session identifier in shared RAN scenario, the RAN (such as NG-RAN) may establish a predefined number (such as one) of user planes towards the predefined number (such as one) CNs, for the rest CNs, no user planes will be established.

In an embodiment, the RAN (such as NG-RAN) may allocate radio resource over the air, and include all the IDs (TMGIs) of the multicast MBS sessions in SIB (System Information Block)/MCCH (Multicast Control Channel) to link to the radio resource. The packets received from the user plane are delivered utilizing the radio resource.

In an embodiment, when there is a failure in the CN with the user plane, the RAN (such as NG-RAN) actively establishes the user plane with another CN, and continue to utilize the radio resource to deliver the packets received from the newly established user plane.

In an embodiment, it is proposed to utilize the associated session identifier (e.g. source-specific multicast (SSM) Internet protocol (IP) address which is used by the AF) to associate the broadcast MBS sessions from different CNs which deliver the same content from AF

In an embodiment, AF may include the associated session identifier towards a session manage node (such as MB-SMF) (optional via a network exposure node such as NEF). A session manage node (such as MB-SMF) passes the associated session identifier to the RAN (such as NG-RAN) via an access and mobility node such as AMF.

In an embodiment, the RAN (such as NG-RAN) receives multiple MBS sessions which are associated by the associated session identifier in shared RAN scenario. If there are no user planes been established (RAN detects by the associated session identifier), the RAN establishes the user plane as in normal scenario. If there is a user plane established, the NG-RAN sends BROADCAST SESSION SETUP RESPONSE, without establishing the user plane regardless of multicast transport of N3mb or unicast transport of N3mb is preferred. And in this way, no “MBS Session Information Response Transfer” will be included in BROADCAST SESSION SETUP RESPONSE. If there are no radio resources allocated (RAN detects by the associated session identifier), RAN allocate the radio resources for the broadcast MBS session and include the MBS session ID (such as TMGI) in SIB/MCCH to link to the radio resources. If the radio resources are allocated, the RAN includes the MBS session ID (such as TMGI) in SIB/MCCH to link to the radio resources.

In an embodiment, when there is a failure in the CN from which the content is received (or the broadcast MBS session is released in that CN), the RAN selects another CN to establish the user plane to receive MBS content.

In an embodiment, for multicast transport of N3mb, the RAN joins the SSM address provided by a user plane node such as MB-UPF

In an embodiment, for unicast transport of N3mb, the RAN allocates a new N3mb DL (downlink) Tunnel Information for the N3mb (it is possible to reuse the old N3mb DL Tunnel Info of the failed N3mb) sends BROADCAST SESSION TRANSPORT REQUEST with the N3mb DL Tunnel Information towards the session management node such as MB-SMF in the selected CN via the access and mobility node such as AMF. The session management node such as MB-SMF forwards the N3mb DL Tunnel Information to the user plane node such as MB-UPF, so that the DL tunnel between the user plane node such as MB-UPF and the RAN can be established.

In an embodiment, after the user plane has been established, the RAN uses the radio resources allocated before to deliver the packets over the air, which were received over user plane from the user plane node such as MB-UPF in the selected CN.

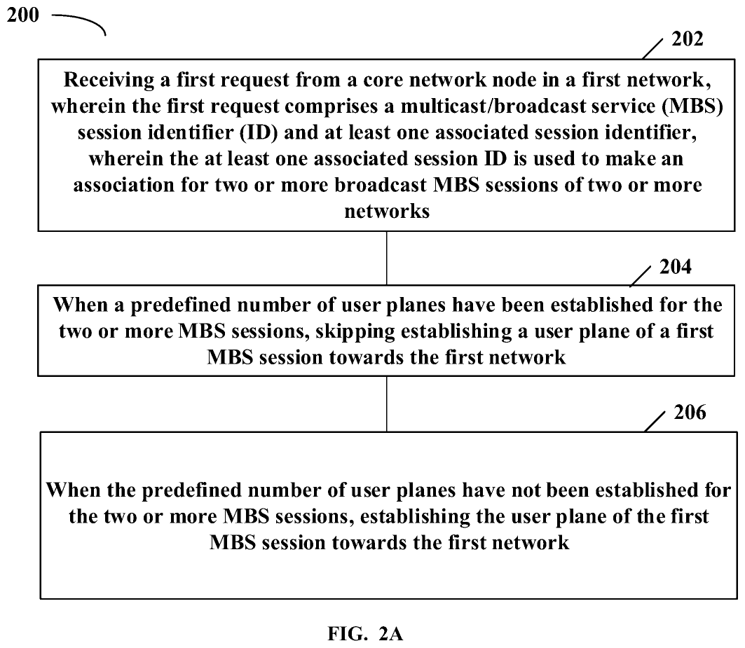

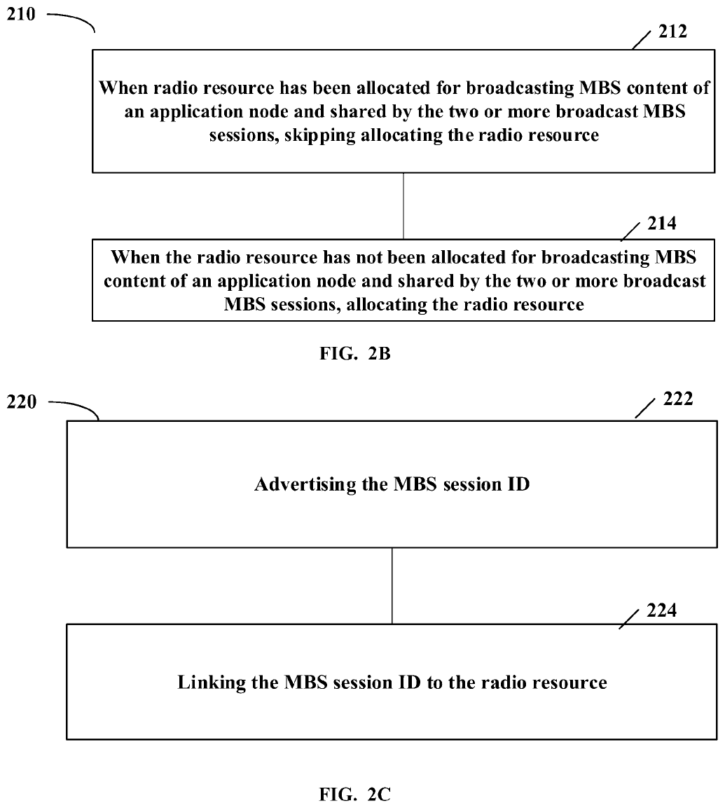

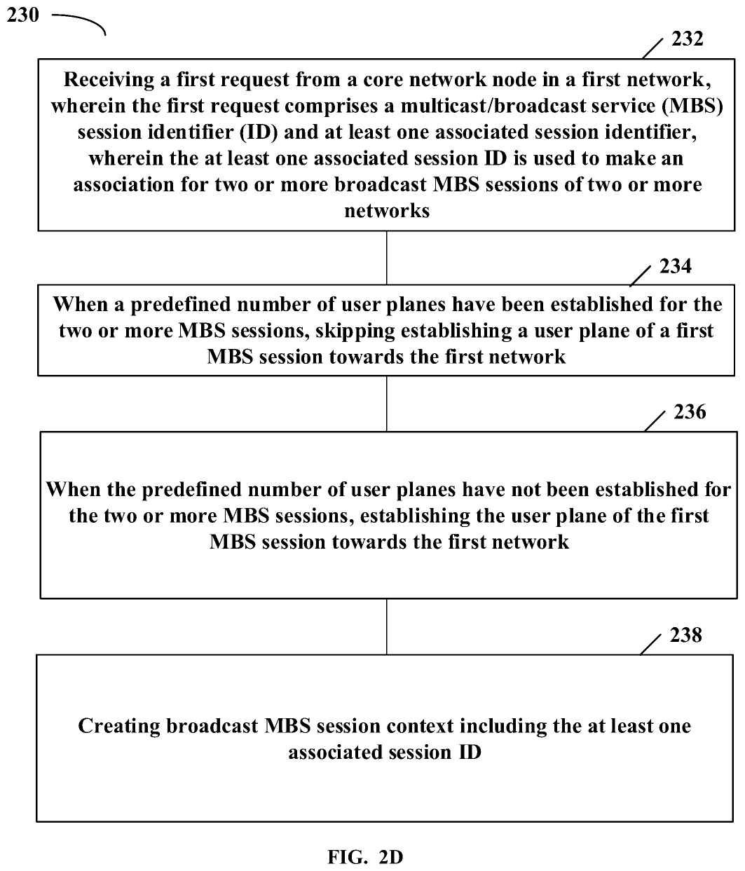

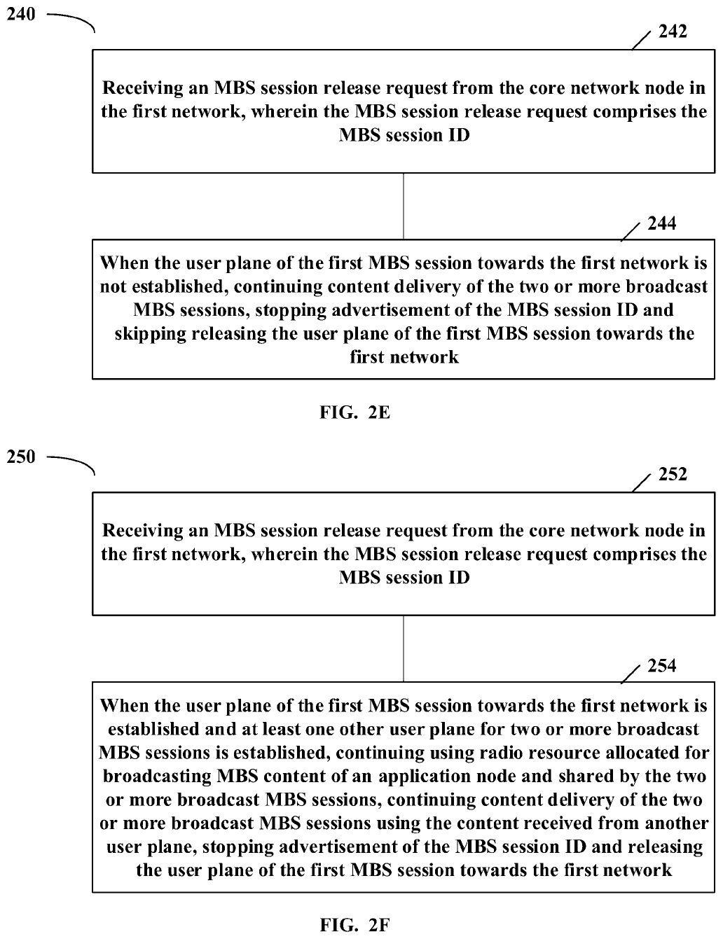

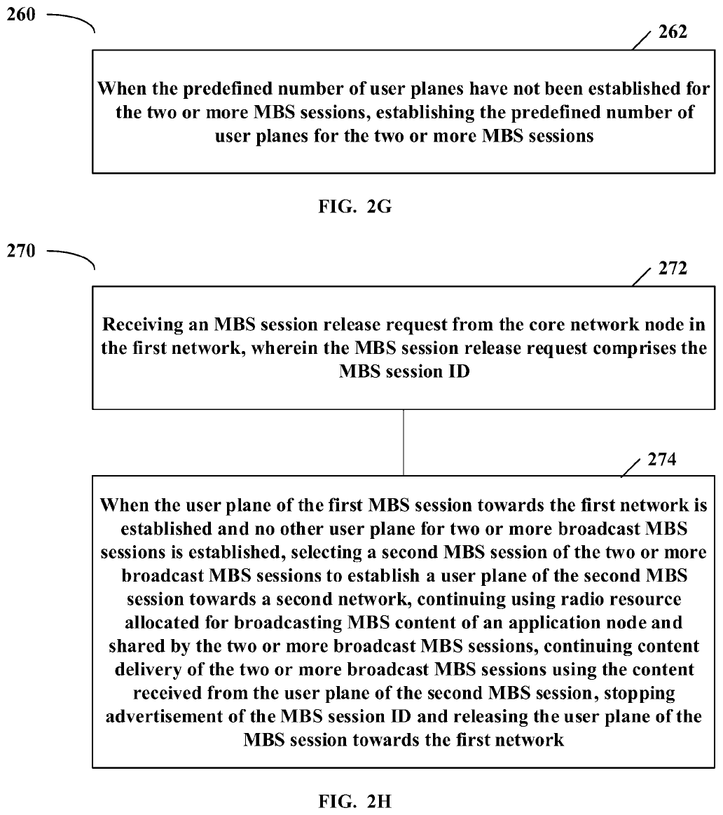

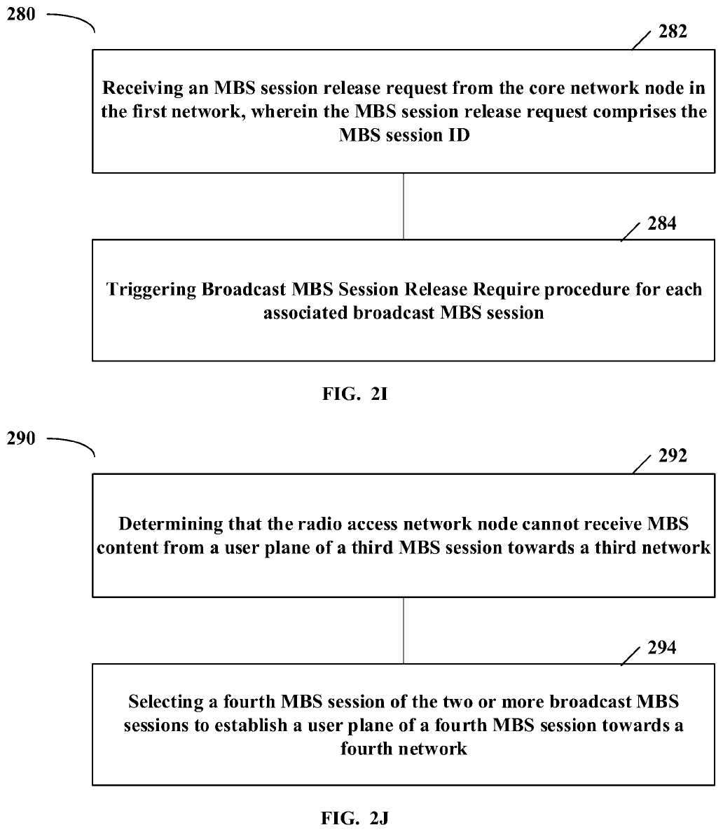

FIG. 2A shows a flowchart of a method according to an embodiment of the present disclosure, which may be performed by an apparatus implemented in/as or communicatively coupled to a radio access network node. As such, the apparatus may provide means for accomplishing various parts of the method 200 as well as means for accomplishing other processes in conjunction with other components.

At block 202, the radio access network node may receive a first request from a core network node in a first network. The first request may comprise a multicast/broadcast service (MBS) session identifier (ID) and at least one associated session identifier. The at least one associated session ID is used to make an association for two or more broadcast MBS sessions of two or more networks.

The radio access network node may be any suitable node which can implement access function. In an embodiment, the radio access network node may be NG-RAN in 5GS. In other embodiment, the radio access network node may be any other suitable RAN in other communication system.

The core network node may be any suitable node which can implement access and mobility management function. In an embodiment, the core network node may comprise an access and mobility management function (AMF).

In an embodiment, multiple core networks are connected to the radio access network node. The multiple core networks may belong to the same type core network or different core networks. For example, the multiple core networks may be 5GC or EPC (Evolved Packet Core).

The first request may be any suitable request comprising the multicast/broadcast service (MBS) session identifier (ID) and at least one associated session identifier. The first request may be an existing message or a new message. In an embodiment, the first request is an N2 message request for example as described in 3GPP TR 23.700-47 V0.2.0.

In an embodiment, the N2 message request is a broadcast session setup request.

The two or more networks may be any suitable network. In an embodiment, the two or more networks comprise a 3rd Generation Partnership Project (3GPP) network. For example, the two or more networks may be 5GS or EPS (Evolved Packet System).

The MBS session ID may be allocated by a network function (such as MB-SMF or BM-SC) in a network. For example, in 5G MOCN network sharing scenarios, the MBS session ID may be allocated by a MB-SMF.

In an embodiment, the MBS session ID may comprise a temporary mobile group identity (TMGI).

Clause 7.1.1.2 of 3GPP TS 23.247 V17.2.0 describes TMGI Allocation Procedure. For example, AF may send Nnef_TMGI_Allocate Request (TMGI number) message to NEF/MBSF to request allocation of a TMGI(s) to identify new MBS session(s). AF may send an Nmbsmf_TMGI_Allocate Request (TMGI number) message to the MB-SMF when the AF is in the trusted domain where NEF is not mandated. Alternatively, AF may request that the network allocates an identifier for the MBS session (i.e., TMGI) via a Nnef_MBSSession_Create request or Nmbsmf_MBSSession_Create Request. 3GPP TS 23.468 V16.0.0, the disclosure of which is incorporated by reference herein in its entirety, also describes TMGI Allocation Procedure and Activate MBMS Bearer Procedure.

In an embodiment, the at least one associated session ID is used to make an association for two or more broadcast MBS sessions with same multicast/broadcast content across two or more networks. For example, when a RAN node receives the same multicast/broadcast content from multiple MBS sessions which are associated in shared RAN scenario, the RAN node may broadcast a single copy of the same multicast/broadcast content over the air. And it may drop the multicast/broadcast content of other MBS sessions. Alternatively RAN node may establish the user plane of one MBS session and inform MB-SMFs of not establishing the others. And RAN node will deliver the packets of this MBS session over the air.

In an embodiment, when the radio access network node receives same multicast or broadcast data originating from an application node from two or more networks, only a single copy of the same multicast or broadcast data is broadcasted and other copies of the same multicast or broadcast data are dropped.

In an embodiment, when RAN node receives multiple MBS sessions which are associated in shared RAN scenario, it may establish the user planes of those MBS sessions. NG-RAN may determine and select one MBS session to be broadcasted over the air. And it may drop the packets of other MBS sessions.

In an embodiment, the at least one associated session ID may comprise a source-specific multicast (SSM) internet protocol address used by an application node for example as described in 3GPP TS 23.247 V17.2.0.

In an embodiment, the MBS session ID may be a first MBS session ID and the at least one associated session identifier may be at least one second MBS session ID.

The MBS session ID may be allocated by a network function (such as MB-SMF or BM-SC) in a network. For example, in 5G MOCN network sharing scenarios, the first MBS session ID may be allocated by a MB-SMF of a first network. The second MBS session ID may be allocated by a MB-SMF of a second network.

In an embodiment, the first request may not comprise all second MBS session IDs associated to the first MBS session ID. For example, the first request may comprise only one second MBS session ID associated to the first MBS session ID. When the RAN node receives a third MBS session ID associated to the first or second MBS session ID from another core network, the RAN node can determine that the first, second and third MBS session ID are associated with each other.

In an embodiment, the first request may further comprise a preferred MBS session ID.

In an embodiment, a preferred MBS session ID may be used or considered by a radio access network node to broadcast multicast or broadcast data toward a network indicated in the preferred MBS session ID and/or used or considered by a user equipment to prioritize the network indicated in the preferred MBS session ID to receive data broadcasted by the radio access network node.

At block 204, when a predefined number of user planes have been established for the two or more MBS sessions, the radio access network node may skip establishing a user plane of a first MBS session towards the first network.

The predefined number of user planes may be any suitable number. In an embodiment, the predefined number of user planes may be smaller than the total number of the two or more networks. In other words, the user plane(s) may be established for only a part of the two or more broadcast MBS sessions.

The predefined number of user planes may be determined in various ways. For example, the predefined number of user planes may be determined by an operator or a user or an application node or a specific MBS service.

In an embodiment, the predefined number of user planes may comprise one user plane.

In an embodiment, the predefined number of user planes may comprise two user planes.

If the radio access network node skips establishing a user plane of a first MBS session towards the first network, it means that the user plane of the first MBS session towards the first network is not established.

In an embodiment, if the radio access network node skips establishing a user plane of a first MBS session towards the first network, it may perform the following operation.

For multicast transport, the radio access network node may skip join a multicast group for receiving MBS content from a Multicast/Broadcast User Plane Function (MB-UPF) in the first network. The MBS content is originated from an application node.

For unicast transport, the radio access network node may skip downlink tunnel allocation and send a first response without downlink tunnel information to the core network node in the first network. The first response may be an N2 message response as described in 3GPP TS 23.247 V17.2.0.

In an embodiment, the N2 message response is a broadcast session setup response.

For example, if NG-RAN prefers to use N3mb multicast transport (and if LL (Lower Layer) SSM is available in NG-RAN), the NG-RAN will not joins the multicast group (i.e. LL SSM).

If NG-RAN prefers to use N3mb point-to-point transport (or if the LL SSM is not available in NG-RAN) between the NG-RAN and MB-UPF, NG-RAN will skip N3mb DL Tunnel allocation and will not provide its N3mb DL Tunnel Information to AMF.

The NG-RAN reports successful establishment of the MBS Session resources (which may include multiple MBS QoS Flows) by sending MBS Session Resource Setup Response (TMGI, N2 SM information (without N3mb DL Tunnel Info)) message(s) to the AMF.

At block 206, when the predefined number of user planes have not been established for the two or more MBS sessions, the radio access network node may establish the user plane of the first MBS session towards the first network.

For example, the radio access network node may establish the user plane of the first MBS session towards the first network according to clause 7.3.1 of 3GPP TS 23.247 V17.2.0.

FIG. 2B shows a flowchart of a method according to another embodiment of the present disclosure, which may be performed by an apparatus implemented in/as or communicatively coupled to a radio access network node. As such, the apparatus may provide means for accomplishing various parts of the method 210 as well as means for accomplishing other processes in conjunction with other components. For some parts which have been described in the above embodiments, the description thereof is omitted here for brevity.

At block 212, when radio resource has been allocated for broadcasting MBS content of an application node and shared by the two or more broadcast MBS sessions, the radio access network node may skip allocating the radio resource.

At block 214, when the radio resource has not been allocated for broadcasting MBS content of an application node and shared by the two or more broadcast MBS sessions, the radio access network node may allocate the radio resource.

The application node may be any suitable node which can provide similar or same function as the AF as described in 3GPP TS 23.501 V17.1.1 or the Application Server (AS) or Services Capability Server (SCS) as described in 3GPP TS 23.682 V17.2.0. For example, the application node may be a content provider or a multicast source or a broadcast source.

In an embodiment, the application node may comprise AF as described in 3GPP TS 23.501 V17.1.1.

In an embodiment, the application node may comprise AS/SCS as described in 3GPP TS 23.682 V17.2.0.

In an embodiment, the application node may determine to broadcast the same content towards different PLMNs (e.g., via different MB-SMFs). The application node may know that multiple CNs of different PLMNs are connected to the same RAN.

FIG. 2C shows a flowchart of a method according to another embodiment of the present disclosure, which may be performed by an apparatus implemented in/as or communicatively coupled to a radio access network node. As such, the apparatus may provide means for accomplishing various parts of the method 220 as well as means for accomplishing other processes in conjunction with other components. For some parts which have been described in the above embodiments, the description thereof is omitted here for brevity.

At block 222, the radio access network node may advertise the MBS session ID.

At block 224, the radio access network node may link the MBS session ID to the radio resource.

For example, if the NG-RAN understands the broadcast MBS Session is associated with another Broadcast MBS Session by the associated session ID whose content has been delivered over the air, the NG-RAN advertises the TMGI of the broadcast MBS session and link the TMGI to existing radio resources.

FIG. 2D shows a flowchart of a method according to another embodiment of the present disclosure, which may be performed by an apparatus implemented in/as or communicatively coupled to a radio access network node. As such, the apparatus may provide means for accomplishing various parts of the method 230 as well as means for accomplishing other processes in conjunction with other components. For some parts which have been described in the above embodiments, the description thereof is omitted here for brevity.

At block 232, the radio access network node may receive a first request from a core network node in a first network. The first request may comprise a multicast/broadcast service (MBS) session identifier (ID) and at least one associated session identifier. The at least one associated session ID is used to make an association for two or more broadcast MBS sessions of two or more networks. Block 232 is same as block 202 of FIG. 2A.

At block 234, when a predefined number of user planes have been established for the two or more MBS sessions, he radio access network node may skip establishing a user plane of a first MBS session towards the first network. Block 234 is same as block 204 of FIG. 2A.

At block 236, when the predefined number of user planes have not been established for the two or more MBS sessions, the radio access network node may establish the user plane of the first MBS session towards the first network. Block 236 is same as block 206 of FIG. 2A.

At block 238, the radio access network node may create broadcast MBS session context including the at least one associated session ID.

For example, the radio access network node such as NG-RAN creates a Broadcast MBS Session Context, stores MBS session ID and at least one associated session identifier, the QoS Profile in the MBS Session Context.

FIG. 2E shows a flowchart of a method according to another embodiment of the present disclosure, which may be performed by an apparatus implemented in/as or communicatively coupled to a radio access network node. As such, the apparatus may provide means for accomplishing various parts of the method 240 as well as means for accomplishing other processes in conjunction with other components. For some parts which have been described in the above embodiments, the description thereof is omitted here for brevity.

At block 242, the radio access network node may receive an MBS session release request from the core network node in the first network. The MBS session release request may comprise the MBS session ID.

For example, the radio access network node such as AMF may send an N2 message to all RAN nodes that have been involved to release MBS session. And then the radio access network node may receive the N2 message to release the MBS Session.

At block 244, when the user plane of the first MBS session towards the first network is not established, the radio access network node may continue content delivery of the two or more broadcast MBS sessions, stop advertisement of the MBS session ID and skip releasing the user plane of the first MBS session towards the first network.

When the radio access network node skips releasing the user plane of the first MBS session towards the first network, the radio access network node may perform the following operations.

For multicast transport, the radio access network node skips sending a leaving message to a Multicast/Broadcast User Plane Function (MB-UPF) in the first network.

For unicast transport, the radio access network node sends an MBS session release response without downlink tunnel information to the core network node in the first network.

FIG. 2F shows a flowchart of a method according to another embodiment of the present disclosure, which may be performed by an apparatus implemented in/as or communicatively coupled to a radio access network node. As such, the apparatus may provide means for accomplishing various parts of the method 250 as well as means for accomplishing other processes in conjunction with other components. For some parts which have been described in the above embodiments, the description thereof is omitted here for brevity.

At block 252, the radio access network node may receive an MBS session release request from the core network node in the first network. The MBS session release request may comprise the MBS session ID.

At block 254, when the user plane of the first MBS session towards the first network is established and at least one other user plane for two or more broadcast MBS sessions is established, the radio access network node may continue using radio resource allocated for broadcasting MBS content of an application node and shared by the two or more broadcast MBS sessions, continue content delivery of the two or more broadcast MBS sessions using the content received from another user plane, stop advertisement of the MBS session ID and release the user plane of the first MBS session towards the first network.

For example, the radio access network node may release the user plane of the first MBS session towards the first network according to clause 7.3.2 of 3GPP TS 23.247 V17.2.0.

FIG. 2G shows a flowchart of a method according to another embodiment of the present disclosure, which may be performed by an apparatus implemented in/as or communicatively coupled to a radio access network node. As such, the apparatus may provide means for accomplishing various parts of the method 260 as well as means for accomplishing other processes in conjunction with other components. For some parts which have been described in the above embodiments, the description thereof is omitted here for brevity.

At block 262, when the predefined number of user planes have not been established for the two or more MBS sessions, the radio access network node may establish the predefined number of user planes for the two or more MBS sessions. For example, some established user plane(s) may be released due to various reasons or there is a failure in the CN which causes the corresponding user plane is failed. In this case, the predefined number of user planes have not been established for the two or more MBS sessions, and the radio access network node may establish the predefined number of user planes for the two or more MBS sessions. For example, the radio access network node may select a MBS session of the two or more broadcast MBS sessions to establish a user plane of the MBS session towards a network.

FIG. 2H shows a flowchart of a method according to another embodiment of the present disclosure, which may be performed by an apparatus implemented in/as or communicatively coupled to a radio access network node. As such, the apparatus may provide means for accomplishing various parts of the method 270 as well as means for accomplishing other processes in conjunction with other components. For some parts which have been described in the above embodiments, the description thereof is omitted here for brevity.

At block 272, the radio access network node may receive an MBS session release request from the core network node in the first network. The MBS session release request may comprise the MBS session ID.

At block 274, when the user plane of the first MBS session towards the first network is established and no other user plane for two or more broadcast MBS sessions is established, the radio access network node may select a second MBS session of the two or more broadcast MBS sessions to establish a user plane of the second MBS session towards a second network, continue using radio resource allocated for broadcasting MBS content of an application node and shared by the two or more broadcast MBS sessions, continue content delivery of the two or more broadcast MBS sessions using the content received from the user plane of the second MBS session, stop advertisement of the MBS session ID and release the user plane of the MBS session towards the first network.

In an embodiment, when establishing the user plane of the second MBS session towards the second network, the radio access network node may perform the following operation.

For multicast transport, the radio access network node may join a multicast group for receiving MBS content from a Multicast/Broadcast User Plane Function (MB-UPF) in the second network.

For unicast transport, the radio access network node may allocate downlink tunnel information, send a request comprising an ID of the second MBS session and the downlink tunnel information to a core network node in the second network.

For example, if multicast transport of N3mb applies, the NG-RAN performs join the multicast group towards the LL SSM provided by the CN. If unicast transport of N3mb applies, the NG-RAN allocates N3mb DL Tunnel Info, and sends N2 message (e.g. BROADCAST SESSION TRANSPORT REQUEST) to AMF, including the MBS Session ID and the N3mb DL Tunnel Info.

FIG. 2I shows a flowchart of a method according to another embodiment of the present disclosure, which may be performed by an apparatus implemented in/as or communicatively coupled to a radio access network node. As such, the apparatus may provide means for accomplishing various parts of the method 280 as well as means for accomplishing other processes in conjunction with other components. For some parts which have been described in the above embodiments, the description thereof is omitted here for brevity.

At block 282, the radio access network node may receive an MBS session release request from the core network node in the first network. The MBS session release request may comprise the MBS session ID.

At block 284, the radio access network node may trigger Broadcast MBS Session Release Require procedure for each associated broadcast MBS session.

In an embodiment, when triggering Broadcast MBS Session Release Require procedure for each associated broadcast MBS session, the radio access network node may perform the following operation.

When a user plane of an associated broadcast MBS session towards a corresponding network is not established, the radio access network node may skip releasing the user plane of the associated broadcast MBS session towards the corresponding network.

When the user plane of the associated broadcast MBS session towards the corresponding network is established, the radio access network node may release the user plane of the associated broadcast MBS session towards the corresponding network.

In an embodiment, when skipping releasing the user plane of the associated broadcast MBS session towards the corresponding network, the radio access network node may perform the following operation.

For multicast transport, the radio access network node may skip sending a leaving message to a Multicast/Broadcast User plane Function (MB-UPF) in the corresponding network.

For unicast transport, the radio access network node may send an MBS session release response without downlink tunnel information to the core network node in the corresponding network.

FIG. 2J shows a flowchart of a method according to another embodiment of the present disclosure, which may be performed by an apparatus implemented in/as or communicatively coupled to a radio access network node. As such, the apparatus may provide means for accomplishing various parts of the method 290 as well as means for accomplishing other processes in conjunction with other components. For some parts which have been described in the above embodiments, the description thereof is omitted here for brevity.

At block 292, the radio access network node may determine that the radio access network node cannot receive MBS content from a user plane of a third MBS session towards a third network. The radio access network node cannot receive MBS content from a user plane of a third MBS session towards a third network due to various reasons. For example, the third MBS session is released. There is a failure of the user plane of the third MBS session. There is a failure of user plane function of the third network.

In an embodiment, the radio access network node may perform the following operation to determine that the radio access network node cannot receive MBS content from a user plane of a third MBS session towards a third network.

For example, the radio access network node may receive an MBS session release request from a core network node in the third network. The radio access network node may release a user plane of the third MBS session towards the third network. Then the radio access network node may determine that the radio access network node cannot receive MBS content from the user plane of the third MBS session towards the third network.

In another embodiment, the radio access network node may perform the following operation to determine that the radio access network node cannot receive MBS content from a user plane of a third MBS session towards a third network.

For example, the radio access network node may detect there is a failure in the third network which causes the radio access network node cannot receive MBS content from the user plane of the third MBS session towards the third network. The failure may comprise user plane failure, the link failure, the user plane function failure, etc. Then the radio access network node may determine that the radio access network node cannot receive MBS content from the user plane of the third MBS session towards the third network.

At block 294, the radio access network node may select a fourth MBS session of the two or more broadcast MBS sessions to establish a user plane of a fourth MBS session towards a fourth network.

In an embodiment, the radio access network node may perform the following operation to establish the user plane of the fourth MBS session towards the fourth network.

For multicast transport, the radio access network node may join a multicast group for receiving MBS content from a Multicast/Broadcast User Plane Function (MB-UPF) in the fourth network.

For unicast transport, the radio access network node may allocate downlink tunnel information, sending an N2 request comprising an ID of the fourth MBS session and the downlink tunnel information to a core network node in the fourth network, and receive an N2 response comprising the ID of the fourth MBS session from the core network node in the fourth network.

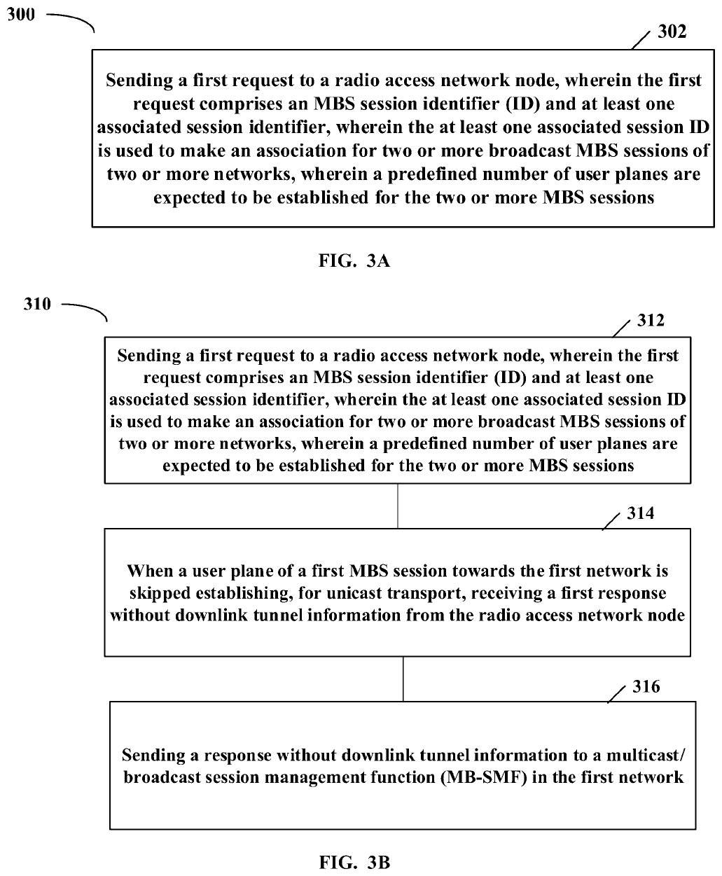

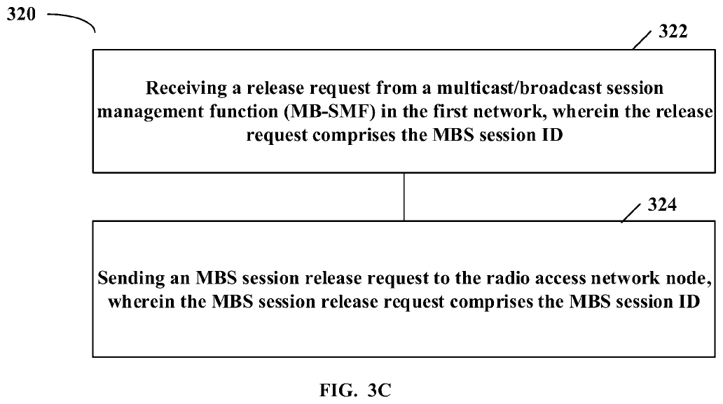

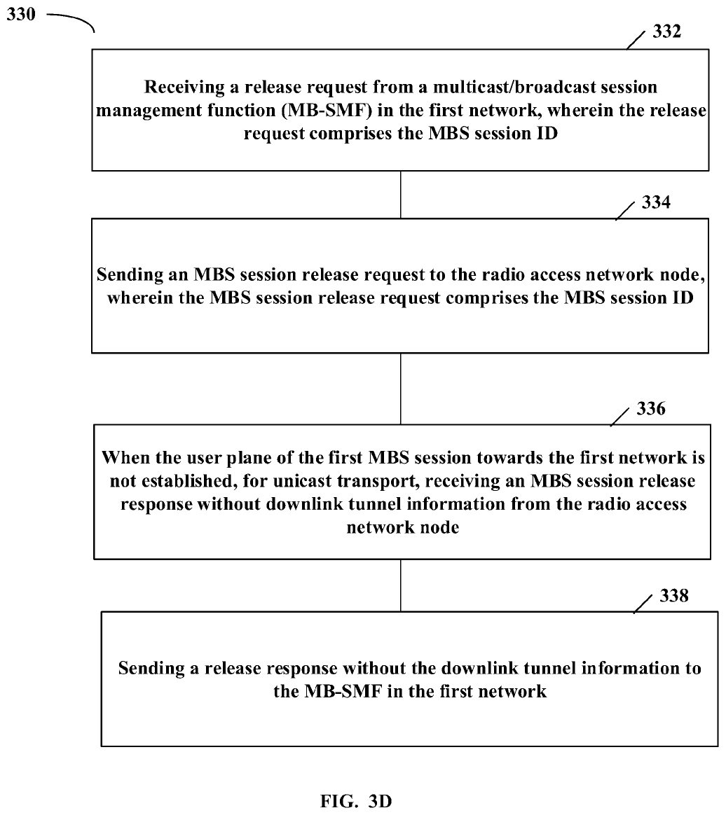

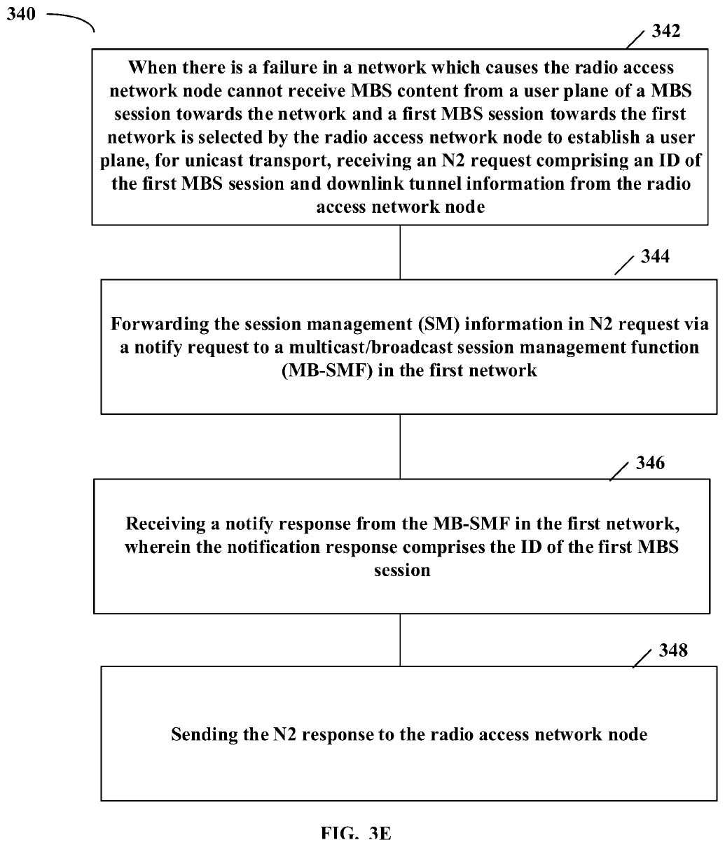

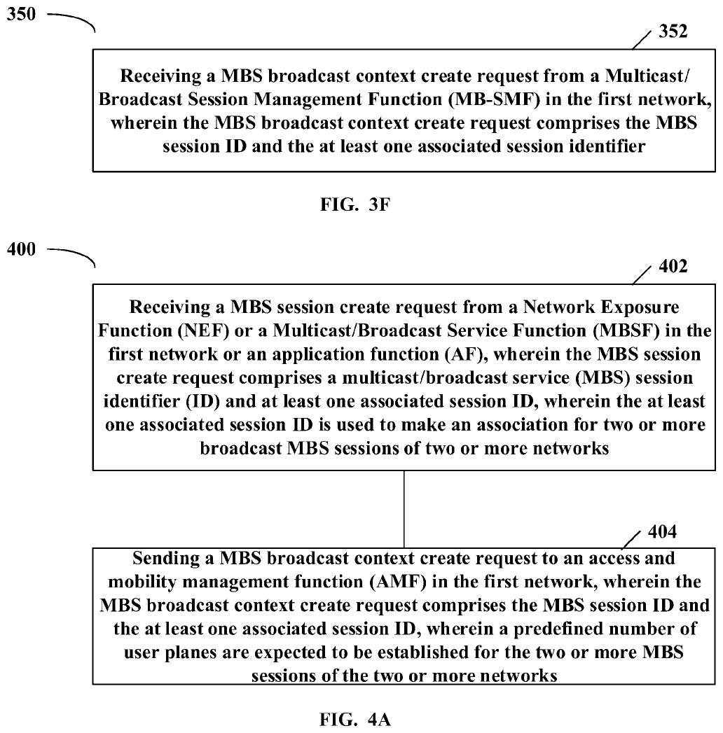

FIG. 3A shows a flowchart of a method according to another embodiment of the present disclosure, which may be performed by an apparatus implemented in/as or communicatively coupled to a core network node in a first network. As such, the apparatus may provide means for accomplishing various parts of the method 300 as well as means for accomplishing other processes in conjunction with other components. For some parts which have been described in the above embodiments, the description thereof is omitted here for brevity.

At block 302, the core network node may send a first request to a radio access network node. The first request may comprise an MBS session identifier (ID) and at least one associated session identifier. The at least one associated session ID is used to make an association for two or more broadcast MBS sessions of two or more networks.

In an embodiment, a predefined number of user planes are expected to be established for the two or more MBS sessions.

In an embodiment, the two or more networks comprise a 3rd Generation Partnership Project (3GPP) network.

In an embodiment, the MBS session ID may comprise a temporary mobile group identity (TMGI).

In an embodiment, the at least one associated session ID may comprise a source-specific multicast internet protocol address used by an application node.

In an embodiment, the MBS session ID may be a first MBS session ID and the at least one associated session identifier may be at least one second MBS session ID.

In an embodiment, the first request may not comprise all second MBS session IDs associated to the first MBS session ID. For example, the first request may comprise only one second MBS session ID associated to the first MBS session ID. When the RAN node receives a third MBS session ID associated to the first or second MBS session ID from another core network, the RAN node can determine that the first, second and third MBS session ID are associated with each other.

In an embodiment, the first request may further comprise a preferred MBS session ID.

In an embodiment, a preferred MBS session ID may be used or considered by a radio access network node to broadcast multicast or broadcast data toward a network indicated in the preferred MBS session ID and/or used or considered by a user equipment to prioritize the network indicated in the preferred MBS session ID to receive data broadcasted by the radio access network node.

In an embodiment, the first request is an N2 message request.

In an embodiment, the N2 message request is a broadcast session setup request.

In an embodiment, the core network node may comprise an access and mobility management function (AMF).

In an embodiment, multiple core networks are connected to the radio access network node.

In an embodiment, the predefined number of user planes may comprise one user plane.

In an embodiment, the core network node may receive a first response from the radio access network node.

In an embodiment, when a user plane of a first MBS session towards the first network is to establish, for unicast transport, the core network node may receive a first response with downlink tunnel information from the radio access network node.

In an embodiment, when a user plane of a first MBS session towards the first network is skipped establishing, for unicast transport, the core network node may receive a first response without downlink tunnel information from the radio access network node.

FIG. 3B shows a flowchart of a method according to another embodiment of the present disclosure, which may be performed by an apparatus implemented in/as or communicatively coupled to a core network node in a first network. As such, the apparatus may provide means for accomplishing various parts of the method 310 as well as means for accomplishing other processes in conjunction with other components. For some parts which have been described in the above embodiments, the description thereof is omitted here for brevity.

At block 312, the core network node may send a first request to a radio access network node. The first request may comprise an MBS session identifier (ID) and at least one associated session identifier. The at least one associated session ID is used to make an association for two or more broadcast MBS sessions of two or more networks.

At block 314, when a user plane of a first MBS session towards the first network is skipped establishing, for unicast transport, the core network node may receive a first response without downlink tunnel information from the radio access network node.

At block 316, the core network node may send a response without downlink tunnel information to a multicast/broadcast session management function (MB-SMF) in the first network.

For example, the MB-SMF provides the associated session ID in the N2 SM container to the NG-RAN via AMF. The AMF may transfer the N2 message in the received Namf_MBSBroadcast_ContextCreate Request (TMGI, LL SSM, N2 SM information (5G QoS Profile, the associated session ID)) message to all NG-RANs which support MBS in the MBS service area. If NG-RAN prefers to use N3mb point-to-point transport (or if the LL SSM is not available in NG-RAN) between the NG-RAN and MB-UPF and when a user plane of the MBS session is skipped establishing, NG-RAN will not provide its N3mb DL Tunnel Info to AMF. The NG-RAN reports successful establishment of the MBS Session resources (which may include multiple MBS QoS Flows) by sending MBS Session Resource Setup Response (TMGI, N2 SM information (without N3mb DL Tunnel Info)) message(s) to the AMF. The AMF transfers the Namf_MBSBroadcast_ContextCreate Response ( ) to the MB-SMF.

FIG. 3C shows a flowchart of a method according to another embodiment of the present disclosure, which may be performed by an apparatus implemented in/as or communicatively coupled to a core network node in a first network. As such, the apparatus may provide means for accomplishing various parts of the method 320 as well as means for accomplishing other processes in conjunction with other components. For some parts which have been described in the above embodiments, the description thereof is omitted here for brevity.

At block 322, the core network node may receive a release request from a multicast/broadcast session management function (MB-SMF) in the first network. The release request may comprise the MBS session ID.

At block 324, the core network node may send an MBS session release request to the radio access network node. The MBS session release request may comprise the MBS session ID.

In an embodiment, when the user plane of the first MBS session towards the first network is established, for unicast transport, the core network node may receive an MBS session release response with downlink tunnel information from the radio access network node and send a release response with the downlink tunnel information to the MB-SMF in the first network.

In an embodiment, when the user plane of the first MBS session towards the first network is not established, for unicast transport, the core network node may receive an MBS session release response without downlink tunnel information from the radio access network node and send a release response without the downlink tunnel information to the MB-SMF in the first network.

FIG. 3D shows a flowchart of a method according to another embodiment of the present disclosure, which may be performed by an apparatus implemented in/as or communicatively coupled to a core network node in a first network. As such, the apparatus may provide means for accomplishing various parts of the method 330 as well as means for accomplishing other processes in conjunction with other components. For some parts which have been described in the above embodiments, the description thereof is omitted here for brevity.

At block 332, the core network node may receive a release request from a multicast/broadcast session management function (MB-SMF) in the first network. The release request may comprise the MBS session ID.

At block 334, the core network node may send an MBS session release request to the radio access network node. The MBS session release request may comprise the MBS session ID.

At block 336, when the user plane of the first MBS session towards the first network is not established, for unicast transport, the core network node may receive an MBS session release response without downlink tunnel information from the radio access network node.

At block 338, the core network node may send a release response without the downlink tunnel information to the MB-SMF in the first network.

FIG. 3E shows a flowchart of a method according to another embodiment of the present disclosure, which may be performed by an apparatus implemented in/as or communicatively coupled to a core network node in a first network. As such, the apparatus may provide means for accomplishing various parts of the method 340 as well as means for accomplishing other processes in conjunction with other components. For some parts which have been described in the above embodiments, the description thereof is omitted here for brevity.

In this embodiment, when there is a failure in a network which causes the radio access network node cannot receive MBS content from a user plane of an MBS session towards the network and a first MBS session towards the first network is selected by the radio access network node to establish a user plane.

At block 342, for unicast transport, the core network node may receive an N2 request comprising an ID of the first MBS session and downlink tunnel information from the radio access network node.

At block 344, the core network node may forward the session management (SM) information in N2 request via a notify request to a multicast/broadcast session management function (MB-SMF) in the first network. For example, the core network node may forward the N2 request via a notify request to a multicast/broadcast session management function (MB-SMF) in the first network.

At block 346, the core network node may receive a notify response from the MB-SMF in the first network. The notification response may comprise the ID of the first MBS session for example, the notify response may comprise an N2 response comprising the ID of the first MBS session.

At block 348, the core network node may send the N2 response to the radio access network node.

In an embodiment, the N2 request is a broadcast session transport request and the N2 response is a broadcast session transport response.

In an embodiment, the notify request is an MBS broadcast context status notify request and the notify response is an MBS broadcast context status notify response.

FIG. 3F shows a flowchart of a method according to another embodiment of the present disclosure, which may be performed by an apparatus implemented in/as or communicatively coupled to a core network node in a first network. As such, the apparatus may provide means for accomplishing various parts of the method 350 as well as means for accomplishing other processes in conjunction with other components. For some parts which have been described in the above embodiments, the description thereof is omitted here for brevity.

At block 352, the core network node may receive a MBS broadcast context create request from a Multicast/Broadcast Session Management Function (MB-SMF) in the first network. The MBS broadcast context create request may comprise the MBS session ID and the at least one associated session identifier.

In an embodiment, the MBS session ID may be a first MBS session ID and the at least one associated session identifier may be at least one second MBS session ID.

In an embodiment, the MBS broadcast context create request may not comprise all second MBS session IDs associated to the first MBS session ID. For example, the MBS broadcast context create request may comprise only one second MBS session ID associated to the first MBS session ID. When the RAN node receives a third MBS session ID associated to the first or second MBS session ID from another core network, the RAN node can determine that the first, second and third MBS session ID are associated with each other.

In an embodiment, the MBS broadcast context create request may further comprise a preferred MBS session ID.

In an embodiment, a preferred MBS session ID may be used or considered by a radio access network node to broadcast multicast or broadcast data toward a network indicated in the preferred MBS session ID and/or used or considered by a user equipment to prioritize the network indicated in the preferred MBS session ID to receive data broadcasted by the radio access network node.

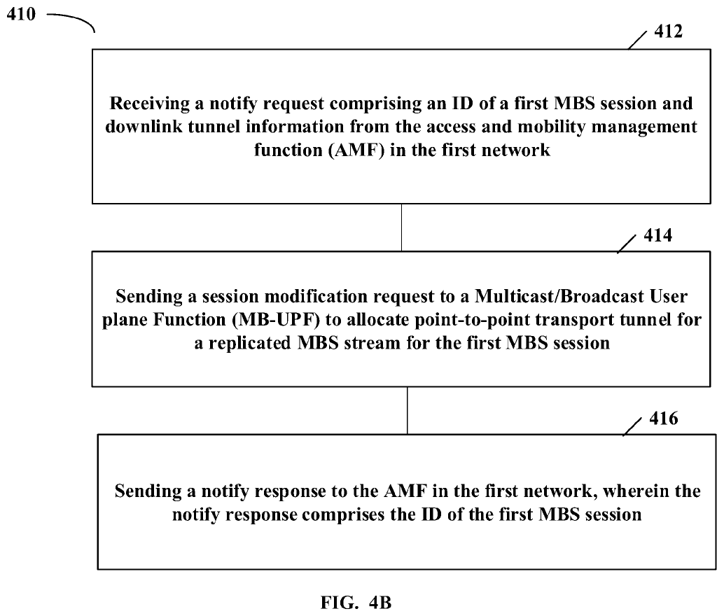

FIG. 4A shows a flowchart of a method according to another embodiment of the present disclosure, which may be performed by an apparatus implemented in/as or communicatively coupled to a multicast/broadcast session management function (MB-SMF) in the first network. As such, the apparatus may provide means for accomplishing various parts of the method 400 as well as means for accomplishing other processes in conjunction with other components. For some parts which have been described in the above embodiments, the description thereof is omitted here for brevity.

At block 402, the MB-SMF may receive a MBS session create request from a Network Exposure Function (NEF) or a Multicast/Broadcast Service Function (MBSF) in the first network or an application function (AF). The MBS session create request may comprise a multicast/broadcast service (MBS) session identifier (ID) and at least one associated session ID. The at least one associated session ID is used to make an association for two or more broadcast MBS sessions of two or more networks.

At block 404, the MB-SMF may send a MBS broadcast context create request to an access and mobility management function (AMF) in the first network. The MBS broadcast context create request may comprise the MBS session ID and the at least one associated session ID.

In an embodiment, a predefined number of user planes are expected to be established for the two or more MBS sessions of the two or more networks.

In an embodiment, the MBS session ID may comprise a temporary mobile group identity (TMGI).

In an embodiment, the at least one associated session ID may comprise a source-specific multicast internet protocol address used by an application node.

In an embodiment, the MBS session ID may be a first MBS session ID and the at least one associated session identifier may be at least one second MBS session ID.

In an embodiment, the MBS session create request and the MBS broadcast context create request may not comprise all second MBS session IDs associated to the first MBS session ID. For example, the MBS session create request and the MBS broadcast context create request may comprise only one second MBS session ID associated to the first MBS session ID. When the RAN node receives a third MBS session ID associated to the first or second MBS session ID from another core network, the RAN node can determine that the first, second and third MBS session ID are associated with each other.

In an embodiment, the MBS session create request and the MBS broadcast context create request further comprise a preferred MBS session ID.

In an embodiment, a preferred MBS session ID may be used or considered by a radio access network node to broadcast multicast or broadcast data toward a network indicated in the preferred MBS session ID and/or used or considered by a user equipment to prioritize the network indicated in the preferred MBS session ID to receive data broadcasted by the radio access network node.

FIG. 4B shows a flowchart of a method according to another embodiment of the present disclosure, which may be performed by an apparatus implemented in/as or communicatively coupled to a multicast/broadcast session management function (MB-SMF) in the first network. As such, the apparatus may provide means for accomplishing various parts of the method 410 as well as means for accomplishing other processes in conjunction with other components. For some parts which have been described in the above embodiments, the description thereof is omitted here for brevity.

At block 412, the MB-SMF may receive a notify request comprising an N2 request comprising an ID of a first MBS session and downlink tunnel information from an access and mobility management function (AMF) in the first network.

At block 414, the MB-SMF may send a session modification request to a Multicast/Broadcast User plane Function (MB-UPF) to allocate point-to-point transport tunnel for a replicated MBS stream for the first MBS session.

At block 416, the MB-SMF may send a notify response to the AMF in the first network. The notify response may comprise the ID of the first MBS session. For example, the notify response may comprise an N2 response comprising the ID of the first MBS session.

In an embodiment, a predefined number of user planes are expected to be established for two or more MBS sessions of two or more networks

In an embodiment, the N2 request is a broadcast session transport request and the N2 response is a broadcast session transport response.

In an embodiment, the notify request is an MBS broadcast context status notify request and the notify response is an MBS broadcast context status notify response.

In an embodiment, the two or more networks comprise a 3rd Generation Partnership Project (3GPP) network.

In an embodiment, the ID of the first MBS session may comprise a temporary mobile group identity (TMGI).

In an embodiment, the predefined number of user planes may comprise one user plane.

In an embodiment, multiple core networks are connected to a radio access network node.

FIG. 5A shows a flowchart of a method according to another embodiment of the present disclosure, which may be performed by an apparatus implemented in/as or communicatively coupled to a Network Exposure Function (NEF) or a Multicast/Broadcast Service Function (MBSF) or a combined NEF and MBSF in the first network. As such, the apparatus may provide means for accomplishing various parts of the method 500 as well as means for accomplishing other processes in conjunction with other components. For some parts which have been described in the above embodiments, the description thereof is omitted here for brevity.

At block 502, the NEF or the MBSF or the combined NEF and MBSF may receive a second MBS session create request from an application node (AF). The second MBS session create request may comprise a multicast/broadcast service (MBS) session identifier (ID) and at least one associated session ID. The at least one associated session ID may be used to make an association for two or more broadcast MBS sessions of two or more networks.

At block 504, the NEF or the MBSF or the combined NEF and MBSF may send a first MBS session create request to a multicast/broadcast session management function (MB-SMF) in the first network. The first MBS session create request may comprise the MBS session ID and the at least one associated session ID. A predefined number of user planes are expected to be established for the two or more MBS sessions of the two or more networks.

In an embodiment, the two or more networks comprise a 3rd Generation Partnership Project (3GPP) network.

In an embodiment, the predefined number of user planes may comprise one user plane.

In an embodiment, multiple core networks are connected to a radio access network node.

In an embodiment, the MBS session ID may comprise a temporary mobile group identity (TMGI).

In an embodiment, the at least one associated session ID may comprise a source-specific multicast internet protocol address used by an application node.

In an embodiment, the MBS session ID may be a first MBS session ID and the at least one associated session identifier may be at least one second MBS session ID.

In an embodiment, the first MBS session create request and the second MBS session create request may not comprise all second MBS session IDs associated to the first MBS session ID. For example, the first MBS session create request and the second MBS session create request may comprise only one second MBS session ID associated to the first MBS session ID. When the RAN node receives a third MBS session ID associated to the first or second MBS session ID from another core network, the RAN node can determine that the first, second and third MBS session ID are associated with each other.

In an embodiment, the first MBS session create request and the second MBS session create request further comprise a preferred MBS session ID.

In an embodiment, a preferred MBS session ID may be used or considered by a radio access network node to broadcast multicast or broadcast data toward a network indicated in the preferred MBS session ID and/or used or considered by a user equipment to prioritize the network indicated in the preferred MBS session ID to receive data broadcasted by the radio access network node.

FIG. 5B shows a flowchart of a method according to another embodiment of the present disclosure, which may be performed by an apparatus implemented in/as or communicatively coupled to an application function (AF). As such, the apparatus may provide means for accomplishing various parts of the method 520 as well as means for accomplishing other processes in conjunction with other components. For some parts which have been described in the above embodiments, the description thereof is omitted here for brevity.

At block 522, the AF may send a second MBS session create request to a multicast/broadcast session management function (MB-SMF) or a Network Exposure Function (NEF) or a Multicast/Broadcast Service Function (MBSF) or a combined NEF and MBSF in a first network. The second MBS session create request may comprise a multicast/broadcast service (MBS) session identifier (ID) and at least one associated session ID.

In an embodiment, the at least one associated session ID is used to make an association for two or more broadcast MBS sessions of two or more networks,

In an embodiment, a predefined number of user planes are expected to be established for two or more MBS sessions of the two or more networks.

In an embodiment, the two or more networks comprise a 3rd Generation Partnership Project (3GPP) network.

In an embodiment, the predefined number of user planes may comprise one user plane.

In an embodiment, multiple core networks are connected to a radio access network node.

In an embodiment, the MBS session ID may comprise a temporary mobile group identity (TMGI).

In an embodiment, the at least one associated session ID may comprise a source-specific multicast internet protocol address used by an application node.

In an embodiment, the MBS session ID may be a first MBS session ID and the at least one associated session identifier may be at least one second MBS session ID.

In an embodiment, the second MBS session create request may not comprise all second MBS session IDs associated to the first MBS session ID. For example, the second MBS session create request may comprise only one second MBS session ID associated to the first MBS session ID. When the RAN node receives a third MBS session ID associated to the first or second MBS session ID from another core network, the RAN node can determine that the first, second and third MBS session ID are associated with each other.

In an embodiment, the second MBS session create request further comprise a preferred MBS session ID.

In an embodiment, a preferred MBS session ID may be used or considered by a radio access network node to broadcast multicast or broadcast data toward a network indicated in the preferred MBS session ID and/or used or considered by a user equipment to prioritize the network indicated in the preferred MBS session ID to receive data broadcasted by the radio access network node.

FIG. 5C shows a flowchart of MBS Session Creation for MOCN RAN sharing according to another embodiment of the present disclosure.

1. AF sends Nnef_TMGI_Allocate Request (TMGI number) message to NEF/MBSF to request allocation of a TMGI(s) to identify new MBS session(s).

NOTE 1: Depending on the network deployment and use case, MB-SMF may receive requests from AF directly, or via NEF, or via MBSF, or via NEF and MBSF.

2. NEF checks authorization of AF.

NOTE 2: NEF is not required if AF is in trusted domain.

3. NEF/MBSF discovers and selects an MB-SMF using NRF or based on local configuration,

4. NEF/MBSF sends an Nmbsmf_TMGI_Allocate Request (TMGI number) message to the MB-SMF.

5. MB-SMF allocates TMGI(s) and returns the TMGI(s) to the NEF/MBSF via the Nmbsmf_TMGI_Allocate response (TMGI(s), expiration time).

6. The NEF or MBSF responds to the AF by sending an Nnef_TMGI_Allocate Response (TMGI(s), expiration time).

7. The AF may perform a Service Announcement towards UEs. The AF informs UEs about MBS Session information with MBS Session ID, e.g., TMGI, SSM, and possibly other information e.g., MBS service area, session description information, etc.

The MBS service area information can be Cell ID list, TAI list, geographical area information or civic address information. Amongst them, Cell ID list and TAI list shall only be used by AFs who reside in trust domain, and when the AFs are aware of such information.

The UE needs to be aware if the service is broadcast or multicast to decide if JOIN is to be performed.

8. AF of content provider may provide description for an MBS session (possibly providing information for a previously allocated TMGI to NEF via a Nnef_MBSSession_Create request (([MBS Session ID], service type, MBS information, [TMGI allocation indication]). If step 1-6 has not been executed before, the AF may provide a SSM or it may request that the network allocates an identifier for the MBS session (i.e., TMGI). The AF provides the service type (i.e. either multicast service or broadcast service). MBS session information may further include QoS requirements and Any UE indication (indicating whether a multicast MBS session is “open to any UEs”), MBS service area, start and end time of the MBS session and MBS session state (active/inactive). In addition, MBS information may also indicate whether the allocation of an ingress transport address is requested.

If geographical area information or civic address information was provided by the AF as MBS service area, NEF/MBSF translates the MBS service area to Cell ID list or TAI list.

The AF provides the associated session ID to the NEF/MBSF when invoking Nnef_MBSSession_Create Request.

AF provides the associated session ID which is used to associate multiple broadcast MBS sessions in different CNs. Typically, it can be the SSM IP address used by the AF.

9 NEF/MBSF checks authorization of content provider.

10. NEF/MBSF discovers MB-SMF candidates and selects MB-SMF as ingress control node, possibly based on MBS service area. If a TMGI is included in step 8, NEF/MBSF finds MB-SMF based on that TMGI.

11. NEF/MBSF sends Nmbsmf_MBSSession_Create Request (MBS Session ID, service type, TMGI allocation indication, MBS service area information, ingress transport address request indication) to MB-SMF, to request MB-SMF to reserve ingress resources for a MBS distribution session, The NEF/MBSF provides MBS Session ID or request allocation of a TMGI, and indicate the requested service type (either multicast service or broadcast service) and MBS session state (active/inactive). It also indicates that the allocation of an ingress transport address is requested if this was requested in step 8, or if the MBSF decides to insert an MBSTF into the user plane for the MBS session. The request also includes the Any UE indication if provided in step 8.

The MBS service area is provided by NEF/MBSF to the MB-SMF if provided by the AF in step 8.

The NEF/MBSF provides the associated session ID to the MB-SMF when invoking Nmbsmf_MBSSession_Create Request. The MB-SMF stores the associated session ID as a part of the MBS session context to be further distributed to NG-RAN.

12. If requested to do so, or if a source specific multicast is provided as MBS Session ID in step 11, the MB-SMF allocates a TMGI.

If a source specific multicast is provided as MBS Session ID in step 11, the MB-SMF updates its NF profile at the NRF with the serving MBS Session ID. If an MBS service area information was received in step 11, the MB-SMF updates its NF profile at the NRF with that information.

NOTE 3: If TMGI is used to represent an MBS Session, MB-SMF does not need to update NRF if the TMGI range(s) supported by an MB-SMF is already included in the MB-SMF profile when MB-SMF register itself into NRF.

13. The MB-SMF derives the required QoS parameters locally.

14 MB-SMF selects the MB-UPF. If the allocation of an ingress transport address was requested in step 11, the MB-SMF requests the MB-UPF to reserve user plane ingress resources. If multicast transport of the MBS data towards RAN nodes is to be used, the MB-SMF also request the MB-UPF to reserve for the outgoing data a tunnel endpoint and the related identifiers (source IP address, SSM and GTP Tunnel ID) and to forward data received at the user plane ingress resource using that tunnel endpoint.

If the allocation of an ingress transport address was not requested in step 11, the MB-SMF provides the SSM received as MBS session ID to the MB-UPF and requests the MB-UPF to join the corresponding multicast tree from the content provider. The MB-SMF may also defer the configuration to join the corresponding multicast tree e.g. based on information that the session is inactive, QoS requirements and MBS start/end time until receiving the first query for the MBS session as part of the establishment procedure in clause 7.2.1.3 of 3GPP TS 23.247 V17.2.0, or until receiving a request to activate the MBS session via the MBS Session Update procedure in clause 7.1.1.6 or 7.1.1.7 of 3GPP TS 23.247 V17.2.0.

15. If requested, MB-UPF selects an ingress address (IP address and port) and a tunnel endpoint for the outgoing data and provides it to MB-SMF.

16. For broadcast communication, the MB-SMF continues the procedure towards the AMF and NG-RAN as specified in clause 7.3.1 of 3GPP TS 23.247 V17.2.0.

17. MB-SMF indicates the possibly allocated ingress address to the NEF/MBSF. MB-SMF may include TMGI if it is allocated in step 9. It also indicates the success or failure of reserving transmission resources.

18. [Optional] If the MBSF decides to use an MBSTF, the NEF/MBSF provides the ingress address received in step 14 towards the MBSTF as DL destination. If the allocation of an ingress transport address was requested in step 8, the MBSF requests the MBSTF to allocate the user plane ingress resources. If the allocation of an ingress transport address was not requested in step 8, the MBSF provides the SSM received as Multicast session ID in step 8 and requests the MBSTF to join the corresponding multicast tree from the content provider.

19. [Conditional on step 19] If requested, the MBSTF selects an ingress address (IP address and port) and provides it to NEF/MBSF.

20. The NEF/MBSF-C indicates the possibly allocated ingress address and other parameters (e.g. TMGI) to the AF via an Nnef_MBSSession_Create response ([TMGI], [Allocated ingress address])). If MBS Session ID is not provided in step 8, or the MBS Session ID is SSM, the NEF/MBSF provides the allocated TMGI. If AF requests the allocation of an ingress transport address, the message also includes the allocated ingress address.

21. Same as step 7. The AF may also perform a service announcement at this stage.

22. For multicast communication, depending on configuration UEs can join the MBS Session as specified in clause 7.2.1 of 3GPP TS 23.247 V17.2.0.

The same updates of steps 8 and 11 apply to clause 7.1.1.3 of 3GPP TS 23.247 V17.2.0.

FIG. 6 shows a flowchart of MBS Session Start for Broadcast for MOCN RAN sharing according to another embodiment of the present disclosure.

1. To establish broadcast MBS session, the AF performs TMGI allocation and MBS session creation as specified in FIG. 5. The MBS service type indicates to be broadcast service.

2. The MB-SMF may use NRF to discover the AMF(s) supporting MBS based on the MBS service area and select the appropriate one(s). Then the MB-SMF sends the Namf_MBSBroadcast_ContextCreate (TMGI, LL SSM, 5G QoS Profile, MBS service area, associated session ID) messages to the selected AMF(s) in parallel if the service type is broadcast service. The MB-SMF may include a maximum response time in the request.

3. The AMF transfers the MBS Session Resource Setup Request message, which contains the N2 SM information in the received Namf_MBSBroadcast_ContextCreate Request, including associated session ID, to all NG-RANs which support MBS in the MBS service area. The AMF may include the MBS service area.

4. NG-RAN creates a Broadcast MBS Session Context including the associated session ID, stores the TMGI, the QoS Profile in the MBS Session Context. The LL SSM are optional parameters and only provided by MB-SMF to NG-RAN if N3mb multicast transport is configured to be used in the 5GC.

If the NG-RAN understands the broadcast MBS Session is associated with another Broadcast MBS Session identified by the associated session ID whose radio resource has been allocated and content has been delivered over the air, the NG-RAN does not further establish the user plane of the broadcast MBS session. That is, step 5 is skipped for multicast transport of N3mb, and for unicast transport of N3mb DL Tunnel Info is not allocated and included in step 6-7 or step 10-11, and thus step 8 or step 12 will not be executed.

5. If NG-RAN prefers to use N3mb multicast transport (and if LL SSM is available in NG-RAN), the NG-RAN joins the multicast group (i.e. LL SSM).

If NG-RAN prefers to use N3mb point-to-point transport (or if the LL SSM is not available in NG-RAN) between the NG-RAN and MB-UPF, NG-RAN provides its N3mb DL Tunnel Info.

6. The NG-RAN reports successful establishment of the MBS Session resources (which may include multiple MBS QoS Flows) by sending MBS Session Resource Setup Response (TMGI, N2 SM information (N3mb DL Tunnel Info)) message(s) to the AMF. N3mb DL Tunnel Info is only available when point-to-point transport applies between MB-UPF and NG-RAN. The NG-RAN reports in N2 SM container partially successful result, if not all MBS Session resources (i.e. all MBS QoS flows admitted) are established successfully in all requested cells.

7. The AMF transfers the Namf_MBSBroadcast_ContextCreate Response ( ) to the MB-SMF. The AMF should respond success when it receives the first success response from the NG-RAN(s). And if all NG-RAN(s) report failure, the AMF should respond failure. The MB-SMF stores the AMF(s) which responds success in the MBS Session Context as the downstream nodes. If the AMF receives the NG-RAN response from all involved NG-RAN(s), the AMF should include an indication of completion of the operation in all NG-RANs.

8. If N3mb point-to-point transport is to be used (i.e. N3mb DL Tunnel Info is present in the Namf_MBSBroadcast_ContextCreate Response message from AMF), the MB-SMF sends an N4mb Session Modification Request to the MB-UPF to allocate the N3mb point-to-point transport tunnel for a replicated MBS stream for the MBS Session. Otherwise, step 8 can be skipped.

9. NG-RAN advertises the TMGI representing the MBS service over radio interface. Step 9 can take place in parallel with step 6.

If the NG-RAN understands the broadcast MBS Session is associated with another Broadcast MBS Session by the associated session ID whose content has been delivered over the air, the NG-RAN advertises the TMGI of the broadcast MBS session and link the TMGI to existing radio resources.

10. Another NG-RAN may report successful establishment of the MBS Session resources (which may include multiple MBS QoS Flows) by sending MBS Session Resource Setup Response (TMGI, N2 SM information (N3mb DL Tunnel Info)) message after the AMF transferred the Namf_MBSBroadcast_ContextCreate Response ( ) to the MB-SMF.

11. The AMF transfers the Namf_MBSBroadcast_ContextStatusNotify request ( ) to the MB-SMF. When the AMF receives the response from all NG-RAN nodes, the AMF includes an indication of the completion of the operation. If the AMF does not receive responses from all NG-RAN nodes before the maximum response time elapses since the reception of the Namf_MBSBroadcast_ContextCreate Request, then the AMF should transfer the Namf_MBSBroadcast_ContextStatusNotify request ( ) which indicates partial success or failure.

12. If N3mb point-to-point transport is to be used (i.e. N3mb DL Tunnel Info is present in the MBS Session Start Response message from AMF), the MB-SMF sends an N4mb Session Modification Request to the MB-UPF to allocate the N3mb point-to-point transport tunnel for a replicated MBS stream for the MBS Session. Otherwise, step 12 can be skipped.

13. The AF starts transmitting the DL media stream to MB-UPF using the N6mb Tunnel, or optionally un-tunneled i.e. as an IP multicast stream using the HL MC address.

14. The MB-UPF transmits the media stream to NG-RAN via N3mb multicast transport or point-to-point transport.

15. The NG-RAN transmits the received DL media stream using DL PTM resources.

FIG. 7 shows a flowchart of MBS Session Release for Broadcast for MOCN RAN sharing according to another embodiment of the present disclosure.

1. The AF/AS may stop the media stream before sending the MBS Session Release Request (TMGI) message to the 3GPP network.

2. The AF/AS performs MBS Session Deletion procedure to request release of MBS Session (steps 1-10 in FIG. 7.1.1.4-1 of 3GPP TS 23.247 V17.2.0, or steps 1˜13 in FIG. 7.1.1.5-1 of 3GPP TS 23.247 V17.2.0).

3. MB-SMF sends Namf_MBSBroadcast_ContextRelease request (TMGI) to the AMF(s) that has been involved in the MBS Session.

4. The AMF sends an N2 message to all RAN nodes that have been involved to release MBS session. If a NG-RAN node receives multiple N2 message to release the MBS Session for the same TMGI (e.g. from several AMFs the NG-RAN is connected to), NG-RAN only performs step 5 and step 6 once.

5. If the user plane of the broadcast MBS session is not established, the NG-RAN will not stop the content delivery. Instead, it simply stops the advertisement of the TMGI. And it will not further release the user plane which hasn't been established. That is, step 6 is skipped for multicast transport of N3mb, and for unicast transport of N3mb DL Tunnel Info is not provided in step 7-8.

If the user plane of the broadcast MBS session is in use, the NG-RAN determines whether there are other broadcast MBS sessions which are associated with this associated session ID. If there are, the NG-RAN may decide not to release the radio resource. Instead, it may select another broadcast MBS session to establish the user plane with the MB-UPF in another CN as described in next clause, reuse the radio resource. It stops the advertisement of the TMGI of this broadcast MBS session and continues to release the broadcast MBS session.

6. If N3mb multicast transport has been used, the NG-RAN sends a Leave message (LL SSM) to stop the media stream to this NG-RAN node. If N3mb point-to-point transport has been used, the NG-RAN releases its DL N3mb Tunnel Info. NG-RAN deletes its MBS Session Context.

7. The NG-RAN reports successful release of resources for the MBS Session by sending MBS Session Resource Release Response (TMGI) message(s) to the AMF(s).

8. The AMF sends Namf_MBSBroadcast_ContextRelease response (TMGI) to the MB-SMF.

9. The AF may start a TMGI de-allocation procedure (steps 11˜14 in FIG. 7.1.1.4-1, or steps 14-17 in FIG. 7.1.1.5-1).

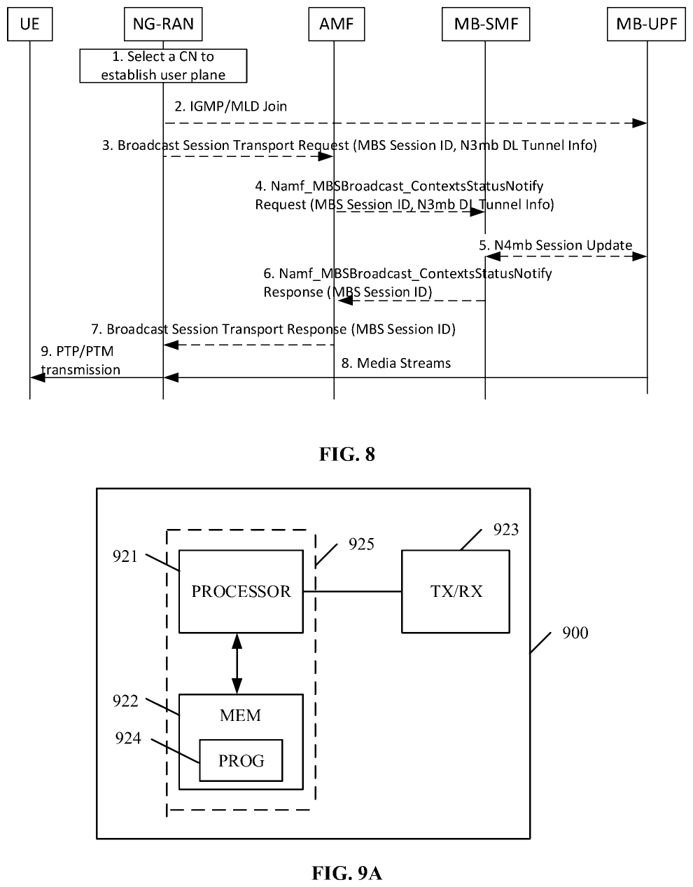

FIG. 8 shows a flowchart of Broadcast MBS Session Release Require according to another embodiment of the present disclosure.

1. NG-RAN selects a CN to establish user plane.

2. If multicast transport of N3mb applies, the NG-RAN performs join the multicast group towards the LL SSM provided by the CN, and skip step 3 to step 5.

3. If unicast transport of N3mb applies, the NG-RAN allocates N3mb DL Tunnel Info, and sends N2 message (e.g. BROADCAST SESSION TRANSPORT REQUEST) to AMF, including the MBS Session ID and the N3mb DL Tunnel Info.

4. The AMF transfers the Namf_MBSBroadcast_ContextStatusNotify request ( ) to the MB-SMF, which contains the N2 message.

5. The MB-SMF sends an N4mb Session Modification Request to the MB-UPF to allocate the N3mb point-to-point transport tunnel for a replicated MBS stream for the MBS Session. The MB-UPF sends N4mb Session Modification Response to the MB-SMF.

6. The MB-SMF sends Namf_MBSBroadcast_ContextStatusNotify response to the AMF, which contains the N2 response message (e.g. BROADCAST SESSION TRANSPORT RESPONSE).

7. The AMF forwards the N2 message to the NG-RAN

8. The MB-UPF transmits the media stream to NG-RAN via N3mb multicast transport or unicast transport.

9. The NG-RAN brings the packets received over the air, reusing the existing radio resource.

Many advantages may be achieved by applying the proposed solution according to embodiments of the present disclosure. For example, in some embodiments herein, for MOCN RAN sharing scenario, the RAN establishes a predefined number of user plane towards multiple CNs where multiple broadcast MBS session associated with the associated session identifier are established. In some embodiments herein, when there is a failure in the CN (which cause the RAN cannot receive packets), the RAN switches to another CN to establish the user plane. In some embodiments herein, it provides an efficient and robust solution. In some embodiments herein, it is efficient on that there is the predefined number of user plane established, which can avoid unnecessary user planes between the RAN and the MB-UPFs in other CNs. In some embodiments herein, it can further avoid RAN handling on duplicated packets (the packets received from the MB-UPFs in other CNs), as well as the MB-UPF handling. In some embodiments herein, it is robust on that the RAN can establish user plane towards another CN when there is a failure in the CN, and continue to use the packets received from the newly established user plane to offer the service towards UEs. The embodiments herein are not limited to the features and advantages mentioned above. A person skilled in the art will recognize additional features and advantages upon reading the following detailed description.

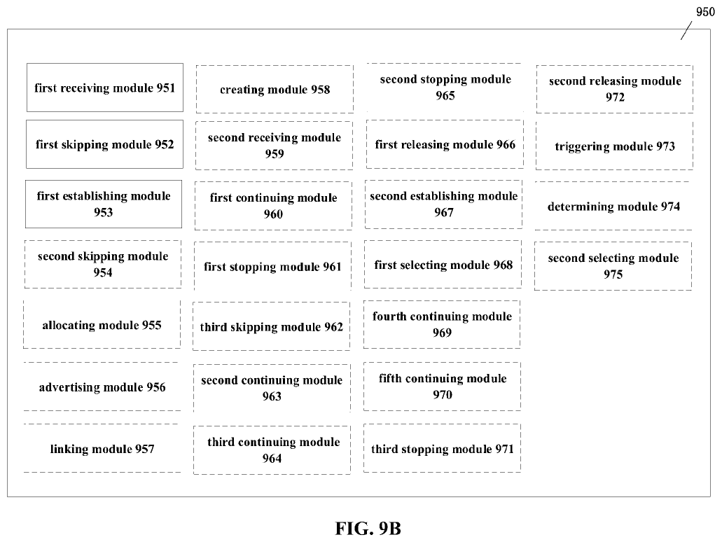

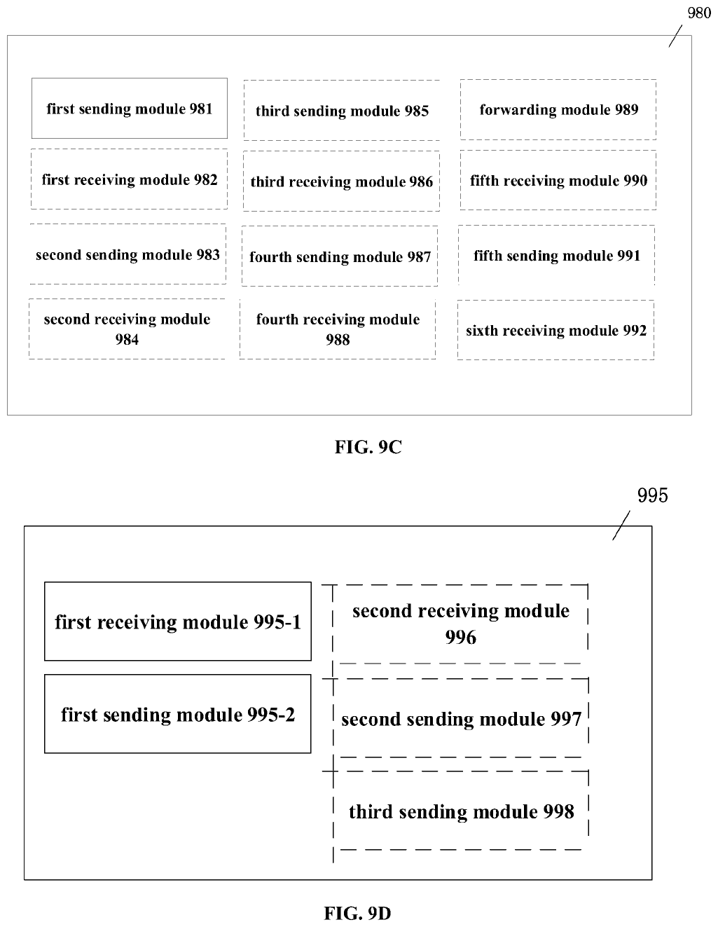

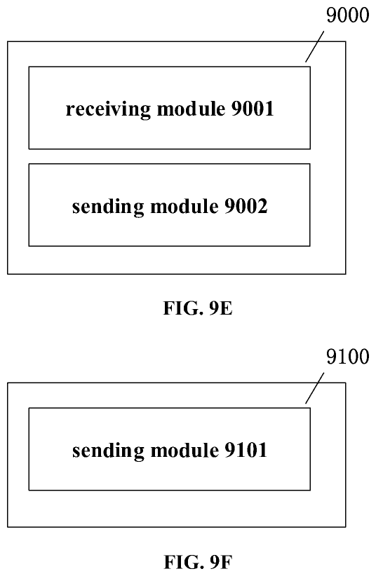

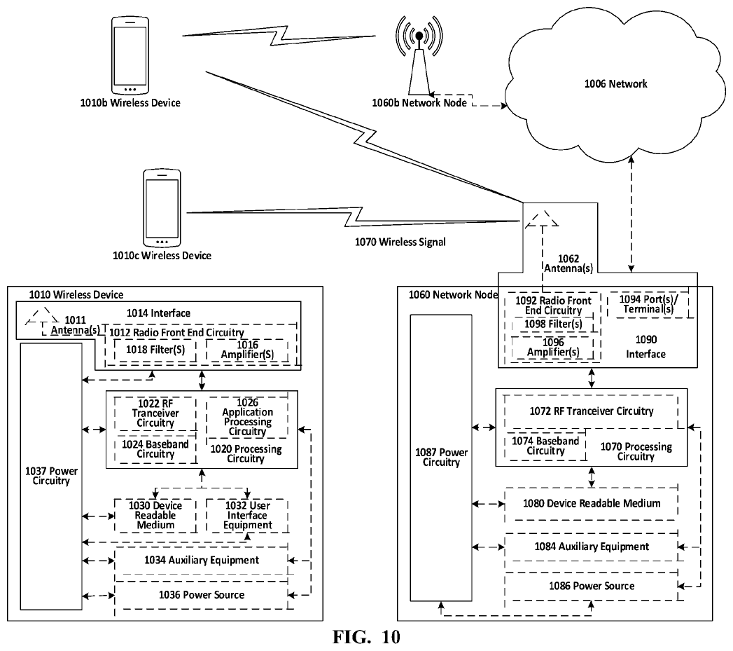

FIG. 9A is a block diagram showing an apparatus suitable for practicing some embodiments of the disclosure. For example, the radio access network node, the core network node, the NEF, the AF, MBSF or the MB-SMF described above may be implemented as or through the apparatus 900.

The apparatus 900 may comprise at least one processor 921, such as a digital processor (DP), and at least one memory (MEM) 922 coupled to the processor 921. The apparatus 900 may further comprise a transmitter TX and receiver RX 923 coupled to the processor 921. The MEM 922 stores a program (PROG) 924. The PROG 924 may include instructions that, when executed on the associated processor 921, enable the apparatus 900 to operate in accordance with the embodiments of the present disclosure. A combination of the at least one processor 921 and the at least one MEM 922 may form processing means 925 adapted to implement various embodiments of the present disclosure.

Various embodiments of the present disclosure may be implemented by computer program executable by one or more of the processor 921, software, firmware, hardware or in a combination thereof.

The MEM 922 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 921 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the radio access network node, the memory 922 contains instructions executable by the processor 921, whereby the radio access network node operates according to any of the methods related to the radio access network node as described above.

In an embodiment where the apparatus is implemented as or at the core network node, the memory 922 contains instructions executable by the processor 921, whereby the core network node operates according to any of the methods related to the core network node as described above.

In an embodiment where the apparatus is implemented as or at the MB-SMF, the memory 922 contains instructions executable by the processor 921, whereby the MB-SMF operates according to any of the methods related to the MB-SMF as described above.

In an embodiment where the apparatus is implemented as or at the NEF or MBSF, the memory 922 contains instructions executable by the processor 921, whereby the NEF or MBSF operates according to any of the methods related to the NEF or MBSF as described above.

In an embodiment where the apparatus is implemented as or at the AF, the memory 922 contains instructions executable by the processor 921, whereby the AF operates according to any of the methods related to the AF as described above.

FIG. 9B is a block diagram showing a radio access network node according to an embodiment of the disclosure. As shown, the radio access network node 950 may comprise a first receiving module 951 configured to receive a first request from a core network node in a first network. The first request may comprise a multicast/broadcast service (MBS) session identifier (ID) and at least one associated session identifier. The at least one associated session ID is used to make an association for two or more broadcast MBS sessions of two or more networks. The radio access network node 950 may further comprise a first skipping module 952 configured to receive, when a predefined number of user planes have been established for the two or more MBS sessions, skip establishing a user plane of a first MBS session towards the first network. The radio access network node 950 may further comprise a first establishing module 953 configured to, when the predefined number of user planes have not been established for the two or more MBS sessions, establish the user plane of the first MBS session towards the first network.

In an embodiment, the radio access network node 950 may further comprise a second skipping module 954 configured to, when radio resource has been allocated for broadcasting MBS content of an application node and shared by the two or more broadcast MBS sessions, skip allocating the radio resource.

In an embodiment, the radio access network node 950 may further comprise an allocating module 955 configured to, when the radio resource has not been allocated for broadcasting MBS content of an application node and shared by the two or more broadcast MBS sessions, allocate the radio resource.

In an embodiment, the radio access network node 950 may further comprise an advertising module 956 configured to advertise the MBS session ID.

In an embodiment, the radio access network node 950 may further comprise a linking module 957 configured to link the MBS session ID to the radio resource.

In an embodiment, the radio access network node 950 may further comprise a creating module 958 configured to create broadcast MBS session context including the at least one associated session ID.

In an embodiment, the radio access network node 950 may further comprise a second receiving module 959 configured to receive an MBS session release request from the core network node in the first network. The MBS session release request may comprise the MBS session ID.

In an embodiment, when the user plane of the first MBS session towards the first network is not established, the radio access network node 960 may further comprise a first continuing module 960 configured to continue content delivery of the two or more broadcast MBS sessions. The radio access network node 950 may further comprise a first stopping module 961 configured to stop advertisement of the MBS session ID. The radio access network node 950 may further comprise a third skipping module 962 configured to skip releasing the user plane of the first MBS session towards the first network.

In an embodiment, when the user plane of the first MBS session towards the first network is established and at least one other user plane for two or more broadcast MBS sessions is established, the radio access network node 950 may further comprise a second continuing module 963 configured to continue using radio resource allocated for broadcasting MBS content of an application node and shared by the two or more broadcast MBS sessions. The radio access network node 950 may further comprise a third continuing module 964 configured to continue content delivery of the two or more broadcast MBS sessions using the content received from another user plane. The radio access network node 950 may further comprise a second stopping module 965 configured to stop advertisement of the MBS session ID. The radio access network node 950 may further comprise a first releasing module 966 configured to release the user plane of the first MBS session towards the first network.

In an embodiment, the radio access network node 950 may further comprise a second establishing module 967 configured to, when the predefined number of user planes have not been established for the two or more MBS sessions, establish the predefined number of user planes for the two or more MBS sessions.

In an embodiment, when the user plane of the first MBS session towards the first network is established and no other user plane for two or more broadcast MBS sessions is established, the radio access network node 950 may further comprise a first selecting module 968 configured to select a second MBS session of the two or more broadcast MBS sessions to establish a user plane of the second MBS session towards a second network. The radio access network node 950 may further comprise a fourth continuing module 969 configured to continue using radio resource allocated for broadcasting MBS content of an application node and shared by the two or more broadcast MBS sessions. The radio access network node 950 may further comprise a fifth continuing module 970 configured to continue content delivery of the two or more broadcast MBS sessions using the content received from the user plane of the second MBS session. The radio access network node 950 may further comprise a third stopping module 971 configured to stop advertisement of the MBS session ID. The radio access network node 950 may further comprise a second releasing module 972 configured to release the user plane of the MBS session towards the first network.

In an embodiment, the radio access network node 950 may further comprise a triggering module 973 configured to trigger Broadcast MBS Session Release Require procedure for each associated broadcast MBS session.

In an embodiment, the radio access network node 950 may further comprise a determining module 974 configured to determine that the radio access network node cannot receive MBS content from a user plane of a third MBS session towards a third network.

In an embodiment, the radio access network node 950 may further comprise a second selecting module 975 configured to select a fourth MBS session of the two or more broadcast MBS sessions to establish a user plane of a fourth MBS session MBS session towards a fourth network.

FIG. 9C is a block diagram showing a core network node in a first network according to an embodiment of the disclosure. As shown, the core network node 980 may comprise a first sending module 981 configured to sending a first request to a radio access network node. The first request may comprise an MBS session identifier (ID) and at least one associated session identifier. The at least one associated session ID is used to make an association for two or more broadcast MBS sessions of two or more networks. A predefined number of user planes are expected to be established for the two or more MBS sessions.

In an embodiment, when a user plane of a first MBS session towards the first network is skipped establishing, the core network node 980 may comprise a first receiving module 982 configured to, for unicast transport, receive a first response without downlink tunnel information from the radio access network node. The core network node 980 may comprise a second sending module 983 configured to send a response without downlink tunnel information to a multicast/broadcast session management function (MB-SMF) in the first network.

In an embodiment, the core network node 980 may comprise a second receiving module 984 configured to receive a release request from a multicast/broadcast session management function (MB-SMF) in the first network. The release request may comprise the MBS session ID.

In an embodiment, the core network node 980 may comprise a third sending module 985 configured to send an MBS session release request to the radio access network node. The MBS session release request may comprise the MBS session ID.

In an embodiment, when the user plane of the first MBS session towards the first network is not established, the core network node 980 may comprise a third receiving module 986 configured to, for unicast transport, receive an MBS session release response without downlink tunnel information from the radio access network node. The core network node 980 may comprise a fourth sending module 987 configured to send a release response without the downlink tunnel information to the MB-SMF in the first network.

In an embodiment, when there is a failure in a network which causes the radio access network node cannot receive MBS content from a user plane of a MBS session towards the network and a first MBS session towards the first network is selected by the radio access network node to establish a user plane, the core network node 980 may comprise a fourth receiving module 988 configured to, for unicast transport, receive an N2 request comprising an ID of the first MBS session and downlink tunnel information from the radio access network node. The core network node 980 may comprise a forwarding module 989 configured to forward the session management (SM) information in N2 request via a notify request to a multicast/broadcast session management function (MB-SMF) in the first network. The core network node 980 may comprise a fifth receiving module 990 configured to receive a notify response from the MB-SMF in the first network. The notify response may comprise the ID of the first MBS session. The core network node 980 may comprise a fifth sending module 991 configured to send the N2 response to the radio access network node.

In an embodiment, the core network node 980 may comprise a sixth receiving module 992 configured to receive a MBS broadcast context create request from a Multicast/Broadcast Session Management Function (MB-SMF) in the first network. The MBS broadcast context create request may comprise the MBS session ID and the at least one associated session identifier.

FIG. 9D is a block diagram showing an MB-SMF in the first network according to an embodiment of the disclosure. As shown, the MB-SMF 995 may comprise a first receiving module 995-1 configured to receive a MBS session create request from a Network Exposure Function (NEF) or a Multicast/Broadcast Service Function (MBSF) in the first network or an application function (AF). The MBS session create request may comprise a multicast/broadcast service (MBS) session identifier (ID) and at least one associated session ID. The at least one associated session ID is used to make an association for two or more broadcast MBS sessions of two or more networks. The MB-SMF 995 may further comprise a first sending module 995-2 configured to send a MBS broadcast context create request to an access and mobility management function (AMF) in the first network. The MBS broadcast context create request may comprise the MBS session ID and the at least one associated session ID. A predefined number of user planes are expected to be established for the two or more MBS sessions of the two or more networks.

In an embodiment, the MB-SMF 995 may further comprise a second receiving module 996 configured to receive a notify request comprising an N2 request comprising an ID of a first MBS session and downlink tunnel information from an access and mobility management function (AMF) in the first network. The MB-SMF 995 may comprise a second sending module 997 configured to sending a session modification request to a Multicast/Broadcast User plane Function (MB-UPF) to allocate point-to-point transport tunnel for a replicated MBS stream for the first MBS session. The MB-SMF 995 may comprise a third sending module 998 configured to send a notify response to the AMF in the first network. The notify response may comprise the ID of the first MBS session. A predefined number of user planes are expected to be established for two or more MBS sessions of two or more networks.

FIG. 9E is a block diagram showing an NEF or MBSF or combined NEF and MBSF in the first network according to an embodiment of the disclosure. As shown, the NEF or MBSF or combined NEF and MBSF 9000 may comprise a receiving module 9001 configured to receive a second MBS session create request from an application node (AF). The second MBS session create request may comprise a multicast/broadcast service (MBS) session identifier (ID) and at least one associated session ID. The at least one associated session ID is used to make an association for two or more broadcast MBS sessions of two or more networks. The NEF or MBSF or combined NEF and MBSF 9000 may further comprise a sending module 9002 configured to send a first MBS session create request to a multicast/broadcast session management function (MB-SMF) in the first network. The first MBS session create request may comprise the MBS session ID and the at least one associated session ID. A predefined number of user planes are expected to be established for the two or more MBS sessions of the two or more networks.

FIG. 9F is a block diagram showing an AF according to an embodiment of the disclosure. As shown, the AF 9100 may comprise a sending module 9101 configured to send a second MBS session create request to a multicast/broadcast session management function (MB-SMF) or a Network Exposure Function (NEF) or MBSF or a combined NEF and MBSF in a first network. The second MBS session create request may comprise a multicast/broadcast service (MBS) session identifier (ID) and at least one associated session ID. The at least one associated session ID is used to make an association for two or more broadcast MBS sessions of two or more networks. A predefined number of user planes are expected to be established for two or more MBS sessions of the two or more networks.

In a first embodiment of the disclosure, there is provided a method performed by an application node. The method may comprise sending a first message to a first network function in a first network or a third network function in the first network. The first message may comprise at least one second multicast or broadcast service identifier associated to a first multicast or broadcast service identifier.

In an embodiment, the at least one second multicast or broadcast service identifier associated to the first multicast or broadcast service identifier is used to make an association for two or more multicast or broadcast services with same multicast or broadcast content across two or more networks.

In an embodiment, the first network may comprise a 3rd Generation Partnership Project (3GPP) network.

In an embodiment, the first network function may comprise at least one of Network Exposure Function (NEF), Multicast/Broadcast Service Function (MBSF), or a combined NEF and MBSF.

In an embodiment, the third network function may comprise Multicast/Broadcast Session Management Function (MB-SMF).

In an embodiment, the method may further comprise sending an identifier allocate request to the first network function in the first network or the third network function in the first network. The method may further comprise receiving an identifier allocate response comprising the first multicast or broadcast service identifier from the first network function in the first network or the third network function in the first network. The first message may further comprise the first multicast or broadcast service identifier.

In an embodiment, the identifier allocate request may comprise the at least one second multicast or broadcast service identifier associated to the first multicast or broadcast service identifier.

In an embodiment, the identifier allocate request may further comprise a preferred multicast or broadcast service identifier.

In an embodiment, when the first message is a multicast or broadcast service session create request, the method may further comprise receiving a multicast or broadcast service session create response from the first network function in the first network or the third network function in the first network.

In an embodiment, the multicast or broadcast service session create response may comprise the first multicast or broadcast service identifier.

In an embodiment, the first multicast or broadcast service identifier and the at least one second multicast or broadcast service identifier comprise a temporary mobile group identity (TMGI).

In an embodiment, the first message may further comprise a preferred multicast or broadcast service identifier.

In an embodiment, the method may further comprise sending an update message comprising a preferred multicast or broadcast service identifier to the first network function in the first network or the third network function in the first network.

In an embodiment, the method may further comprise sending a service announce message to a user equipment. The service announce message may comprise the first multicast or broadcast service identifier and one or more second multicast or broadcast service identifiers associated to the first multicast or broadcast service identifier.

In an embodiment, the service announce message may further comprise a preferred multicast or broadcast service identifier.

In an embodiment, a preferred multicast or broadcast service identifier is used by a radio access network node to broadcast multicast or broadcast data toward a network indicated in the preferred multicast or broadcast service identifier and/or used by a user equipment to prioritize the network indicated in the preferred multicast or broadcast service identifier to receive data broadcasted by the radio access network node.

In an embodiment, two or more core networks are connected to the radio access network node.

In an embodiment, the method may further comprise sending an identifier allocate request to a second network function in a second network. The method may further comprise receiving an identifier allocate response comprising a second multicast or broadcast service identifier from the second network function in the second network.

In an embodiment, the method may further comprise sending a multicast or broadcast service session create request to a second network function in a second network. The method may further comprise receiving a multicast or broadcast service session create response comprising a second multicast or broadcast service identifier from the second network function in the second network.

In an embodiment, the second network may comprise a 3GPP network.

In an embodiment, the second network function may comprise at least one of MB-SMF, NEF, MBSF, or a combined NEF and MBSF.

In an embodiment, the application node may comprise Application Function (AF).

In a second embodiment of the disclosure, there is provided a method performed by a first network function in a first network. The method may comprise receiving a first message from an application node. The first message may comprise at least one second multicast or broadcast service identifier associated to a first multicast or broadcast service identifier. The method may further comprise sending a second message to a third network function in the first network. The second message may comprise the at least one second multicast or broadcast service identifier associated to the first multicast or broadcast service identifier.

In an embodiment, the at least one second multicast or broadcast service identifier associated to the first multicast or broadcast service identifier is used to make an association for two or more multicast or broadcast services with same multicast or broadcast content across two or more networks.

In an embodiment, the first network may comprise a 3rd Generation Partnership Project (3GPP) network.

In an embodiment, the first network function may comprise at least one of Network Exposure Function (NEF), Multicast/Broadcast Service Function (MBSF), or a combined NEF and MBSF.

In an embodiment, the third network function may comprise Multicast/Broadcast Session Management Function (MB-SMF) and the application node may comprise Application Function (AF).

In an embodiment, the method may further comprise receiving a first identifier allocate request from the application node. The method may further comprise sending a second identifier allocate request to the third network function in the first network. The method may further comprise receiving a second identifier allocate response comprising the first multicast or broadcast service identifier from the third network function in the first network. The method may further comprise sending a first identifier allocate response comprising the first multicast or broadcast service identifier to the application node. The first message may further comprise the first multicast or broadcast service identifier.

In an embodiment, the first identifier allocate request and the second identifier allocate request comprise the at least one second multicast or broadcast service identifier associated to the first multicast or broadcast service identifier.

In an embodiment, the first identifier allocate request and the second identifier allocate request further comprise a preferred multicast or broadcast service identifier.

In an embodiment, the first message is a multicast or broadcast service session create request, the second message is a multicast or broadcast service session create request. The method may further comprise receiving a second multicast or broadcast service session create response from the third network function in the first network. The method may further comprise sending a first multicast or broadcast service session create response to the application node.

In an embodiment, the first multicast or broadcast service session create response and the second multicast or broadcast service session create response comprise the first multicast or broadcast service identifier.

In an embodiment, the first multicast or broadcast service identifier and the at least one second multicast or broadcast service identifier comprise a temporary mobile group identity (TMGI).

In an embodiment, the first message and the second message further comprise a preferred multicast or broadcast service identifier.

In an embodiment, the method may further comprise receiving an update request comprising a preferred multicast or broadcast service identifier from the application node. The method may further comprise sending an update request comprising the preferred multicast or broadcast service identifier to the third network function in the first network.

In an embodiment, a preferred multicast or broadcast service identifier is used by a radio access network node to broadcast multicast or broadcast data toward a network indicated in the preferred multicast or broadcast service identifier and/or used by a user equipment to prioritize the network indicated in the preferred multicast or broadcast service identifier to receive data broadcasted by the radio access network node.

In an embodiment, two or more core networks are connected to the radio access network node.

In a third embodiment of the disclosure, there is provided a method performed by a third network function in a first network. The method may comprise receiving a first message or a second message from an application node or a first network function in the first network. The first message or the second message may comprise at least one second multicast or broadcast service identifier associated to a first multicast or broadcast service identifier. The method may further comprise sending a third message to a fourth network function in the first network. The third message may comprise the first multicast or broadcast service identifier and the at least one second multicast or broadcast service identifier associated to the first multicast or broadcast service identifier.

In an embodiment, the at least one second multicast or broadcast service identifier associated to the first multicast or broadcast service identifier is used to make an association for two or more multicast or broadcast services with same multicast or broadcast content across two or more networks.

In an embodiment, the first network may comprise a 3rd Generation Partnership Project (3GPP) network.

In an embodiment, the first network function may comprise at least one of Network Exposure Function (NEF), Multicast/Broadcast Service Function (MBSF), or a combined NEF and MBSF.

In an embodiment, the third network function may comprise Multicast/Broadcast Session Management Function (MB-SMF) and the application node may comprise Application Function (AF).

In an embodiment, the first message, the second message and the third message further comprise a preferred multicast or broadcast service identifier.

In an embodiment, the method may further comprise receiving a second identifier allocate request from the first network function in the first network or the application node. The method may further comprise sending a second identifier allocate response comprising the first multicast or broadcast service identifier to the first network function in the first network or the application node. The first message or the second message may further comprise the first multicast or broadcast service identifier.

In an embodiment, the second identifier allocate request may comprise the at least one second multicast or broadcast service identifier associated to the first multicast or broadcast service identifier.

In an embodiment, the second identifier allocate request may further comprise a preferred multicast or broadcast service identifier.

In an embodiment, the first multicast or broadcast service identifier and the at least one second multicast or broadcast service identifier comprise a temporary mobile group identity (TMGI).

In an embodiment, the method may further comprise receiving an update request comprising a preferred multicast or broadcast service identifier from the first network function in the first network or the application node. The method may further comprise sending an update request comprising the preferred multicast or broadcast service identifier to the fourth network function in the first network or the application node.

In an embodiment, when the first message or the second message is a multicast or broadcast service session create request, the method may further comprise sending a multicast or broadcast service session create response to the application node or the first network function in the first network.

In an embodiment, the multicast or broadcast service session create response may comprise the first multicast or broadcast service identifier allocated by the third network function in the first network.

In an embodiment, the third message is a multicast or broadcast context create request.

In an embodiment, a preferred multicast or broadcast service identifier is used by a radio access network node to broadcast multicast or broadcast data toward a network indicated in the preferred multicast or broadcast service identifier and/or used by a user equipment to prioritize the network indicated in the preferred multicast or broadcast service identifier to receive data broadcasted by the radio access network node.

In an embodiment, two or more core networks are connected to the radio access network node.

In a fourth embodiment of the disclosure, there is provided a method performed by a fourth network function in a first network. The method may comprise receiving a third message from a third network function in the first network. The third message may comprise a first multicast or broadcast service identifier and at least one second multicast or broadcast service identifier associated to the first multicast or broadcast service identifier. The method may further comprise sending a fourth message to a radio access network node. The fourth message may comprise the first multicast or broadcast service identifier and the at least one second multicast or broadcast service identifier associated to the first multicast or broadcast service identifier.

In an embodiment, the at least one second multicast or broadcast service identifier associated to the first multicast or broadcast service identifier is used to make an association for two or more multicast or broadcast services with same multicast or broadcast content across two or more networks.

In an embodiment, the first network may comprise a 3rd Generation Partnership Project (3GPP) network.

In an embodiment, the third network function may comprise Multicast/Broadcast Session Management Function (MB-SMF).

In an embodiment, the third message and the fourth message further comprise a preferred multicast or broadcast service identifier.

In an embodiment, the first multicast or broadcast service identifier and the at least one second multicast or broadcast service identifier comprise a temporary mobile group identity (TMGI).

In an embodiment, the method may further comprise receiving an update request comprising a preferred multicast or broadcast service identifier from the third network function in the first network. The method may further comprise sending an update request comprising the preferred multicast or broadcast service identifier to the radio access network node.

In an embodiment, the third message is a multicast or broadcast context create request.

In an embodiment, the fourth message is a N2 message request.

In an embodiment, a preferred multicast or broadcast service identifier is used by the radio access network node to broadcast multicast or broadcast data toward a network indicated in the preferred multicast or broadcast service identifier and/or used by a user equipment to prioritize the network indicated in the preferred multicast or broadcast service identifier to receive data broadcasted by the radio access network node.

In an embodiment, two or more core networks are connected to the radio access network node.

In an embodiment, the fourth network function may comprise an access and mobility function (AMF).

In a fifth embodiment of the disclosure, there is provided a method performed by a radio access network node. The method may comprise receiving a fourth message from a fourth network function in a first network. The fourth message may comprise a first multicast or broadcast service identifier and at least one second multicast or broadcast service identifier associated to the first multicast or broadcast service identifier. The method may further comprise receiving multicast or broadcast data originating from an application node. The method may further comprise broadcasting the multicast or broadcast data based on the fourth message.

In an embodiment, the at least one second multicast or broadcast service identifier associated to the first multicast or broadcast service identifier is used to make an association for two or more multicast or broadcast services with same multicast or broadcast content across two or more networks.

In an embodiment, the first network may comprise a 3rd Generation Partnership Project (3GPP) network.

In an embodiment, the fourth message may further comprise a preferred multicast or broadcast service identifier.

In an embodiment, the first multicast or broadcast service identifier and the at least one second multicast or broadcast service identifier comprise a temporary mobile group identity (TMGI).

In an embodiment, the method may further comprise receiving an update request comprising a preferred multicast or broadcast service identifier from the fourth network function in the first network. The multicast or broadcast data is broadcasted further based on the preferred multicast or broadcast service identifier.

In an embodiment, the multicast or broadcast data is broadcasted toward a network identified by the preferred multicast or broadcast service identifier.

In an embodiment, the fourth message is a N2 message request.

In an embodiment, the fourth network function may comprise an access and mobility function (AMF).

In an embodiment, broadcasting the multicast or broadcast data based on the fourth message may comprise determining one or more multicast or broadcast service identifiers associated to the first multicast or broadcast service identifier based on the at least one second multicast or broadcast service identifier associated to the first multicast or broadcast service identifier; selecting at least one multicast or broadcast service identifier from the first multicast or broadcast service identifier and the one or more multicast or broadcast service identifiers associated to the first multicast or broadcast service identifier; and broadcasting the multicast or broadcast data toward at least one network identified by the selected at least one multicast or broadcast service identifier.

In an embodiment, broadcasting the multicast or broadcast data based on the fourth message may further comprise broadcasting the selected at least one multicast or broadcast service identifier to at least one user equipment.

In an embodiment, the method may further comprise broadcasting system information to at least one user equipment. The system information may comprise at least one of the first multicast or broadcast service identifier, one or more multicast or broadcast service identifiers associated to the first multicast or broadcast service identifier, or a preferred multicast or broadcast service identifier.

In an embodiment, a preferred multicast or broadcast service identifier is used by the radio access network node to broadcast multicast or broadcast data toward a network indicated in the preferred multicast or broadcast service identifier and/or used by a user equipment to prioritize the network indicated in the preferred multicast or broadcast service identifier to receive data broadcasted by the radio access network node.

In an embodiment, two or more core networks are connected to the radio access network node.

In an embodiment, the method may further comprise establishing a transmission link with a user plane function of the first network to receive the multicast or broadcast data. The method may further comprise skipping establishing the transmission link with the user plane function of the first network when the multicast or broadcast data can be received from a user plane function of another network.

In an embodiment, when same multicast or broadcast data originating from the application node is received from two or more networks, only a single copy of the same multicast or broadcast data is broadcasted based on the fourth message and the other copies of the same multicast or broadcast data are dropped.

In a sixth embodiment of the disclosure, there is provided a method performed by a user equipment (UE). The method may comprise receiving a message from an application node or a radio access network node. The message may comprise at least one of a first multicast or broadcast service identifier, one or more second multicast or broadcast service identifiers associated to the first multicast or broadcast service identifier, or a preferred multicast or broadcast service identifier. The method may further comprise receiving multicast or broadcast data broadcasted by the radio access network node based on the message.

In an embodiment, the one or more second multicast or broadcast service identifiers associated to the first multicast or broadcast service identifier are used to make an association for two or more multicast or broadcast services with same multicast or broadcast content across two or more networks.

In an embodiment, the message is system information or a service announce message.

In an embodiment, the first multicast or broadcast service identifier and the one or more second multicast or broadcast service identifiers comprise a temporary mobile group identity (TMGI).

In an embodiment, a preferred multicast or broadcast service identifier is used by the radio access network node to broadcast multicast or broadcast data toward a network indicated in the preferred multicast or broadcast service identifier and/or used by a user equipment to prioritize the network indicated in the preferred multicast or broadcast service identifier to receive data broadcasted by the radio access network node.

In an embodiment, two or more core networks are connected to the radio access network node.

In a seventh embodiment of the disclosure, there is provided an application node. The application node may comprise a processor and a memory coupled to the processor. Said memory contains instructions executable by said processor. Said application node is operative to send a first message to a first network function in a first network. The first message may comprise at least one second multicast or broadcast service identifier associated to a first multicast or broadcast service identifier.

In an eighth embodiment of the disclosure, there is provided a first network function in a first network. The first network function may comprise a processor and a memory coupled to the processor. Said memory contains instructions executable by said processor. Said first network function is operative to receive a first message from an application node. The first message may comprise at least one second multicast or broadcast service identifier associated to a first multicast or broadcast service identifier. Said first network function is further operative to send a second message to a third network function in the first network. The second message may comprise the at least one second multicast or broadcast service identifier associated to the first multicast or broadcast service identifier.

In a ninth embodiment of the disclosure, there is provided a third network function in a first network. The third network function may comprise a processor and a memory coupled to the processor. Said memory contains instructions executable by said processor. Said third network function is operative to receive a first message or a second message from an application node or a first network function in the first network. The first message or the second message may comprise at least one second multicast or broadcast service identifier associated to a first multicast or broadcast service identifier. Said third network function is further operative to send a third message to a fourth network function in the first network. The third message may comprise the first multicast or broadcast service identifier and the at least one second multicast or broadcast service identifier associated to the first multicast or broadcast service identifier.

In a tenth embodiment of the disclosure, there is provided a fourth network function in a first network. The fourth network function may comprise a processor and a memory coupled to the processor. Said memory contains instructions executable by said processor. Said fourth network function is operative to receive a third message from a third network function in the first network. The third message may comprise a first multicast or broadcast service identifier and at least one second multicast or broadcast service identifier associated to the first multicast or broadcast service identifier. Said fourth network function is further operative to send a fourth message to a radio access network node. The fourth message may comprise the first multicast or broadcast service identifier and the at least one second multicast or broadcast service identifier associated to the first multicast or broadcast service identifier.

In an eleventh embodiment of the disclosure, there is provided a radio access network node. The radio access network node may comprise a processor and a memory coupled to the processor. Said memory contains instructions executable by said processor. Said radio access network node is operative to receive a fourth message from a fourth network function in a first network. The fourth message may comprise a first multicast or broadcast service identifier and at least one second multicast or broadcast service identifier associated to the first multicast or broadcast service identifier. Said radio access network node is further operative to receive multicast or broadcast data originating from an application node. Said radio access network node is further operative to broadcast the multicast or broadcast data based on the fourth message.

In a twelfth embodiment of the disclosure, there is provided a user equipment (UE). The UE may comprise a processor and a memory coupled to the processor. Said memory contains instructions executable by said processor. Said UE is operative to receive a message from an application node or a radio access network node. The message may comprise at least one of a first multicast or broadcast service identifier, one or more second multicast or broadcast service identifiers associated to the first multicast or broadcast service identifier, or a preferred multicast or broadcast service identifier. Said UE is further operative to receive multicast or broadcast data broadcasted by the radio access network node based on the message.

In a thirteenth embodiment of the disclosure, there is provided an application node. The application node may comprise a first sending module configured to send a first message to a first network function in a first network or a third network function in the first network. The first message may comprise at least one second multicast or broadcast service identifier associated to a first multicast or broadcast service identifier.

In an embodiment, the application node may further comprise a sixth sending module configured to send an identifier allocate request to the first network function in the first network or the third network function in the first network.

In an embodiment, the application node may further comprise a second receiving module configured to receive an identifier allocate response comprising the first multicast or broadcast service identifier from the first network function in the first network or the third network function in the first network. The first message may further comprise the first multicast or broadcast service identifier.

In an embodiment, the application node may further comprise a third receiving module configured to receive a multicast or broadcast service session create response from the first network function in the first network or the third network function in the first network.

In an embodiment, the application node may further comprise a second sending module configured to send an update message comprising a preferred multicast or broadcast service identifier to the first network function in the first network or the third network function in the first network.

In an embodiment, the application node may further comprise a third sending module configured to send a service announce message to a user equipment. The service announce message may comprise the first multicast or broadcast service identifier and one or more second multicast or broadcast service identifiers associated to the first multicast or broadcast service identifier.

In an embodiment, the application node may further comprise a fourth sending module configured to send an identifier allocate request to a second network function in a second network.

In an embodiment, the application node may further comprise a fourth receiving module configured to receive an identifier allocate response comprising a second multicast or broadcast service identifier from the second network function in the second network.

In an embodiment, the application node may further comprise a fifth sending module configured to send a multicast or broadcast service session create request to a second network function in a second network.

In an embodiment, the application node may further comprise a fifth receiving module configured to receive a multicast or broadcast service session create response comprising a second multicast or broadcast service identifier from the second network function in the second network.

In a fourteenth embodiment of the disclosure, there is provided a first network function. The first network function may comprise a first receiving module configured to receiving a first message from an application node. The first message may comprise at least one second multicast or broadcast service identifier associated to a first multicast or broadcast service identifier. The first network function may further comprise a first sending module configured to send a second message to a third network function in the first network. The second message may comprise the at least one second multicast or broadcast service identifier associated to the first multicast or broadcast service identifier.

In an embodiment, the first network function may further comprise a second receiving module configured to receive a first identifier allocate request from the application node.

In an embodiment, the first network function may further comprise a second sending module configured to send a second identifier allocate request to the third network function in the first network.

In an embodiment, the first network function may further comprise a third receiving module configured to receive a second identifier allocate response comprising the first multicast or broadcast service identifier from the third network function in the first network.

In an embodiment, the first network function may further comprise a third sending module configured to send a first identifier allocate response comprising the first multicast or broadcast service identifier to the application node. The first message may further comprise the first multicast or broadcast service identifier.

In an embodiment, the first network function may further comprise a fourth receiving module configured to receive a second multicast or broadcast service session create response from the third network function in the first network.

In an embodiment, the first network function may further comprise a fourth sending module configured to send a first multicast or broadcast service session create response to the application node.

In an embodiment, the first network function may further comprise a fifth receiving module configured to receive an update request comprising a preferred multicast or broadcast service identifier from the application node.

In an embodiment, the first network function may further comprise a fifth sending module configured to send an update request comprising the preferred multicast or broadcast service identifier to the third network function in the first network.

In a fifteenth embodiment of the disclosure, there is provided a third network function. The third network function may comprise a first receiving module configured to receive a first message or a second message from an application node or a first network function in the first network. The first message or the second message may comprise at least one second multicast or broadcast service identifier associated to a first multicast or broadcast service identifier. The third network function may further comprise a first sending module configured to send a third message to a fourth network function in the first network. The third message may comprise the first multicast or broadcast service identifier and the at least one second multicast or broadcast service identifier associated to the first multicast or broadcast service identifier.

In an embodiment, the third network function may further comprise a second receiving module configured to receive a second identifier allocate request from the first network function in the first network or the application node.

In an embodiment, the third network function may further comprise a second sending module configured to send a second identifier allocate response comprising the first multicast or broadcast service identifier to the first network function in the first network or the application node. The first message or the second message may further comprise the first multicast or broadcast service identifier.

In an embodiment, the third network function may further comprise a third receiving module configured to receive an update request comprising a preferred multicast or broadcast service identifier from the first network function in the first network or the application node.

In an embodiment, the third network function may further comprise a third sending module configured to send an update request comprising the preferred multicast or broadcast service identifier to the fourth network function in the first network or the application node.

In an embodiment, the third network function may further comprise a fourth sending module configured to send a multicast or broadcast service session create response to the application node or the first network function in the first network.

In a sixteenth embodiment of the disclosure, there is provided a fourth network function. The fourth network function may comprise a first receiving module configured to receive a third message from a third network function in the first network. The third message may comprise a first multicast or broadcast service identifier and at least one second multicast or broadcast service identifier associated to the first multicast or broadcast service identifier. The fourth network function may further comprise a first sending module configured to send a fourth message to a radio access network node. The fourth message may comprise the first multicast or broadcast service identifier and the at least one second multicast or broadcast service identifier associated to the first multicast or broadcast service identifier.

In an embodiment, the fourth network function may further comprise a second receiving module configured to receive an update request comprising a preferred multicast or broadcast service identifier from the third network function in the first network.

In an embodiment, the fourth network function may further comprise a second sending module configured to send an update request comprising the preferred multicast or broadcast service identifier to the radio access network node.

In a seventeenth embodiment of the disclosure, there is provided a radio access network node. The radio access network node may comprise a first receiving module configured to receive a fourth message from a fourth network function in a first network. The fourth message may comprise a first multicast or broadcast service identifier and at least one second multicast or broadcast service identifier associated to the first multicast or broadcast service identifier. The radio access network node may further comprise a second receiving module configured to receive multicast or broadcast data originating from an application node. The radio access network node may further comprise a first broadcasting module configured to broadcast the multicast or broadcast data based on the fourth message.

In an embodiment, the radio access network node may further comprise a third receiving module configured to receive an update request comprising a preferred multicast or broadcast service identifier from the fourth network function in the first network. The multicast or broadcast data is broadcasted further based on the preferred multicast or broadcast service identifier.

In an embodiment, the radio access network node may further comprise a second broadcasting module configured to broadcast system information to at least one user equipment. The system information may comprise at least one of the first multicast or broadcast service identifier, one or more multicast or broadcast service identifiers associated to the first multicast or broadcast service identifier, or a preferred multicast or broadcast service identifier.

In an embodiment, the radio access network node may further comprise an establishing module configured to establish a transmission link with a user plane function of the first network to receive the multicast or broadcast data.

In an embodiment, the establishing module is configured to skip establishing the transmission link with the user plane function of the first network when the multicast or broadcast data can be received from a user plane function of another network.

In an eighteenth embodiment of the disclosure, there is provided a UE. The UE may comprise a first receiving module configured to receive a message from an application node or a radio access network node. The message may comprise at least one of a first multicast or broadcast service identifier, one or more second multicast or broadcast service identifiers associated to the first multicast or broadcast service identifier, or a preferred multicast or broadcast service identifier. The UE further comprises a second receiving module configured to receive multicast or broadcast data broadcasted by the radio access network node based on the message.

In another embodiment of the disclosure, there is provided a computer-readable storage medium storing instructions which when executed by at least one processor, cause the at least one processor to perform any of the methods according to the first, second, third, fourth, fifth and sixth embodiments of the disclosure.

In another embodiment of the disclosure, there is provided a computer program product, comprising instructions which, when executed on at least one processor, cause the at least one processor to carry out any of the methods according to the first, second, third, fourth, fifth and sixth embodiments of the disclosure.

Many advantages may be achieved by applying the proposed solution according to embodiments of the present disclosure. For example, some embodiments herein may enable efficient resource utilization for the same broadcast content to be provided to MOCN network sharing scenarios (i.e., multiple CNs are connected to the same RAN). In normal MBS broadcast, RAN needs to broadcast sessions independently, even for the shared RAN scenario. That is, if a content is broadcasted towards 3 PLMN vendors, in shared RAN scenario, NG-RAN would broadcast the content in 3 MBS sessions independently, one for each PLMN. With the solution according to some embodiments, shared RAN can determine to broadcast in one or more PLMNs (instead of one for each PLMN), and the UEs in other PLMNs would be able to receive the content from the specific PLMN. The embodiments herein are not limited to the features and advantages mentioned above. A person skilled in the art will recognize additional features and advantages upon reading the following detailed description.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the radio access network node, the core network node, the NEF, the AF, or the MB-SMF may not need a fixed processor or memory, any computing resource and storage resource may be arranged from the radio access network node, the core network node, the third network function, or the MB-SMF in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

Further, the exemplary overall commutation system including the terminal device and the network node will be introduced as below.

Embodiments of the present disclosure provide a communication system including a host computer including: processing circuitry configured to provide user data; and a communication interface configured to forward the user data to a cellular network for transmission to a terminal device. The cellular network includes a base station such as radio access network node above mentioned, and/or the terminal device such as the UE above mentioned.

In embodiments of the present disclosure, the system further includes the terminal device. The terminal device is configured to communicate with the base station.

In embodiments of the present disclosure, the processing circuitry of the host computer is configured to execute a host application, thereby providing the user data; and the terminal device includes processing circuitry configured to execute a client application associated with the host application.

Embodiments of the present disclosure also provide a communication system including a host computer including: a communication interface configured to receive user data originating from a transmission from a terminal device; a base station. The transmission is from the terminal device to the base station. The terminal device is above mentioned UE. The base station is above mentioned radio access network node.

In embodiments of the present disclosure, the processing circuitry of the host computer is configured to execute a host application. The terminal device is configured to execute a client application associated with the host application, thereby providing the user data to be received by the host computer.

FIG. 10 is a schematic showing a wireless network in accordance with some embodiments.

Although the subject matter described herein may be implemented in any appropriate type of system using any suitable components, the embodiments disclosed herein are described in relation to a wireless network, such as the example wireless network illustrated in FIG. 10. For simplicity, the wireless network of FIG. 10 only depicts network 1006, network nodes 1060 (corresponding to network side node) and 1060b, and WDs (corresponding to terminal device) 1010, 1010b, and 1010c. In practice, a wireless network may further include any additional elements suitable to support communication between wireless devices or between a wireless device and another communication device, such as a landline telephone, a service provider, or any other network node or end device. Of the illustrated components, network node 1060 and wireless device (WD) 1010 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1006 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1060 and WD 1010 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 10, network node 1060 includes processing circuitry 1070, device readable medium 1080, interface 1090, auxiliary equipment 1084, power source 1086, power circuitry 1087, and antenna 1062. Although network node 1060 illustrated in the example wireless network of FIG. 10 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1060 are depicted as single boxes located within a larger box, or nested within multiple boxes, in practice, a network node may comprise multiple different physical components that make up a single illustrated component (e.g., device readable medium 1080 may comprise multiple separate hard drives as well as multiple RAM modules).

Similarly, network node 1060 may be composed of multiple physically separate components (e.g., a NodeB component and a RNC component, or a BTS component and a BSC component, etc.), which may each have their own respective components. In certain scenarios in which network node 1060 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1060 may be configured to support multiple radio access technologies (RATs). In such embodiments, some components may be duplicated (e.g., separate device readable medium 1080 for the different RATs) and some components may be reused (e.g., the same antenna 1062 may be shared by the RATs). Network node 1060 may also include multiple sets of the various illustrated components for different wireless technologies integrated into network node 1060, such as, for example, GSM, WCDMA, LTE, NR, WiFi, or Bluetooth wireless technologies. These wireless technologies may be integrated into the same or different chip or set of chips and other components within network node 1060.

Processing circuitry 1070 is configured to perform any determining, calculating, or similar operations (e.g., certain obtaining operations) described herein as being provided by a network node. These operations performed by processing circuitry 1070 may include processing information obtained by processing circuitry 1070 by, for example, converting the obtained information into other information, comparing the obtained information or converted information to information stored in the network node, and/or performing one or more operations based on the obtained information or converted information, and as a result of said processing making a determination.

Processing circuitry 1070 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1060 components, such as device readable medium 1080, network node 1060 functionality. For example, processing circuitry 1070 may execute instructions stored in device readable medium 1080 or in memory within processing circuitry 1070. Such functionality may include providing any of the various wireless features, functions, or benefits discussed herein. In some embodiments, processing circuitry 1070 may include a system on a chip (SOC).

In some embodiments, processing circuitry 1070 may include one or more of radio frequency (RF) transceiver circuitry 1072 and baseband processing circuitry 1074. In some embodiments, radio frequency (RF) transceiver circuitry 1072 and baseband processing circuitry 1074 may be on separate chips (or sets of chips), boards, or units, such as radio units and digital units. In alternative embodiments, part or all of RF transceiver circuitry 1072 and baseband processing circuitry 1074 may be on the same chip or set of chips, boards, or units

In certain embodiments, some or all of the functionality described herein as being provided by a network node, base station, eNB or other such network device may be performed by processing circuitry 1070 executing instructions stored on device readable medium 1080 or memory within processing circuitry 1070. In alternative embodiments, some or all of the functionality may be provided by processing circuitry 1070 without executing instructions stored on a separate or discrete device readable medium, such as in a hard-wired manner. In any of those embodiments, whether executing instructions stored on a device readable storage medium or not, processing circuitry 1070 can be configured to perform the described functionality. The benefits provided by such functionality are not limited to processing circuitry 1070 alone or to other components of network node 1060, but are enjoyed by network node 1060 as a whole, and/or by end users and the wireless network generally.

Device readable medium 1080 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1070. Device readable medium 1080 may store any suitable instructions, data or information, including a computer program, software, an application including one or more of logic, rules, code, tables, etc. and/or other instructions capable of being executed by processing circuitry 1070 and, utilized by network node 1060. Device readable medium 1080 may be used to store any calculations made by processing circuitry 1070 and/or any data received via interface 1090. In some embodiments, processing circuitry 1070 and device readable medium 1080 may be considered to be integrated.

Interface 1090 is used in the wired or wireless communication of signaling and/or data between network node 1060, network 1006, and/or WDs 1010. As illustrated, interface 1090 comprises port(s)/terminal(s) 1094 to send and receive data, for example to and from network 1006 over a wired connection. Interface 1090 also includes radio front end circuitry 1092 that may be coupled to, or in certain embodiments a part of, antenna 1062. Radio front end circuitry 1092 comprises filters 1098 and amplifiers 1096. Radio front end circuitry 1092 may be connected to antenna 1062 and processing circuitry 1070. Radio front end circuitry may be configured to condition signals communicated between antenna 1062 and processing circuitry 1070. Radio front end circuitry 1092 may receive digital data that is to be sent out to other network nodes or WDs via a wireless connection. Radio front end circuitry 1092 may convert the digital data into a radio signal having the appropriate channel and bandwidth parameters using a combination of filters 1098 and/or amplifiers 1096. The radio signal may then be transmitted via antenna 1062. Similarly, when receiving data, antenna 1062 may collect radio signals which are then converted into digital data by radio front end circuitry 1092. The digital data may be passed to processing circuitry 1070. In other embodiments, the interface may comprise different components and/or different combinations of components.

In certain alternative embodiments, network node 1060 may not include separate radio front end circuitry 1092, instead, processing circuitry 1070 may comprise radio front end circuitry and may be connected to antenna 1062 without separate radio front end circuitry 1092. Similarly, in some embodiments, all or some of RF transceiver circuitry 1072 may be considered a part of interface 1090. In still other embodiments, interface 1090 may include one or more ports or terminals 1094, radio front end circuitry 1092, and RF transceiver circuitry 1072, as part of a radio unit (not shown), and interface 1090 may communicate with baseband processing circuitry 1074, which is part of a digital unit (not shown).

Antenna 1062 may include one or more antennas, or antenna arrays, configured to send and/or receive wireless signals. Antenna 1062 may be coupled to radio front end circuitry 1090 and may be any type of antenna capable of transmitting and receiving data and/or signals wirelessly. In some embodiments, antenna 1062 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1062 may be separate from network node 1060 and may be connectable to network node 1060 through an interface or port.

Antenna 1062, interface 1090, and/or processing circuitry 1070 may be configured to perform any receiving operations and/or certain obtaining operations described herein as being performed by a network node. Any information, data and/or signals may be received from a wireless device, another network node and/or any other network equipment. Similarly, antenna 1062, interface 1090, and/or processing circuitry 1070 may be configured to perform any transmitting operations described herein as being performed by a network node. Any information, data and/or signals may be transmitted to a wireless device, another network node and/or any other network equipment.

Power circuitry 1087 may comprise, or be coupled to, power management circuitry and is configured to supply the components of network node 1060 with power for performing the functionality described herein. Power circuitry 1087 may receive power from power source 1086. Power source 1086 and/or power circuitry 1087 may be configured to provide power to the various components of network node 1060 in a form suitable for the respective components (e.g., at a voltage and current level needed for each respective component). Power source 1086 may either be included in, or external to, power circuitry 1087 and/or network node 1060. For example, network node 1060 may be connectable to an external power source (e.g., an electricity outlet) via an input circuitry or interface such as an electrical cable, whereby the external power source supplies power to power circuitry 1087. As a further example, power source 1086 may comprise a source of power in the form of a battery or battery pack which is connected to, or integrated in, power circuitry 1087. The battery may provide backup power should the external power source fail. Other types of power sources, such as photovoltaic devices, may also be used.

Alternative embodiments of network node 1060 may include additional components beyond those shown in FIG. 10 that may be responsible for providing certain aspects of the network node's functionality, including any of the functionality described herein and/or any functionality necessary to support the subject matter described herein. For example, network node 1060 may include user interface equipment to allow input of information into network node 1060 and to allow output of information from network node 1060. This may allow a user to perform diagnostic, maintenance, repair, and other administrative functions for network node 1060.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V21), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1010 includes antenna 1011, interface 1014, processing circuitry 1020, device readable medium 1030, user interface equipment 1032, auxiliary equipment 1034, power source 1036 and power circuitry 1037. WD 1010 may include multiple sets of one or more of the illustrated components for different wireless technologies supported by WD 1010, such as, for example, GSM, WCDMA, LTE, NR, WiFi, WiMAX, or Bluetooth wireless technologies, just to mention a few. These wireless technologies may be integrated into the same or different chips or set of chips as other components within WD 1010.

Antenna 1011 may include one or more antennas or antenna arrays, configured to send and/or receive wireless signals, and is connected to interface 1014. In certain alternative embodiments, antenna 1011 may be separate from WD 1010 and be connectable to WD 1010 through an interface or port. Antenna 1011, interface 1014, and/or processing circuitry 1020 may be configured to perform any receiving or transmitting operations described herein as being performed by a WD. Any information, data and/or signals may be received from a network node and/or another WD. In some embodiments, radio front end circuitry and/or antenna 1011 may be considered an interface.

As illustrated, interface 1014 comprises radio front end circuitry 1012 and antenna 1011. Radio front end circuitry 1012 comprise one or more filters 1018 and amplifiers 1016. Radio front end circuitry 1014 is connected to antenna 1011 and processing circuitry 1020, and is configured to condition signals communicated between antenna 1011 and processing circuitry 1020. Radio front end circuitry 1012 may be coupled to or a part of antenna 1011. In some embodiments, WD 1010 may not include separate radio front end circuitry 1012; rather, processing circuitry 1020 may comprise radio front end circuitry and may be connected to antenna 1011. Similarly, in some embodiments, some or all of RF transceiver circuitry 1022 may be considered a part of interface 1014. Radio front end circuitry 1012 may receive digital data that is to be sent out to other network nodes or WDs via a wireless connection. Radio front end circuitry 1012 may convert the digital data into a radio signal having the appropriate channel and bandwidth parameters using a combination of filters 1018 and/or amplifiers 1016. The radio signal may then be transmitted via antenna 1011. Similarly, when receiving data, antenna 1011 may collect radio signals which are then converted into digital data by radio front end circuitry 1012. The digital data may be passed to processing circuitry 1020. In other embodiments, the interface may comprise different components and/or different combinations of components.

Processing circuitry 1020 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1010 components, such as device readable medium 1030, WD 1010 functionality. Such functionality may include providing any of the various wireless features or benefits discussed herein. For example, processing circuitry 1020 may execute instructions stored in device readable medium 1030 or in memory within processing circuitry 1020 to provide the functionality disclosed herein.

As illustrated, processing circuitry 1020 includes one or more of RF transceiver circuitry 1022, baseband processing circuitry 1024, and application processing circuitry 1026. In other embodiments, the processing circuitry may comprise different components and/or different combinations of components. In certain embodiments processing circuitry 1020 of WD 1010 may comprise a SOC. In some embodiments, RF transceiver circuitry 1022, baseband processing circuitry 1024, and application processing circuitry 1026 may be on separate chips or sets of chips. In alternative embodiments, part or all of baseband processing circuitry 1024 and application processing circuitry 1026 may be combined into one chip or set of chips, and RF transceiver circuitry 1022 may be on a separate chip or set of chips. In still alternative embodiments, part or all of RF transceiver circuitry 1022 and baseband processing circuitry 1024 may be on the same chip or set of chips, and application processing circuitry 1026 may be on a separate chip or set of chips. In yet other alternative embodiments, part or all of RF transceiver circuitry 1022, baseband processing circuitry 1024, and application processing circuitry 1026 may be combined in the same chip or set of chips. In some embodiments, RF transceiver circuitry 1022 may be a part of interface 1014. RF transceiver circuitry 1022 may condition RF signals for processing circuitry 1020.

In certain embodiments, some or all of the functionality described herein as being performed by a WD may be provided by processing circuitry 1020 executing instructions stored on device readable medium 1030, which in certain embodiments may be a computer-readable storage medium. In alternative embodiments, some or all of the functionality may be provided by processing circuitry 1020 without executing instructions stored on a separate or discrete device readable storage medium, such as in a hard-wired manner. In any of those particular embodiments, whether executing instructions stored on a device readable storage medium or not, processing circuitry 1020 can be configured to perform the described functionality. The benefits provided by such functionality are not limited to processing circuitry 1020 alone or to other components of WD 1010, but are enjoyed by WD 1010 as a whole, and/or by end users and the wireless network generally.

Processing circuitry 1020 may be configured to perform any determining, calculating, or similar operations (e.g., certain obtaining operations) described herein as being performed by a WD. These operations, as performed by processing circuitry 1020, may include processing information obtained by processing circuitry 1020 by, for example, converting the obtained information into other information, comparing the obtained information or converted information to information stored by WD 1010, and/or performing one or more operations based on the obtained information or converted information, and as a result of said processing making a determination.

Device readable medium 1030 may be operable to store a computer program, software, an application including one or more of logic, rules, code, tables, etc. and/or other instructions capable of being executed by processing circuitry 1020. Device readable medium 1030 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1020. In some embodiments, processing circuitry 1020 and device readable medium 1030 may be considered to be integrated.

User interface equipment 1032 may provide components that allow for a human user to interact with WD 1010. Such interaction may be of many forms, such as visual, audial, tactile, etc. User interface equipment 1032 may be operable to produce output to the user and to allow the user to provide input to WD 1010. The type of interaction may vary depending on the type of user interface equipment 1032 installed in WD 1010. For example, if WD 1010 is a smart phone, the interaction may be via a touch screen; if WD 1010 is a smart meter, the interaction may be through a screen that provides usage (e.g., the number of gallons used) or a speaker that provides an audible alert (e.g., if smoke is detected). User interface equipment 1032 may include input interfaces, devices and circuits, and output interfaces, devices and circuits. User interface equipment 1032 is configured to allow input of information into WD 1010, and is connected to processing circuitry 1020 to allow processing circuitry 1020 to process the input information. User interface equipment 1032 may include, for example, a microphone, a proximity or other sensor, keys/buttons, a touch display, one or more cameras, a USB port, or other input circuitry. User interface equipment 1032 is also configured to allow output of information from WD 1010, and to allow processing circuitry 1020 to output information from WD 1010. User interface equipment 1032 may include, for example, a speaker, a display, vibrating circuitry, a USB port, a headphone interface, or other output circuitry. Using one or more input and output interfaces, devices, and circuits, of user interface equipment 1032, WD 1010 may communicate with end users and/or the wireless network, and allow them to benefit from the functionality described herein.

Auxiliary equipment 1034 is operable to provide more specific functionality which may not be generally performed by WDs. This may comprise specialized sensors for doing measurements for various purposes, interfaces for additional types of communication such as wired communications etc. The inclusion and type of components of auxiliary equipment 1034 may vary depending on the embodiment and/or scenario.

Power source 1036 may, in some embodiments, be in the form of a battery or battery pack. Other types of power sources, such as an external power source (e.g., an electricity outlet), photovoltaic devices or power cells, may also be used. WD 1010 may further comprise power circuitry 1037 for delivering power from power source 1036 to the various parts of WD 1010 which need power from power source 1036 to carry out any functionality described or indicated herein. Power circuitry 1037 may in certain embodiments comprise power management circuitry. Power circuitry 1037 may additionally or alternatively be operable to receive power from an external power source; in which case WD 1010 may be connectable to the external power source (such as an electricity outlet) via input circuitry or an interface such as an electrical power cable. Power circuitry 1037 may also in certain embodiments be operable to deliver power from an external power source to power source 1036. This may be, for example, for the charging of power source 1036. Power circuitry 1037 may perform any formatting, converting, or other modification to the power from power source 1036 to make the power suitable for the respective components of WD 1010 to which power is supplied.

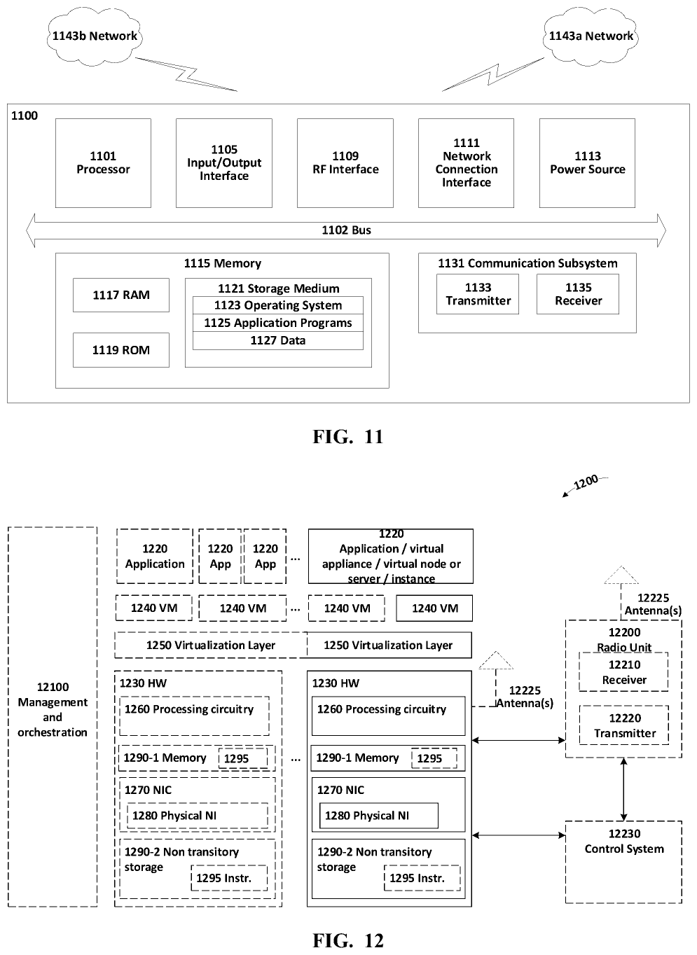

FIG. 11 is a schematic showing a user equipment in accordance with some embodiments.

FIG. 11 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 1100 may be any UE identified by the 3rd Generation Partnership Project (3GPP), including a NB-IoT UE, a machine type communication (MTC) UE, and/or an enhanced MTC (eMTC) UE. UE 1100, as illustrated in FIG. 11, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 11 is a UE, the components discussed herein are equally applicable to a WD, and vice-versa.

In FIG. 11, UE 1100 includes processing circuitry 1101 that is operatively coupled to input/output interface 1105, radio frequency (RF) interface 1109, network connection interface 1111, memory 1115 including random access memory (RAM) 1117, read-only memory (ROM) 1119, and storage medium 1121 or the like, communication subsystem 1131, power source 1133, and/or any other component, or any combination thereof. Storage medium 1121 includes operating system 1123, application program 1125, and data 1127. In other embodiments, storage medium 1121 may include other similar types of information. Certain UEs may utilize all of the components shown in FIG. 11, or only a subset of the components. The level of integration between the components may vary from one UE to another UE. Further, certain UEs may contain multiple instances of a component, such as multiple processors, memories, transceivers, transmitters, receivers, etc.

In FIG. 11, processing circuitry 1101 may be configured to process computer instructions and data. Processing circuitry 1101 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1101 may include two central processing units (CPUs). Data may be information in a form suitable for use by a computer.

In the depicted embodiment, input/output interface 1105 may be configured to provide a communication interface to an input device, output device, or input and output device. UE 1100 may be configured to use an output device via input/output interface 1105. An output device may use the same type of interface port as an input device. For example, a USB port may be used to provide input to and output from UE 1100. The output device may be a speaker, a sound card, a video card, a display, a monitor, a printer, an actuator, an emitter, a smartcard, another output device, or any combination thereof. UE 1100 may be configured to use an input device via input/output interface 1105 to allow a user to capture information into UE 1100. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 11, RF interface 1109 may be configured to provide a communication interface to RF components such as a transmitter, a receiver, and an antenna. Network connection interface 1111 may be configured to provide a communication interface to network 1143a. Network 1143a may encompass wired and/or wireless networks such as a local-area network (LAN), a wide-area network (WAN), a computer network, a wireless network, a telecommunications network, another like network or any combination thereof. For example, network 1143a may comprise a Wi-Fi network. Network connection interface 1111 may be configured to include a receiver and a transmitter interface used to communicate with one or more other devices over a communication network according to one or more communication protocols, such as Ethernet, TCP/IP, SONET, ATM, or the like. Network connection interface 1111 may implement receiver and transmitter functionality appropriate to the communication network links (e.g., optical, electrical, and the like). The transmitter and receiver functions may share circuit components, software or firmware, or alternatively may be implemented separately.

RAM 1117 may be configured to interface via bus 1102 to processing circuitry 1101 to provide storage or caching of data or computer instructions during the execution of software programs such as the operating system, application programs, and device drivers. ROM 1119 may be configured to provide computer instructions or data to processing circuitry 1101. For example, ROM 1119 may be configured to store invariant low-level system code or data for basic system functions such as basic input and output (I/O), startup, or reception of keystrokes from a keyboard that are stored in a non-volatile memory. Storage medium 1121 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1121 may be configured to include operating system 1123, application program 1125 such as a web browser application, a widget or gadget engine or another application, and data file 1127. Storage medium 1121 may store, for use by UE 1100, any of a variety of various operating systems or combinations of operating systems.

Storage medium 1121 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1121 may allow UE 1100 to access computer-executable instructions, application programs or the like, stored on transitory or non-transitory memory media, to off-load data, or to upload data. An article of manufacture, such as one utilizing a communication system may be tangibly embodied in storage medium 1121, which may comprise a device readable medium.

In FIG. 11, processing circuitry 1101 may be configured to communicate with network 1143b using communication subsystem 1131. Network 1143a and network 1143b may be the same network or networks or different network or networks. Communication subsystem 1131 may be configured to include one or more transceivers used to communicate with network 1143b. For example, communication subsystem 1131 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 1133 and/or receiver 1135 to implement transmitter or receiver functionality, respectively, appropriate to the RAN links (e.g., frequency allocations and the like). Further, transmitter 1133 and receiver 1135 of each transceiver may share circuit components, software or firmware, or alternatively may be implemented separately.

In the illustrated embodiment, the communication functions of communication subsystem 1131 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1131 may include cellular communication, Wi-Fi communication, Bluetooth communication, and GPS communication. Network 1143b may encompass wired and/or wireless networks such as a local-area network (LAN), a wide-area network (WAN), a computer network, a wireless network, a telecommunications network, another like network or any combination thereof. For example, network 1143b may be a cellular network, a Wi-Fi network, and/or a near-field network. Power source 1113 may be configured to provide alternating current (AC) or direct current (DC) power to components of UE 1100.

The features, benefits and/or functions described herein may be implemented in one of the components of UE 1100 or partitioned across multiple components of UE 1100. Further, the features, benefits, and/or functions described herein may be implemented in any combination of hardware, software or firmware. In one example, communication subsystem 1131 may be configured to include any of the components described herein. Further, processing circuitry 1101 may be configured to communicate with any of such components over bus 1102. In another example, any of such components may be represented by program instructions stored in memory that when executed by processing circuitry 1101 perform the corresponding functions described herein. In another example, the functionality of any of such components may be partitioned between processing circuitry 1101 and communication subsystem 1131. In another example, the non-computationally intensive functions of any of such components may be implemented in software or firmware and the computationally intensive functions may be implemented in hardware.

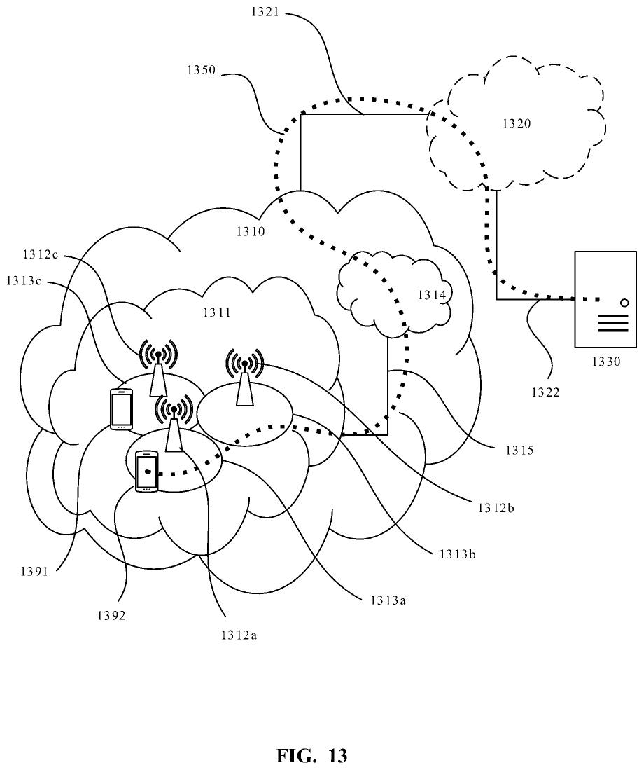

FIG. 12 is a schematic showing a virtualization environment in accordance with some embodiments.

FIG. 12 is a schematic block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1200 hosted by one or more of hardware nodes 1230. Further, in embodiments in which the virtual node is not a radio access node or does not require radio connectivity (e.g., a core network node), then the network node may be entirely virtualized.

The functions may be implemented by one or more applications 1220 (which may alternatively be called software instances, virtual appliances, network functions, virtual nodes, virtual network functions, etc.) operative to implement some of the features, functions, and/or benefits of some of the embodiments disclosed herein. Applications 1220 are run in virtualization environment 1200 which provides hardware 1230 comprising processing circuitry 1260 and memory 1290-1. Memory 1290-1 contains instructions 1295 executable by processing circuitry 1260 whereby application 1220 is operative to provide one or more of the features, benefits, and/or functions disclosed herein.

Virtualization environment 1200, comprises general-purpose or special-purpose network hardware devices 1230 comprising a set of one or more processors or processing circuitry 1260, which may be commercial off-the-shelf (COTS) processors, dedicated Application Specific Integrated Circuits (ASICs), or any other type of processing circuitry including digital or analog hardware components or special purpose processors. Each hardware device may comprise memory 1290-1 which may be non-persistent memory for temporarily storing instructions 1295 or software executed by processing circuitry 1260. Each hardware device may comprise one or more network interface controllers (NICs) 1270, also known as network interface cards, which include physical network interface 1280. Each hardware device may also include non-transitory, persistent, machine-readable storage media 1290-2 having stored therein software 1295 and/or instructions executable by processing circuitry 1260. Software 1295 may include any type of software including software for instantiating one or more virtualization layers 1250 (also referred to as hypervisors), software to execute virtual machines 1240 as well as software allowing it to execute functions, features and/or benefits described in relation with some embodiments described herein.

Virtual machines 1240, comprise virtual processing, virtual memory, virtual networking or interface and virtual storage, and may be run by a corresponding virtualization layer 1250 or hypervisor. Different embodiments of the instance of virtual appliance 1220 may be implemented on one or more of virtual machines 1240, and the implementations may be made in different ways.

During operation, processing circuitry 1260 executes software 1295 to instantiate the hypervisor or virtualization layer 1250, which may sometimes be referred to as a virtual machine monitor (VMM). Virtualization layer 1250 may present a virtual operating platform that appears like networking hardware to virtual machine 1240.

As shown in FIG. 12, hardware 1230 may be a standalone network node with generic or specific components. Hardware 1230 may comprise antenna 12225 and may implement some functions via virtualization. Alternatively, hardware 1230 may be part of a larger cluster of hardware (e.g. such as in a data center or customer premise equipment (CPE)) where many hardware nodes work together and are managed via management and orchestration (MANO) 12100, which, among others, oversees lifecycle management of applications 1220.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1240 may be a software implementation of a physical machine that runs programs as if they were executing on a physical, non-virtualized machine. Each of virtual machines 1240, and that part of hardware 1230 that executes that virtual machine, be it hardware dedicated to that virtual machine and/or hardware shared by that virtual machine with others of the virtual machines 1240, forms a separate virtual network elements (VNE).

Still in the context of NFV, Virtual Network Function (VNF) is responsible for handling specific network functions that run in one or more virtual machines 1240 on top of hardware networking infrastructure 1230 and corresponds to application 1220 in FIG. 12.

In some embodiments, one or more radio units 12200 that each include one or more transmitters 12220 and one or more receivers 12210 may be coupled to one or more antennas 12225. Radio units 12200 may communicate directly with hardware nodes 1230 via one or more appropriate network interfaces and may be used in combination with the virtual components to provide a virtual node with radio capabilities, such as a radio access node or a base station.

In some embodiments, some signalling can be effected with the use of control system 12230 which may alternatively be used for communication between the hardware nodes 1230 and radio units 12200.

FIG. 13 is a schematic showing a telecommunication network connected via an intermediate network to a host computer in accordance with some embodiments.

With reference to FIG. 13, in accordance with an embodiment, a communication system includes telecommunication network 1310, such as a 3GPP-type cellular network, which comprises access network 1311, such as a radio access network, and core network 1314. Access network 1311 comprises a plurality of base stations 1312a, 1312b, 1312c, such as NBs, eNBs, gNBs or other types of wireless access points, each defining a corresponding coverage area 1313a, 1313b, 1313c. Each base station 1312a, 1312b, 1312c is connectable to core network 1314 over a wired or wireless connection 1315. A first UE 1391 located in coverage area 1313c is configured to wirelessly connect to, or be paged by, the corresponding base station 1312c. A second UE 1392 in coverage area 1313a is wirelessly connectable to the corresponding base station 1312a. While a plurality of UEs 1391, 1392 are illustrated in this example, the disclosed embodiments are equally applicable to a situation where a sole UE is in the coverage area or where a sole UE is connecting to the corresponding base station 1312a or 1312b or 1312c.

Telecommunication network 1310 is itself connected to host computer 1330, which may be embodied in the hardware and/or software of a standalone server, a cloud-implemented server, a distributed server or as processing resources in a server farm. Host computer 1330 may be under the ownership or control of a service provider, or may be operated by the service provider or on behalf of the service provider. Connections 1321 and 1322 between telecommunication network 1310 and host computer 1330 may extend directly from core network 1314 to host computer 1330 or may go via an optional intermediate network 1320. Intermediate network 1320 may be one of, or a combination of more than one of, a public, private or hosted network; intermediate network 1320, if any, may be a backbone network or the Internet; in particular, intermediate network 1320 may comprise two or more sub-networks (not shown).

The communication system of FIG. 13 as a whole enables connectivity between the connected UEs 1391, 1392 and host computer 1330. The connectivity may be described as an over-the-top (OTT) connection 1350. Host computer 1330 and the connected UEs 1391, 1392 are configured to communicate data and/or signalling via OTT connection 1350, using access network 1311, core network 1314, any intermediate network 1320 and possible further infrastructure (not shown) as intermediaries. OTT connection 1350 may be transparent in the sense that the participating communication devices through which OTT connection 1350 passes are unaware of routing of uplink and downlink communications. For example, base station 1312a or 1312b or 1312c may not or need not be informed about the past routing of an incoming downlink communication with data originating from host computer 1330 to be forwarded (e.g., handed over) to a connected UE 1391. Similarly, base station 1312a or 1312b or 1312c need not be aware of the future routing of an outgoing uplink communication originating from the UE 1391 towards the host computer 1330.

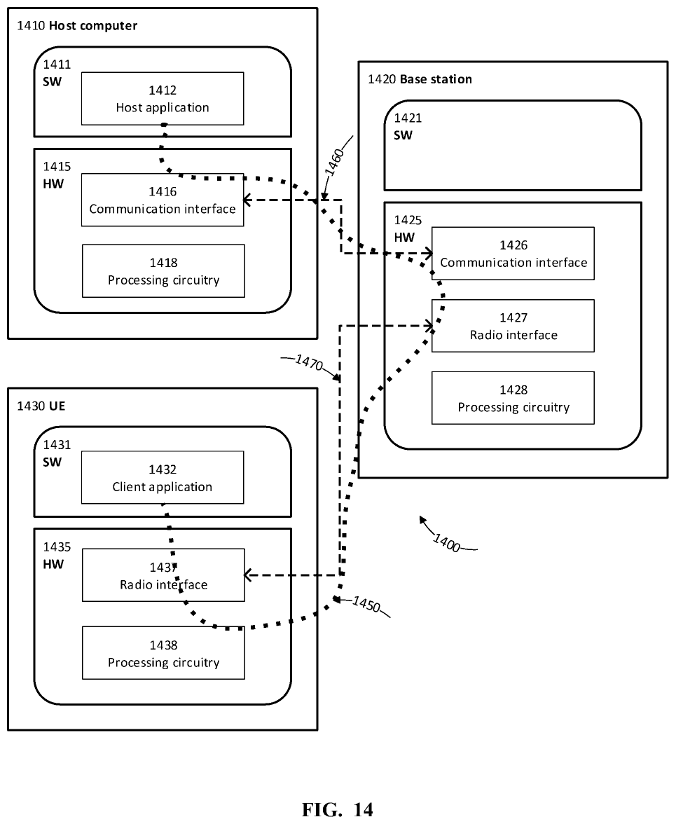

FIG. 14 is a schematic showing a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 14. In communication system 1400, host computer 1410 comprises hardware 1415 including communication interface 1416 configured to set up and maintain a wired or wireless connection with an interface of a different communication device of communication system 1400. Host computer 1410 further comprises processing circuitry 1418, which may have storage and/or processing capabilities. In particular, processing circuitry 1418 may comprise one or more programmable processors, application-specific integrated circuits, field programmable gate arrays or combinations of these (not shown) adapted to execute instructions. Host computer 1410 further comprises software 1411, which is stored in or accessible by host computer 1410 and executable by processing circuitry 1418. Software 1411 includes host application 1412. Host application 1412 may be operable to provide a service to a remote user, such as UE 1430 connecting via OTT connection 1450 terminating at UE 1430 and host computer 1410. In providing the service to the remote user, host application 1412 may provide user data which is transmitted using OTT connection 1450.

Communication system 1400 further includes base station 1420 provided in a telecommunication system and comprising hardware 1425 enabling it to communicate with host computer 1410 and with UE 1430. Hardware 1425 may include communication interface 1426 for setting up and maintaining a wired or wireless connection with an interface of a different communication device of communication system 1400, as well as radio interface 1427 for setting up and maintaining at least wireless connection 1470 with UE 1430 located in a coverage area (not shown in FIG. 14) served by base station 1420. Communication interface 1426 may be configured to facilitate connection 1460 to host computer 1410. Connection 1460 may be direct or it may pass through a core network (not shown in FIG. 14) of the telecommunication system and/or through one or more intermediate networks outside the telecommunication system. In the embodiment shown, hardware 1425 of base station 1420 further includes processing circuitry 1428, which may comprise one or more programmable processors, application-specific integrated circuits, field programmable gate arrays or combinations of these (not shown) adapted to execute instructions. Base station 1420 further has software 1421 stored internally or accessible via an external connection.

Communication system 1400 further includes UE 1430 already referred to. Its hardware 1435 may include radio interface 1437 configured to set up and maintain wireless connection 1470 with a base station serving a coverage area in which UE 1430 is currently located. Hardware 1435 of UE 1430 further includes processing circuitry 1438, which may comprise one or more programmable processors, application-specific integrated circuits, field programmable gate arrays or combinations of these (not shown) adapted to execute instructions. UE 1430 further comprises software 1431, which is stored in or accessible by UE 1430 and executable by processing circuitry 1438. Software 1431 includes client application 1432. Client application 1432 may be operable to provide a service to a human or non-human user via UE 1430, with the support of host computer 1410. In host computer 1410, an executing host application 1412 may communicate with the executing client application 1432 via OTT connection 1450 terminating at UE 1430 and host computer 1410. In providing the service to the user, client application 1432 may receive request data from host application 1412 and provide user data in response to the request data. OTT connection 1450 may transfer both the request data and the user data. Client application 1432 may interact with the user to generate the user data that it provides.

It is noted that host computer 1410, base station 1420 and UE 1430 illustrated in FIG. 14 may be similar or identical to host computer 1330, one of base stations 1312a, 1312b, 1312c and one of UEs 1391, 1392 of FIG. 13, respectively. This is to say, the inner workings of these entities may be as shown in FIG. 14 and independently, the surrounding network topology may be that of FIG. 13.

In FIG. 14, OTT connection 1450 has been drawn abstractly to illustrate the communication between host computer 1410 and UE 1430 via base station 1420, without explicit reference to any intermediary devices and the precise routing of messages via these devices. Network infrastructure may determine the routing, which it may be configured to hide from UE 1430 or from the service provider operating host computer 1410, or both. While OTT connection 1450 is active, the network infrastructure may further take decisions by which it dynamically changes the routing (e.g., on the basis of load balancing consideration or reconfiguration of the network).

Wireless connection 1470 between UE 1430 and base station 1420 is in accordance with the teachings of the embodiments described throughout this disclosure. One or more of the various embodiments improve the performance of OTT services provided to UE 1430 using OTT connection 1450, in which wireless connection 1470 forms the last segment. More precisely, the teachings of these embodiments may can avoid unnecessary user planes between the RAN and the MB-UPFs in other CNs and avoid RAN handling on duplicated packets, as well as the MB-UPF handling. It is robust on that the RAN can establish user plane towards another CN when there is a failure in the CN, and continue to use the packets received from the newly established user plane to offer the service towards UEs.

A measurement procedure may be provided for the purpose of monitoring data rate, latency and other factors on which the one or more embodiments improve. There may further be an optional network functionality for reconfiguring OTT connection 1450 between host computer 1410 and UE 1430, in response to variations in the measurement results. The measurement procedure and/or the network functionality for reconfiguring OTT connection 1450 may be implemented in software 1411 and hardware 1415 of host computer 1410 or in software 1431 and hardware 1435 of UE 1430, or both. In embodiments, sensors (not shown) may be deployed in or in association with communication devices through which OTT connection 1450 passes; the sensors may participate in the measurement procedure by supplying values of the monitored quantities exemplified above, or supplying values of other physical quantities from which software 1411, 1431 may compute or estimate the monitored quantities. The reconfiguring of OTT connection 1450 may include message format, retransmission settings, preferred routing etc.; the reconfiguring need not affect base station 1420, and it may be unknown or imperceptible to base station 1420. Such procedures and functionalities may be known and practiced in the art. In certain embodiments, measurements may involve proprietary UE signalling facilitating host computer 1410's measurements of throughput, propagation times, latency and the like. The measurements may be implemented in that software 1411 and 1431 causes messages to be transmitted, in particular empty or ‘dummy’ messages, using OTT connection 1450 while it monitors propagation times, errors etc.

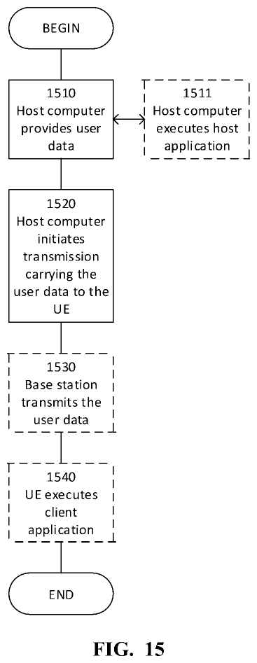

FIG. 15 is a schematic showing methods implemented in a communication system including a host computer, a base station and a user equipment in accordance with some embodiments.

FIG. 15 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 15 will be included in this section. In step 1510, the host computer provides user data. In substep 1511 (which may be optional) of step 1510, the host computer provides the user data by executing a host application. In step 1520, the host computer initiates a transmission carrying the user data to the UE. In step 1530 (which may be optional), the base station transmits to the UE the user data which was carried in the transmission that the host computer initiated, in accordance with the teachings of the embodiments described throughout this disclosure. In step 1540 (which may also be optional), the UE executes a client application associated with the host application executed by the host computer.

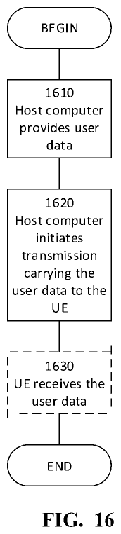

FIG. 16 is a schematic showing methods implemented in a communication system including a host computer, a base station and a user equipment in accordance with some embodiments.

FIG. 16 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 16 will be included in this section. In step 1610 of the method, the host computer provides user data. In an optional substep (not shown) the host computer provides the user data by executing a host application. In step 1620, the host computer initiates a transmission carrying the user data to the UE. The transmission may pass via the base station, in accordance with the teachings of the embodiments described throughout this disclosure. In step 1630 (which may be optional), the UE receives the user data carried in the transmission.

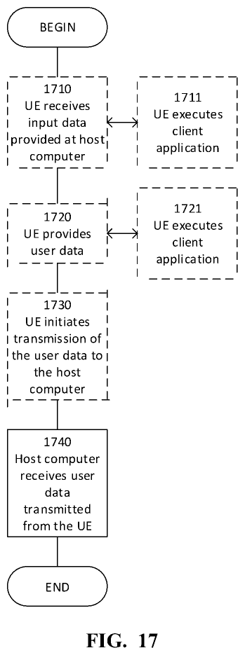

FIG. 17 is a schematic showing methods implemented in a communication system including a host computer, a base station and a user equipment in accordance with some embodiments.

FIG. 17 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 17 will be included in this section. In step 1710 (which may be optional), the UE receives input data provided by the host computer. Additionally or alternatively, in step 1720, the UE provides user data. In substep 1721 (which may be optional) of step 1720, the UE provides the user data by executing a client application. In substep 1711 (which may be optional) of step 1710, the UE executes a client application which provides the user data in reaction to the received input data provided by the host computer. In providing the user data, the executed client application may further consider user input received from the user. Regardless of the specific manner in which the user data was provided, the UE initiates, in substep 1730 (which may be optional), transmission of the user data to the host computer. In step 1740 of the method, the host computer receives the user data transmitted from the UE, in accordance with the teachings of the embodiments described throughout this disclosure.

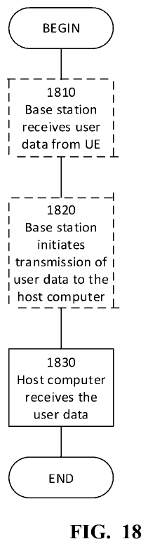

FIG. 18 is a schematic showing methods implemented in a communication system including a host computer, a base station and a user equipment in accordance with some embodiments.

FIG. 18 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 18 will be included in this section. In step 1810 (which may be optional), in accordance with the teachings of the embodiments described throughout this disclosure, the base station receives user data from the UE. In step 1820 (which may be optional), the base station initiates transmission of the received user data to the host computer. In step 1830 (which may be optional), the host computer receives the user data carried in the transmission initiated by the base station.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method performed by a radio access network node, comprising:
receiving a first request from a core network node in a first network, wherein the first request comprises a first multicast/broadcast service (MBS) session identifier (ID) for a first broadcast MBS session and an associated session ID, wherein the associated session ID is associated with two or more broadcast MBS sessions with different MBS session IDs delivering a same MBS content over two or more networks; and
in accordance with a determination that a predefined user plane connection delivering the MBS content associated to a second broadcast MBS session has been established with a network for multicast transport, skipping joining a multicast group for receiving the MBS content from a Multicast/Broadcast User Plane Function (MB-UPF) in the first network which is originated from an application node; and/or
for unicast transport, skipping allocation of downlink tunnel information for the first broadcast MBS session;
wherein the first broadcast MBS session and the second broadcast MBS session are comprised in the two or more broadcast MBS sessions.

2. (canceled)

3. The method according to claim 1, further comprising:
when radio resource has been allocated for broadcasting the MBS content of the application node and shared by the two or more broadcast MBS sessions, skipping allocating the radio resource; and/or
when the radio resource has not been allocated for broadcasting the MBS content of the application node and shared by the two or more broadcast MBS sessions, allocating the radio resource.

4. The method according to claim 3, further comprising:
advertising the first MBS session ID; and
linking the first MBS session ID to the radio resource.

5. The method according to claim 1, further comprising:
creating broadcast MBS session context including the associated session ID.

6. The method according to claim 1, further comprising:
receiving an MBS session release request from the core network node in the first network, wherein the MBS session release request comprises the first MBS session ID.

7. The method according to claim 6, further comprising:
in accordance with a determination that the user plane of the first MBS session towards the first network is not established, continuing content delivery of the two or more broadcast MBS sessions, stopping advertisement of the MBS session ID; and
for multicast transport, skipping sending a leaving message to an MB-UPF in the first network; and/or
for unicast transport, sending an MBS session release response without downlink tunnel information to the core network node in the first network.

8-12. (canceled)

13. The method according to claim 6, further comprising:
triggering Broadcast MBS Session Release Require procedure for each associated broadcast MBS session.

14. (canceled)

15. (canceled)

16. The method according to claim 1, further comprising:
determining that the radio access network node cannot receive MBS content from a user plane of a third MBS session towards a third network; and
selecting a fourth MBS session of the two or more broadcast MBS sessions to establish a user plane of a fourth MBS session towards a fourth network.

17. (canceled)

18. The method according to claim 16, wherein determining that the radio access network node cannot receive MBS content from a user plane of a third MBS session towards a third network comprises:
detecting there is a failure in the third network which causes the radio access network node cannot receive MBS content from the user plane of the third MBS session towards the third network; and
determining that the radio access network node cannot receive MBS content from the user plane of the third MBS session towards the third network.

19-45. (canceled)

46. A method performed by a multicast/broadcast session management function (MB-SMF) in a first network, comprising:
receiving an MBS session create request from a Network Exposure Function (NEF) or a Multicast/Broadcast Service Function (MBSF) in the first network or an application function (AF), wherein the MBS session create request comprises a multicast/broadcast service (MBS) session identifier (ID) and an associated session ID, wherein the associated session ID is associated with two or more broadcast MBS sessions of different MBS session IDs delivering a same content over two or more networks; and
sending an MBS broadcast context create request to an access and mobility management function (AMF) in the first network, wherein the MBS broadcast context create request comprises the MBS session ID and the associated session ID,
wherein at least one user plane is expected to be established for the two or more MBS sessions of the two or more networks.

47. The method according to claim 46, further comprising:
receiving a notify request comprising an ID of a first MBS session and downlink tunnel information from the AMF in the first network; and
sending a session modification request to a Multicast/Broadcast User plane Function (MB-UPF) to allocate point-to-point transport tunnel for a replicated MBS stream for the first MBS session; and
sending a notify response to the AMF in the first network, wherein the notify response comprises the ID of the first MBS session.

48. The method according to claim 47, wherein the N2 request is a broadcast session transport request and the N2 response is a broadcast session transport response.

49. The method according to claim 47, wherein the notify request is an MBS broadcast context status notify request and the notify response is an MBS broadcast context status notify response.

50-67. (canceled)

68. A radio access network node, comprising:
a processor; and
a memory coupled to the processor, said memory containing instructions executable by said processor, whereby said radio access network node is operative to:
receive a first request from a core network node in a first network, wherein the first request comprises a first multicast/broadcast service (MBS) session identifier (ID) for a first broadcast MBS session and an associated session ID, wherein the associated session ID is associated with two or more broadcast MBS sessions with different MBS session IDs delivering a same MBS content over two or more networks; and
in accordance with a determination that a predefined number of user planes user plane connection delivering the MBS content associated to a second broadcast MBS session has been established with a network for multicast transport, skip joining a multicast group for receiving the MBS content from a Multicast/Broadcast User Plane Function (MB-UPF) in the first network which is originated from an application node; and/or
for unicast transport, skipping allocation of downlink tunnel information for the first broadcast MBS session;
wherein the first broadcast MBS session and the second broadcast MBS session are comprised in the two or more broadcast MBS sessions.

69-71. (canceled)

72. A multicast/broadcast session management function (MB-SMF) in a first network, comprising:
a processor; and
a memory coupled to the processor, said memory containing instructions executable by said processor, whereby said MB-SMF is operative to:
receive an MBS session create request from a Network Exposure Function (NEF) or a Multicast/Broadcast Service Function (MBSF) in the first network or an application function (AF), wherein the MBS session create request comprises a multicast/broadcast service (MBS) session identifier (ID) and an associated session ID, wherein the associated session ID is associated with two or more broadcast MBS sessions with different MBS session IDs delivering a same content over two or more networks; and
send an MBS broadcast context create request to an access and mobility management function (AMF) in the first network, wherein the MBS broadcast context create request comprises the MBS session ID and the associated session ID,
wherein at least one user plane is expected to be established for the two or more MBS sessions of the two or more networks.

73-79. (canceled)
